(19) United States
(12) Patent Application Publication
(10) Pub. No.: US 2019/0138673 A1
(43) Pub. Date: May 9, 2019

(54) Growth-Based Design System

(71) Applicant: Desktop Metal, Inc., Burlington, MA (US)

(72) Inventors: Andrew Fiske Roberts, Charlestown, MA (US); Christian Gomez, Burlington, MA (US)

(21) Appl. No.: 16/173,343

(22) Filed: Oct. 29, 2018

Related U.S. Application Data
(60) Provisional application No. 62/583,880, filed on Nov. 9, 2017.
(60) Provisional application No. 62/623,821, filed on Jan. 30, 2018.
(60) Provisional application No. 62/626,608, filed on Feb. 5, 2018.

(51) Int. Cl. G06F 17/50; G06T 17/10

(52) U.S. Cl. CPC G06F 17/5009; G06F 2217/06; G06F 2217/02; G06T 17/10

(57) ABSTRACT

A process for simulating cellular growth is implemented to determine geometry of an object within a simulated environment. Seed cells, which represent starting points for a cell body, are defined within the environment. A number of constraints and parameters, such as forces and target locations, are also imposed on the environment. The body of cells is then grown within the simulated environment, spawning and destroying cells as needed to meet the imposed constraints. A stable structure meeting the constraints can be exported and fabricated, such as by a three-dimensional printer, to produce a corresponding a real-world object.

### RELATED APPLICATIONS

This application claims the benefit of U.S. Provisional Application No. 62/583,880, filed on Nov. 9, 2017; U.S. Provisional Application No. 62/623,821, filed on Jan. 30, 2018; and U.S. Provisional Application No. 62/626,608, filed on Feb. 5, 2018. The entire teachings of the above applications are incorporated herein by reference.

### BACKGROUND

Various software tools are available for creating, viewing and editing designs. Designs may be representations of physical structures used in engineering, movie making, game development, or otherwise. Such software systems are commonly referred to as computer aided design tools (i.e. CAD tools). Existing CAD tools enable users to create geometric models and perform analytical simulations using techniques such as the Finite Element Method (i.e. FEM). With these tools, users can see where a design may fail, and subsequently modify and reanalyze the design in order to reach an optimal tradeoff among variables such as cost and weight.

Existing CAD tools require that the engineer manually create design shapes using geometry creation tools. These tools include feature based modeling approaches wherein users are provided with a set of parameterized features for creating bosses, holes, shells, fillets, patterns, and other features. This creation approach contrasts with Nature, wherein organisms develop their shapes autonomously through growth. In Nature, nobody sketches and analyzes a tree. Instead, the tree grows from a single cell into an embryo and finally a mature organism, guided only by the environmental factors around it. In Nature, cell growth is sometimes referred to as morphogenesis, the process that causes an organism to develop its form. There are numerous forms of cell growth. In plants, for example, cells are fixed to each other and may only subdivide in special growth regions. In animals, on the other hand, cells are free to detach and migrate (a process called gastrulation) in order to drastically restructure the organism. Existing CAD tools require a user to create a design manually and from scratch, whereas in nature, the design (a plant or animal) emerges by itself through cell-based growth.

Metal injection molding (MIM) is a metalworking process useful in creating a variety of metal objects. A mixture of powdered metal and binder (e.g., a polymer such as polypropylene) forms a “feedstock” capable of being molded, at a high temperature, into the shape of a desired object. The initial molded part, also referred to as a “green part,” then undergoes a debinding process to remove the binder, followed by a sintering process. During sintering, the part is brought to a temperature near the melting point of the powdered metal, which evaporates any remaining binder and forming the metal powder into a solid mass, thereby producing the desired object.

Additive manufacturing, also referred to as 3D printing, includes a variety of techniques for manufacturing a three-dimensional object via an automated process of forming successive layers of the object. 3D printers may utilize a feedstock comparable to that used in MIM, thereby creating a green part without the need for a mold. The green part may then undergo comparable debinding and sintering processes to produce the object.

### SUMMARY

Example embodiments include a method of defining geometry of an object. A simulated environment may be generated including at least one initial cell, the simulated environment being defined by environment parameters. Successive cells may be generated to form a cell body including the at least one initial cell, where the generation is a function of the environment parameters and cell parameters of cells of the cell body. Updated cell parameters may be determined in response to a simulated stimulus applied to the cell body, the stimulus including at least one of a force, a radiation source, and a chemical reaction. A chemical reaction may include an electrolytic action.

The cell parameters of the successive cells may then be modified based on a value corresponding to the cell parameters of neighboring cells. New cells adjacent to the successive cells may be generated as a function of the cell parameters of the successive cells following the modification. A geometry for an object may then be defined based on a geometry of the cell body.

A successive cell may be adjacent to the face of an existing cell. The environment parameters may define a start location and an end location, the cell body extending between the start location and the end location. The generation of successive cells may progress from the start location to locations that form a shortest route from the cells in the cell body to the end location. The environment parameters may include at least one of a growth rate, a gravity force, and a force applied to a surface adjacent to the cell body. The cell parameters may include at least one of a value corresponding to strain exhibited by a cell, a temperature of the cell, or an age of the cell. The stimulus may include at least one of an applied force, a gravity force, a magnetic force, a friction force, or a pressure force. Forces may be applied to a cell body in a linear rotational, or normal manner, and forces may be applied as reactions to contacts between a cell body and components of an assembly within the simulated environment.

The environment parameters may define a surface of an assembly within the simulated environment, the surface applying the simulated stimulus to cells adjacent to the surface. The environment parameters may define a volume requiring occupation by the cell body, or may define a volume prohibiting occupation by the cell body. The environment parameters may 1) define a volume, 2) enable growth of the cell body within the volume, and 3) prohibit growth of the cell body outside of the volume following occupation of the cell body within the volume. The environment parameters may include one or more of a maximum thickness of the cell body, a minimum thickness of the cell body, and a growth direction.

A violation of the environment parameters may be detected, the violation including at least one of 1) a failure of the cell body to occupy a required volume, 2) an occupation of a prohibited volume, and 3) failure to connect a start location and an end location via the cell body. Modifying the cell body may include modifying the cell body to correct the violation. Modifying the cell body may include adding further successive cells to the cell body, the location of the further successive cells being determined based on the environment parameters and the at least one force. Modifying the cell body may include removing a subset of the successive cells from the cell body, the subset being determined based on the environment parameters and the at least one force.

Further, locations for the successive cells may be calculated. To do so, an existing cell of the cell body may be selected, and a growth direction from the existing cell to an end location may be defined. A set of locations for potential new cells adjacent to the existing cell may be determined, and one of the set of locations may be selected based on at least one of: 1) a relative deviation from the growth direction, and 2) strain exhibited by a face of the existing cell.

Each of the successive cells and the at least one initial cell may define a respective volume within the simulated environment. The geometry for the object may correspond to the respective volume of each of the successive cells and the at least one initial cell. Defining the geometry for the object may include generating a modified geometry of the cell body, the modified geometry having a plurality of additional slant faces at the surface of the modified geometry.

Completion of the cell body may be determined based on 1) an indication that at least one expression involving the environment parameters evaluate to true, and 2) an indication that the modification of the cell body has decreased below a threshold. Defining the geometry for the object may occur in response to the determined completion.

An immediate strain parameter and a strain concentration parameter may be determined for each cell of the cell body, the immediate strain parameter indicating a degree of simulated strain at the cell. The strain concentration parameter for each cell may be modified based on the corresponding immediate strain parameter and strain concentration parameters of neighboring cells. The degree of simulated strain at the cell may be determined based on an effect on the cell, the effect being related to the simulated stimulus. At least one of a strain, a stress, and a displacement may be simulated in reaction to the simulated stimulus.

New cells adjacent to the successive cells may be selectively spawned as a function of the cell parameters of the successive cells following the modification. Cells may be selectively terminated based on a measure of at least one simulated chemical at cells of the cell body. Cells adjacent to the successive cells may be selectively terminated as a function of the cell parameters of the successive cells following the modification.

Further embodiments may include a method of defining geometry of an object. A simulated environment including an assembly may be generated. A start location and an end location may be defined within the simulated environment. At least one initial cell may be generated at the start location. Locations for successive cells may be calculated, the locations being 1) adjacent to at least one of another successive cell and the at least one initial cell, and 2) a function of environment parameters. Successive cells may then be generated to form a cell body including the at least one initial cell, the cell body extending from the start location to the end location and including a portion adjacent to the assembly. The cell body may be modified in response to at least one simulated force applied to the cell body. A geometry for an object may then be defined based on a geometry of the cell body.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates a model assembly within a simulated environment rendered by a CAD tool with which example embodiments may be implemented.

FIG. 1B illustrates the model assembly including a model part having a geometry defined by a growth-based design (GBD) solution.

FIGS. 2A-B are flow diagrams illustrating example control processes in one embodiment.

FIGS. 3A-B illustrate configurations of cells within a simulated environment.

FIG. 4 illustrates a lateral 2D view of a base stem growing from a wall in one embodiment.

FIGS. 5A-B illustrate lateral 2D views of cell bodies growing from respective walls in further examples.

FIG. 6 is a flow diagram illustrating an example process for growing bases from existing base cells.

FIG. 7 illustrates a lateral 2D view of a base stem in a process of determining a best direction to create a new base cell.

FIG. 8 is a lateral 2D view of a population of cells displayed with only their boundary and internal springs.

FIG. 9 is a flow diagram illustrating a process of spawning cells.

FIG. 10 illustrates one of a number of existing cells in the process of spawning a new cell along one of its boundaries.

FIG. 11 illustrates a cell division.

FIG. 12 illustrates cells undergoing a strengthening operation.

FIG. 13 illustrates a process of selectively destroying cells.

FIG. 14A-B illustrate a cell body having a honeycomb region.

FIG. 15 is a block diagram representing a data structure that may be implemented in example embodiments.

FIG. 16A-J illustrate a sequence of growth and modification of a cell body in an example embodiment.

FIGS. 17A-J illustrates a sequence of operations to form an object in an example embodiment.

FIG. 18 is a block diagram of a hardware and software environment in which example embodiments may be implemented.

FIG. 19 is a block diagram of components of a software program that may be implemented in example embodiments.

FIGS. 20-30 illustrate a process of voxel fairing to process the surfaces of an object model.

FIGS. 31A-C illustrate a controlled growth of a cell body and formation of a model part in a further embodiment.

### DETAILED DESCRIPTION

A description of example embodiments follows. The teachings of all patents, published applications and references cited herein are incorporated by reference in their entirety.

In nature, a plant or animal begins as a single cell. Through growth, subdivision, and migration, the cell becomes multiple cells. The cell structure then morphs and adapts to its environment, and ultimately, forms a mature organism. Along the way, individual cells may emit chemical signals (called morphogens), and respond to signals from the environment and other cells. In addition, cells behave according to rules encoded in their genes. A collection of cells grows and adapts over time to produce a finished “design.” In the end, this design is naturally adapted to its environment, having benefited from continuous self-analysis, and an ability to adapt accordingly, throughout its entire growth process.

Nature operates in stark contrast to the way people work with CAD tools. Existing CAD tools require that users conceive of a design, model its geometry, and then analyze it. In nature, however, a design begins as a set of “seed cells,” and grows in response to continuous self-analysis. The organism is its own blueprint and factory rolled up into one. The design starts from a non-specialized cell and emerges into its final form, affected by both the cell's peers, as well as events in the environment. For example, a tree may grow in a certain direction, and to a certain size. Then a hurricane might come along and crack a branch, causing the tree to spontaneously adapt by strengthening the branch and trunk in other areas. In nature, designs reflect their history, showing indications of constant adaptations. Shapes emerge out of a set of constantly unfolding events.

Existing CAD tools require users to create all aspects of the geometry. Parametric Technology Corp. pioneered one of the more popular approaches, called parametric feature-based modeling, in the 1980's. With this approach, a user placed a set of features in a model, and each feature was responsible for producing geometric entities in the context of the existing geometry. The user kept adding features until the geometry was complete. A user could go back and change the feature parameters and re-execute the sequence of features in order to regenerate the geometry. The geometry, however, was unaware of its own existence, and thus, there was no concept of the geometry changing itself via some sort of a growth process operating over time.

With existing CAD tools, a user may pass the geometry of a design off to a kinematic or dynamic analysis tool in order to see how it behaves under static or dynamic conditions. Time-based simulation has traditionally been involved in the analysis process, once the geometry is complete and unchanging. For example, a user could create a bracket and then simulate stresses, strains, and failure modes as the geometry was gradually loaded up, or subjected to vibrations over time. This allowed the user to go back and modify the design features, regenerate the geometry, and then re-analyze it. The process was iterative.

More recent CAD tools have enabled users to modify geometry more directly than via features. While feature based modeling has proven to be powerful by allowing a single parameter to update an entire geometric model, feature-based modeling also forced the user to think of a design in terms of a fixed set of features up front. If the design were to change significantly, the user might be forced to start over by constructing a new set of features. Previous CAD tools operate to spontaneously recognizes patterns in geometry, such as ribs and holes, and allows the user to modify these patterns. The tool allows for rapid and unplanned changes, but still produces static, unchanging geometry. The geometry is not able to change itself via a growth process over time.

Existing CAD tools essentially lack the ability for the geometry of a design to grow in response to analytical feedback over time. This is because existing CAD tools do not attempt to simulate natural cell-based growth processes. Instead, existing tools require the user to envision fully what the geometry will look like, then model its form using the tool, and then subject it to analysis. During analysis, the design actually remains unchanged, or static, as if inanimate.

Unlike existing CAD tools, topology optimization (TO) emerged as an approach to automatically generating geometric shapes. Introduced in 1988, TO is a mathematical approach for generating optimized shapes by selecting the elements in a finite element mesh (the design space) that best maximize the tradeoffs in both minimizing material usage and maximizing part strength for a given manufacturing process. TO was conceived as an extension of the Finite Element Method, where a design shape (2D or 3D) is first meshed into discrete elements. With TO, the density of mesh elements is varied from 0 to 1 in order to find an optimal solution to an objective function such as maximizing stiffness for a given maximum volume fraction of the original part. With TO, the system picks a combination of mesh element densities and solves for the objective function, and then derives a new combinations of densities, iterating until it reaches an optimal combination of densities.

TO approaches are fundamentally different when compared with the growth based design approach taken in this invention. Both approaches break the volumetric space into a system of volumetric elements. In the growth based approach, however, these elements are populated with cells as they are born, and while the cells are alive, cells maintain a constantly changing state, which goes away when cells die and are removed. During the life cycle of a cell, a cell may vary its state based on the states of other cells in the environment as well as in response to external stimuli, including forces (e.g. applied, gravitational, normal, friction, and reaction forces), radiation sources (e.g. heat and light sources and electric fields), and chemical reactions (e.g. oxidation/reduction reactions) Additionally, a cell may vary its state in response to its proximity to environmental structures such as walls and surfaces. The decision to add and remove cells in the proximity to other cells is based on the constantly changing state of existing cells—which survives over many iterations. With TO approaches, there is no “cell” object occupying each volumetric element, whereby the cell state varies over time and can affect other cells as well as the decisions to create or kill subsequent cells. With TO approaches, mesh elements are simply represented by a density value, and the decision to change mesh density values is based on simulation results from the current iteration. To summarize, TO uses only the current state of the system to make decisions on the next state of the system, whereas the growth based design approach uses the cumulative effect of all prior states of cells to make decisions on the next state of the system.

Another more automated approach to refining a design is via genetic algorithms. Genetic algorithms automatically rank a large collection of design variations (represented by a collection of vectors containing name/value pairs). Genetic algorithms obtain a new generation of offspring using a technique of combining vectors of various “parent” vectors. Genetic algorithms require that the user provide an external system that “tweaks” or modifies a design based on a set of input parameters. These algorithms also require that the user provide an external analysis system that can provide a rank, or “score” for a design variation. The genetic algorithm simulates “survival of the fittest” evolution. The core of the genetic algorithm is a means of generating a set of new design parameters (not the designs themselves) by combining and mutating the design parameters of the fittest parents. Thus, genetic algorithms do not attempt to generate a design from input parameters, nor do they attempt to analyze a design in order to determine its fitness.

Lindenmayer systems (“L-Systems”) were designed to model growth processes of plants and organisms that exhibited large degrees of self-similarity, or fractal-like repetition. They consisted of an alphabet of replaceable symbols, along with a set of fixed symbols, or constants, and a set of production rules. Each production rule was designed to specify a match pattern as a sequence of symbols, and a replacement pattern as a new sequence of symbols. Given an initial set of symbols, the idea was that one could traverse the initial set of symbols and apply the production rules that matched, replacing each group of matched symbols with the replacement symbols for that rule. This process would be applied iteratively, producing an increasingly complex set of symbols. By associating various drawing rules with symbols, one could process a collection of symbols and produce a 3D structure resembling structures such as a branching plant, a snowflake, or a Penrose tiling.

L-Systems supported variable-sized sets of production rules. One could add as many rules, with as much complexity to the rules as one desired. One limitation of L-Systems, however, was that each rule could only be defined as a match on a sequence of symbols, where each symbol represented an atom or building block in the system. In other words, the rules were simple replacement rules based on the existence of a symbol match. One could not, for example, define a rule that dictated that if a symbol (i.e., a building block) were being crushed by the excessive weight of lots of (symbol) building blocks resting on top of it, then the symbol would spawn a neighbor, or else die if the weight were too excessive. While this type of rule does not even make sense in the context of an L-System comprising an alphabet of symbols such as letters (A, B, C), it does illustrate a level of complexity not supported by L-Systems.

L-Systems essentially support basic rules that rewrite patterns of symbols with new patterns of symbols. L-Systems do not, however, provide a means of plugging in external sub-routines to evaluate physical characteristics of the whole system. For example, they lack an ability to measure the positions, velocities, forces, stresses, and accelerations of entities in the system, and to make changes to these properties between applications of production rules. Given this, L-Systems may be capable of modeling some aspects of automated replication, but they do not incorporate the types of physical simulations and continuous feedback mechanisms that living organisms experience at the cellular level.

Example embodiments provide a software system referred to herein as growth-based design (GBD). Growth-based design is an approach to computer aided design (i.e. CAD) that enables users to model the way things grow in nature. The system provides a set of cellular building blocks that capture the behaviors of growing cell populations. The user works with these building blocks to construct a design recipe that grows a set of seed cells into a physical structure. Users benefit from this solution by being able to create naturally self-optimized designs that they wouldn't have been able to envision on their own.

The cellular building blocks mentioned above are software implementations of multi-dimensional cellular objects that know how to grow, spawn child cells, subdivide, and die in response to a constantly changing environment. The user directs the system to snap a collection of these cellular blocks together in a sort of “virtual Petri dish,” where one can set up the initial boundary conditions such as walls and forces. The user instructs the system to trigger growth through the elapsing of time. The tool lets the user stop the progress at any point, and interact with the design before resuming. This approach contrasts with existing CAD tools where there's no concept of autonomous cell growth, and where the user must develop an idea in his or her head, and then create the geometry explicitly.

In nature, much of the “design” of things comes from the constant adaptation of plants and animals as they grow into their environments. Man-made things, in contrast, have traditionally been conceived of and manufactured outside of their operating environments. They are dropped into place, only to succeed or fail. Example embodiments can provide design tools that blend principles of growth and adaptation with elements of human creativity. In particular, example embodiments may provide elements of cell-level growth behaviors, and include them into a toolset of building blocks for creating structures.

A growth-based design approach, as described in example embodiments below, presents a solution that is distinct from traditional CAD. Rather than begin with a whole design, and break it down into parts for analysis with the Finite Element Method (i.e. FEM), growth-based design starts with parts and grows the design into the whole. This approach takes guess-work out of design, eliminating the need for users to try a design, analyze it, make changes, and try again. With growth-based design, the analysis is built right into the design, so analysis is not left as an afterthought.

By implementing a growth-based design approach to define a geometry of an object, example embodiments can provide structures having shapes that take on a natural and functional form that emerges from the growth process. During such a design process, the shape of the structure may result from a constantly-adapting form, which at one point grows to get stronger, and at other times, atrophies via cell destruction to gain efficiency. As a result, there's a compounding effect of changes, or “history,” built into each design that gives it several advantages.

Growth-based design is applicable to virtually any type of design problem, provided that one first creates a suitable library of cellular building blocks, and a modeling environment that captures the necessary boundary conditions. One example embodiment focuses on the modeling of 2D planar structures. In another embodiment, there may be a library of cells for modeling 3D surfaces and volume-filling structures. In each embodiment, the growth-based design system may provide a “scaffolding structure” which serves an abstract platform upon which cells may grow. In the 2D plane, and 3D surface cases, this scaffolding may be referred to as a “cell fabric.” A cell fabric may define the allowable cell locations, including cell orientations and cell-to-cell attachments that are allowed in the cell population.

In example embodiments, one important aspect is the ability for a cell population to selectively destroy cells in addition to spawning new cells. This enables the system to optimize the shape of a structure by not only growing cells where needed, but destroying them where they are not needed, continuously over time. Solutions may utilize a number of measurements in determining whether or not to create a new neighboring cell, or destroy a cell. For destroying a cell, the system may calculate a time-averaged value of overall strain, where both compression and tension of internal and boundary elements such as springs factor into the overall strain.

In determining whether or not to create a new cell as a neighbor to another cell, a system utilizing growth-based design may also utilize a number of measurements. In one approach, the strain of a structural element such as a spring along an individual cell boundary may cause the system to determine that the cell needs the help of a neighboring cell in order to reduce its deformation along that boundary.

Example embodiments can assist users in developing optimal designs, mechanical or otherwise. The cell-based model produced by the system may directly represent a structure to be manufactured, or may be used to fit smooth surfaces to its initial shape, and serve as a source for generating CNC machine tool instructions used in producing manufactured parts and assemblies using materials such as steel, plastic, sheet metal, or wood.

Example embodiments may also provide geometries for use in 3D printing applications. The latest advances in 3D printing technologies allow material properties of the printed medium to be varied continuously throughout the structure. This allows the structure to have stronger materials in areas that may experience higher stress. Growth-based design is well suited to leveraging this new capability because cell growth process can incrementally improve material properties in areas that experience higher stress.

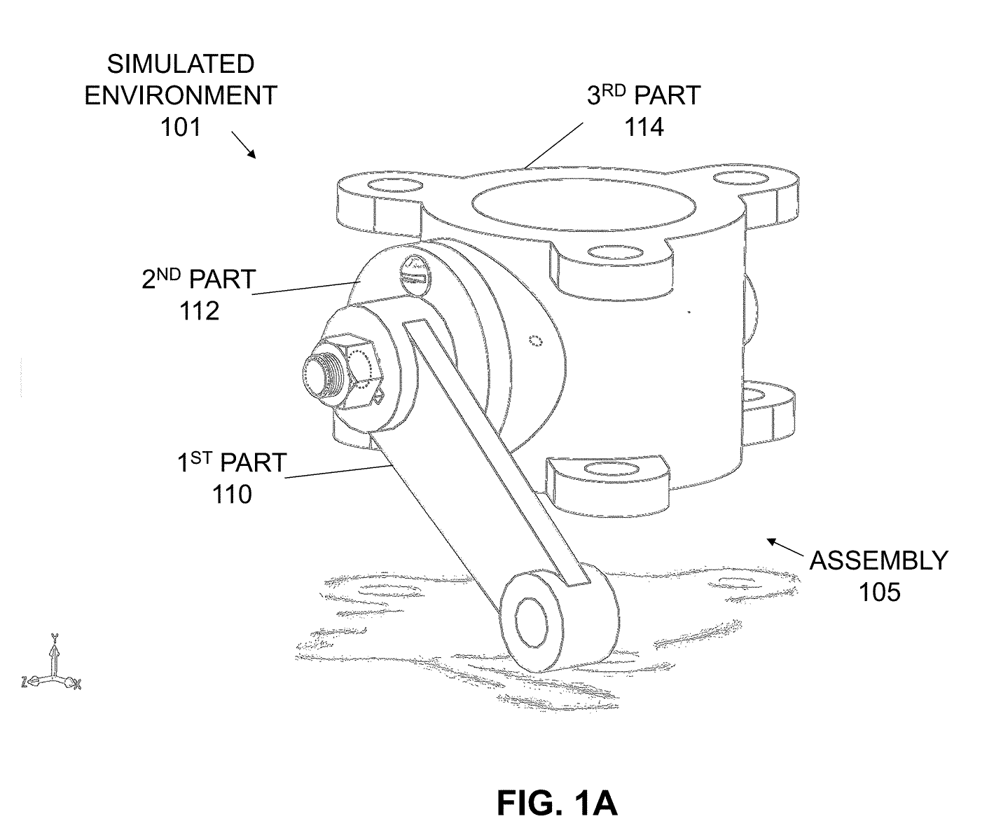

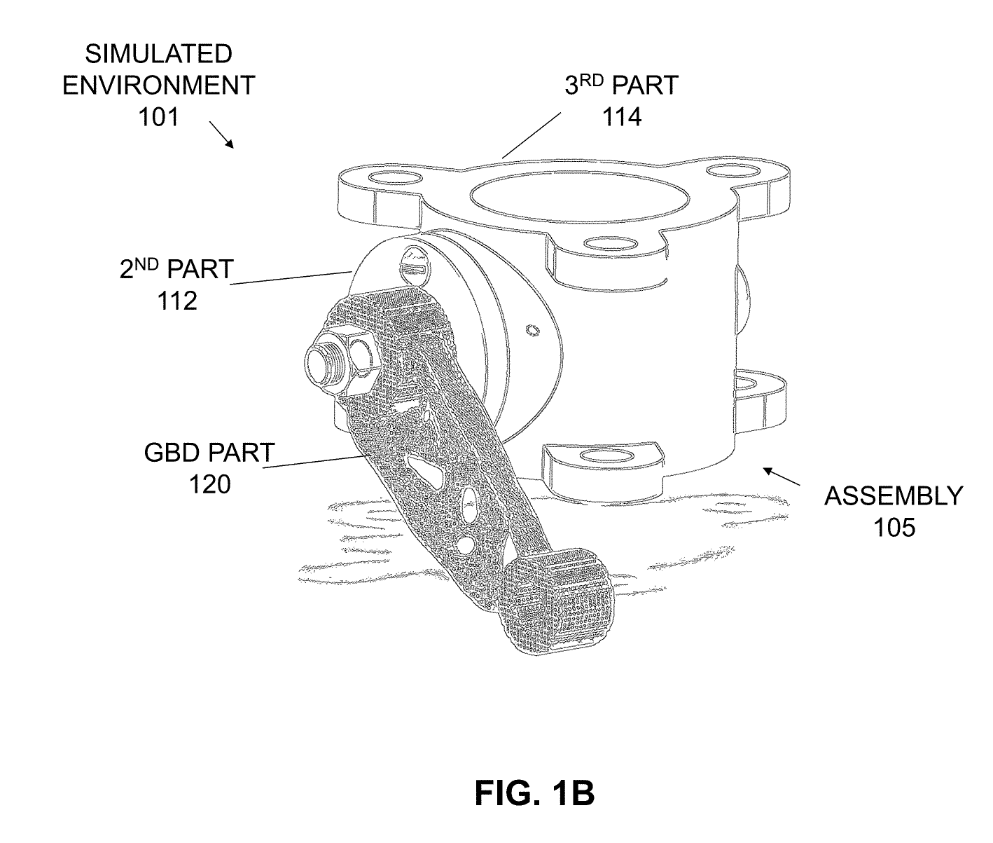

FIG. 1A illustrates a model assembly 105 within a simulated environment 101 rendered by a CAD tool with which example embodiments may be implemented. The view shown in FIG. 1 may be, for example, a screenshot of a portion of a CAD user interface. The assembly 105 may include multiple individual modeled parts, including a first part 110, and second part 112, and a third part 114. The parts 110, 112, 114 may be coupled together using modeled fasteners (e.g., bolts, nuts, and screws), and the CAD tool may model the physical properties and real-world operation of the assembly within the simulated environment.

Example embodiments can provide for automatically generating object models using GBD solutions. The object models can be generated to meet predetermined parameters, constraints, performance criteria, or other design requirements. For example, a model may be generated to replace one or more of the parts 110, 112, 114 of the assembly. Further, in meeting particular design requirements, the object model may have a geometry that is superior to the geometry of a corresponding hand-designed part (such as the parts 110, 112, 114).

FIG. 1B illustrates the model assembly 105 of FIG. 1A, but modified to replace the first part 110 with a model part 120 having a geometry defined by a GBD solution. The GBD part 120 may have a geometry defined as a result of a GBD process described herein. The GBD part 120 may possess a number of advantages over the first part 110, such as higher durability, higher strength, lower volume (and thus more efficient use of build materials), and greater ease of manufacturing by some manufacturing.

A part having geometry defined by a GBD solution, such as the part 120, may also have several advantages when manufactured via metal injection molding (MIM) and additive manufacturing (3D printing). Both such manufacturing processes may impose certain constraints or limitations on geometries and materials of objects to be manufactured. For example, a debinding process may require objects not to exceed a maximum thickness in order for the green object to be efficiently debinded within an acceptable period of time. Further, a 3D printer may be able to generate green objects having certain geometries more efficiently, and with higher fidelity to the original design, than objects having other geometries. For example, object geometries that can be printed via more continuous toolpaths, fewer discrete segments at each layer, and minimal layer-to-layer differential, may yield higher-fidelity objects that can also be manufactured more quickly by a 3D printer. It may also be advantageous to generate a part meeting design requirements while using minimal material. Example embodiments can generate object models for implementation in MIM and/or 3D printing, and can generate those objects to confer some or all of the advantages described above.

Example embodiments, described below, include systems and methods of providing object geometries via GBD solutions. Systems incorporating example embodiments provide design tools for simulating the growth of a physical structure using a cell-based approach. Users work with a palette of setup features which they add to an environment comprising initial constraints such as forces, and fixed locations. The environment may support keep-out regions to prevent cell growth, fill-in regions to enforce cell growth, and containing regions that act as cages to contain cell growth. Additionally, users may define signaling sources that form gradient fields called morphogens. The user may also define seed cell connections that specify start locations for cells upon fixed surfaces and target locations for stem growth to terminate at forced surfaces. The user may add a collection of features to an environment that may contain assembly geometry of parts to which the grown part or parts must mate and align. The features allow the user to select geometry in the assembly to be associated with fill-in, keep-out, and container regions. When the setup is complete the user may trigger cell growth to begin. Cells begin to grow from seed cells in the directions of target locations to form stems. As time steps progress, the environment may vary the initial stimuli in the form of forces, heat sources, electrostatic fields, and chemical concentrations that may act upon the cell body. These stimuli may further trigger the environment to update a multi-physics engine that produces cell level reactions to the stimuli. These reactions may include changes to the positions of cells; changes in strains, stresses, temperatures, and other cell-based parameters representing responses to stimuli upon the cell body. As cells within the cell body react to changes in stimuli, their parameters representing immediate changes such as strain may cause a set of other parameters to update. These other parameters may represent what would be referred to as chemicals within real cells. These other parameters may update to simulate reaction, diffusion, and decay of chemicals across cell boundaries. For example, when a cell's strain parameter increases drastically from one frame to the next, a second parameter representing a strain chemical in the cell may initially spike or “react” by increasing in response to the drastic increase in the strain parameter. But then a second modification of the strain chemical parameter may cause it to decrease in order to simulate diffusion of the high concentration of the chemical in one cell to a lower concentration of the same parameter in a neighboring cell with a lower value of the strain chemical parameter. Finally, after the diffusion, the strain chemical parameter of the first and other cells may further update by dropping in order to simulate a decay or “sink” of the concentration over time. Once the cells' parameters have been updated, the system may spawn new cells, kill existing cells, and modify the connections of these cells with neighboring cells and supporting structures. One purpose of the secondary modification of parameters based upon the values of the same parameters in neighboring cells is to average or damp out the immediate changes to cell parameters based upon changes in stimuli. Another purpose is to allow cells to propagate signals to other cells. For example, if a cell updates by dramatically increasing its strain parameter, the diffusion and decay into other cells may serve to signal to neighboring cells a high strain. This may enable the cell body to effect cell growth in a general area where a single cell may experience a high strain. By increasing the diffusion rate upon each frame tick, this signal may be propagated to a wider area of neighboring cells spurring a more regional growth. Alternatively, by increasing the decay rate of the strain chemical parameter, the size of the signal area may be reduced causing a more localized growth.

As time elapses, the system may trigger the introduction of additional forces such as point loads and keep-out regions. As time passes, the cellular structure may adapt to changes imposed by the environment. In the same way that a tree grows to support its own increasing weight over time, a cellular structure may adapt to a collection of varying dynamic loads.

Once a cellular structure has reached a certain level of maturity (as measured by cell age or elapsed time), the system may be triggered to unleash a cell-destroying process that causes cells to self-terminate if they meet certain fitness criteria. One such criterion is low strain or low value in a strain chemical parameter, whereby a cell may not be participating significantly in holding up the structure, and thus may sense little strain. In many cases, cells created early in the design process may no longer be needed to support the structure. Because the overall cell population may have changed, cells that may have formed at the core of a “stem” structure early on may end up with little or no strain as younger cells on the outside of the stem take up the shifting loads. The system supports a form of cellular apoptosis, whereby less needed cells are destroyed as part of optimization strategies such as weight minimization. As cells die, neighboring cells immediately feel the effects of the increased average loads per cell. This may cause the system to enter a phase whereby cells are both destroyed and spawned simultaneously in order to reach equilibrium. The system may activate these cell-terminating processes at different points in time in the same way it activates and configures loads, mounting structures, cell-signaling sources, at different points in time.

In nature, morphogens play a significant role in governing the collective behavior of a cell population. Morphogens are chemical signals cells use to communicate among peers. Cells may sense the presence and strength of morphogens emitted by other cells, and they may emit their own morphogens in response. Morphogen concentrations may drop the further away a signal is sensed from its emitting cell. This requires a cell population to exist within a substrate that's capable of both holding and dissipating a chemical concentration.

In example embodiments, individual cells may be configured to emit signals which diffuse throughout the medium (referred to as a cell fabric) and form gradient fields. A simple example may be a point signal whose concentration may decrease in proportion to the distance from the source location. Cells may sense morphogens and use these signals as clues to govern the direction of cell spawning. Through the use of morphogens, cell populations may be nurtured into growing in certain directions. Morphogens may also be used to define “keep-out” and “fill-in” regions, causing cells within these regions to die and be removed by the system over time.

A system may maintain an in-memory software structure called an “environment” that is used to house the products of the growth process. This environment may contain a set of active structures such as cells, whose processes the system may periodically execute at different points in time. In addition, the environment may contain a number of inanimate objects such as walls and static fields such as gravity. The previous sections described several types of environmental processes, including those relating to cells, such as growth, destruction, and spawning processes. Some of these processes, such as neighbor spawning, may operate within the structure of an individual cell, whereas other processes, such as signal emitters, may operate at the top level of the environment.

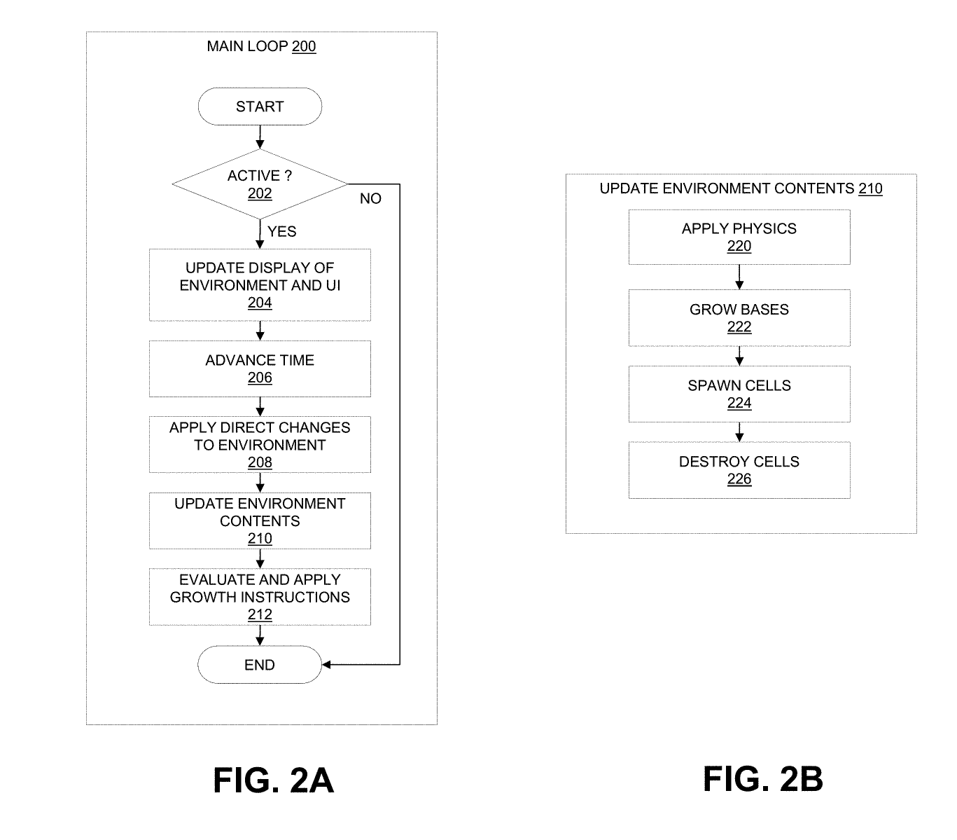

FIGS. 2A-B are flow diagrams illustrating processes that may be carried out by example embodiments. FIG. 2A illustrates a main loop 200 that may be carried out to generate and maintain a simulated environment. In one embodiment, a system may set up a simulated environment with initial structures, forces, signal sources, and/or other elements, and then operate a main loop, such as the main loop 200, in which time is elapsed. The main loop 200 may be responsible for directly adding and removing structures to the environment, and for allowing each element in the environment to have an opportunity to execute its own processes, such as cell spawning. The main loop may also update a physics engine used to simulate the physical behavior of elements in the environment over time.

Under such an application, a system may take the form of a batch program in which the user may write a body of logic within the main loop 200, run the program containing the loop, and then modify it, and rerun it. For example, a user might add a set of coded instructions (in a language such as Java or C++) to the main loop to first create a wall, a keep-out region, and a seed cell, all at time=0. Each instruction in the main loop may further comprise one or more configuration parameters such as the direction for a seed cell to grow, or the initial value and direction of a point load. Each instruction may also include activation and deactivation times, or other conditions for determining when to be active in the main loop. For example, a point load may be programmed to activate when two seed cells have fused together and stopped growing.

The operation of such a batch program may involve starting the program and running it until the program receives an interrupt from the user. Alternatively, such a program may run for some number of cycles and exit on its own. In one embodiment, the program may operate in a mode without a graphical user interface.

Referring again to FIG. 2A, the main loop 200 may perform operations including: a) determining if the loop is active (202), and if so, b) advancing to the next operation of updating the display of the environment and user interface (204), c) advancing time (206), d) applying direct changes to the environment (208), e) updating the environment contents (210), and f) evaluating and applying growth instructions (212). Once the main loop 200 has completed, it may repeat until interrupted.

The update to the environment (204) may include drawing a graphical 2D or 3D representation of the environment's contents, and a timeline indicating the current time of the growth process. When applying the direct changes to the environment (208), the system may change the state of the environment via program logic embedded directly into the main loop. When updating environment contents (210), the system may give each entity in the environment a chance to modify not only itself, but any other aspect of the state of the environment. When evaluating and applying growth instructions (212), the system may allow an externally-supplied body of logic (referred to as growth instructions) to operate on the contents of the environment. These instructions may, in turn, correspond to a set of growth instruction instances which are instantiated software classes capable of operating upon the contents of the environment.

FIG. 2B illustrates the process for updating environment contents (210) in further detail. The process 210 may include: applying physics to the environment (220), growing stems in the direction of target locations (222), spawning cells (224), and destroying cells (226). The operation of applying physics 220, may involve repeatedly incrementing a physics engine a number of steps such as 10 steps, whereby the step size may be a small value on the order of 0.0005 seconds. By giving the physics engine a chance to iterate several times during a single execution of the main loop, the system is able to partially propagate any concentrated stresses that may have arisen due to the sudden spawning or destruction of a cell whose elastic member (i.e. spring) resting lengths may differ from those of its neighbors by an amount greater than a specified threshold, such as 1 percent. The physics engine may be responsible for managing the positions, velocities and accelerations of cell nodes, along with springs and dampers representing the cell boundaries and internal supports. In another embodiment, a physics engine may manage a set of attachment constraints among nodes, rigid body constraints along cell boundaries, collisions between cells, and soft body dynamics to support deformable behavior. In another embodiment, a physics engine may model the behavior of cell material using the finite element method and a set of applied material properties to each cell, including Young's Modulus, the compressive and tensile yield stresses of the material, Poisson's Ratio, and material density.

The operation of growing stem bases 222 provides the system with the ability to simulate growth at locations known in nature as growth points, or meristems. A meristem, in nature, is a location in plants where cells are able to spawn new cells as neighbors through subdivision. In example embodiments, subdivision is modeled as a programmed creation of a new cell along a boundary of a specially designated cell called a base cell. This cell creation often takes place in a specified direction aligned with a signal source. The operation 222 may comprise evaluating each base cell in a cell population to see if it is able to spawn a new cell. In one embodiment, the system may skip operation 802 on a particular cycle in order to slow the rate of base cell growth. The rate of skipping may be a quantity such as 95%, meaning that growing bases may be triggered only 1 in 20 cycles.

The operation of spawning cells 224 may involve iterating over the population of cells and executing a “spawn cell” method on each cell. During cell spawning, a cell is given the opportunity to trigger the creation of new cells along any of its empty boundaries.

The operation of destroying cells 226 may involve iterating over the population of cells and first determining the highest priority candidates for destruction based on cell parameter values, and then destroying a subset of these cells. The system may request each cell to compute and return an updated measure of its strain, or a parameter representing a diffused strain chemical, then sort the set of strains or strain chemicals, and remove a number of the least strained cells. The number to remove may, for example, be a maximum of 0.5% of the total population, or a maximum of between 1-3 cells per cycle if the system has entered a slowed cell destruction period. These values may also be varied.

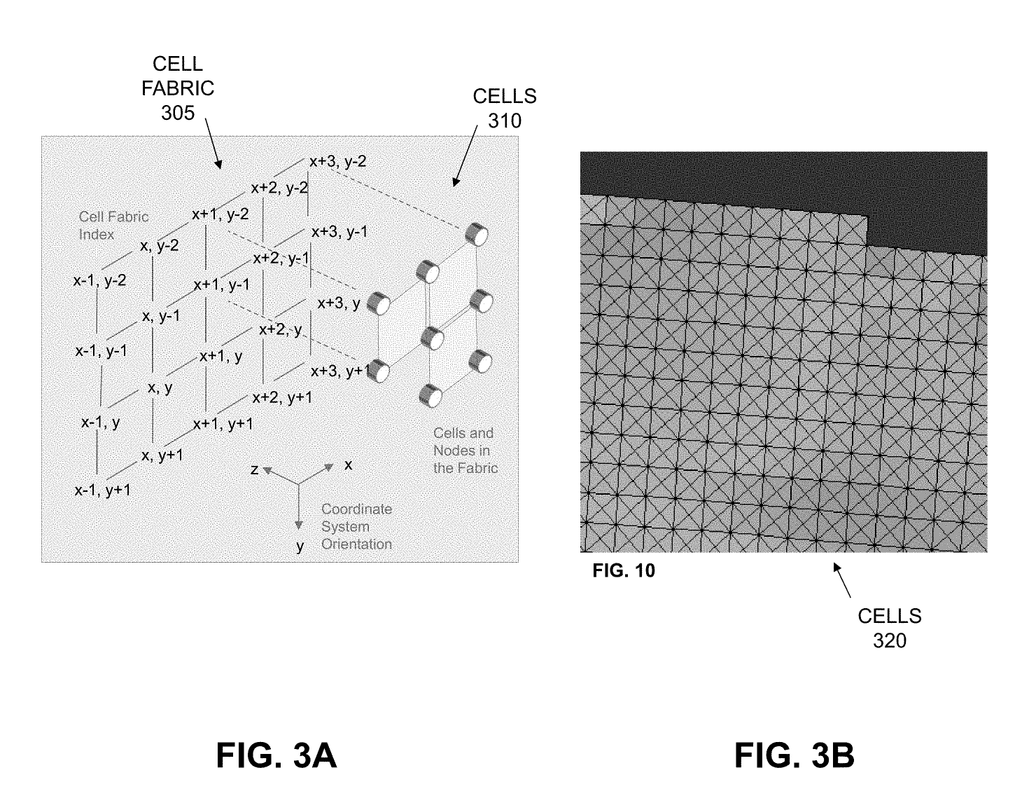

FIGS. 3A-B illustrate configurations of cells within a simulated environment. Example embodiments may provide a grown structure within the environment, the structure comprising a set of cells. Cells may be attached to one another. Each cell may have an idealized representation comprising one or more physical elements, including springs, dampers, and masses. Basic 2D cells may comprise a set of mass nodes connected by a set of boundaries and crisscrossing internal springs and dampers. Cells may be capable of measuring properties of their structural elements, including, but not limited to, measuring the average stresses and strains experienced by a weighted combination of the cell's springs. These measurements may furthermore be averaged over time to filter out rapid fluctuations in values. In another embodiment, the system may utilize an FEM physics engine to model the behavior of cell material as opposed to modeling the behavior as a set of idealized springs, masses, and dampers.

Cells may spawn the creation of new neighboring cells along their boundaries. If a cell is getting compressed or stretched too much along a boundary, it may spawn a neighboring cell on that same boundary in order to help counteract its own deformation. Two cells sharing a boundary may provide two boundary springs between corner nodes, and thus, resist compression and stretching better than if only one cell occupied the boundary. Conditions for spawning a new cell may include that the boundary not already have a neighbor, and that the boundary spring be experiencing compression or tension strain in excess of a specified threshold.

A cell may be attached to a neighbor by sharing one or two boundary nodes. This approach prevents tearing of cells apart. To support cell tearing, an attachment constraint may be used to bind non-shared nodes of two cells and provide a threshold for separating. Once the threshold is met, the coincident nodes are released, allowing the cells to move apart. A cell may also be attached to a fixed structure such as a wall. The boundary nodes of an attached cell are not allowed to move. When new cells are spawned next to a fixed structure, they may be attached to the structure along one or more boundaries due to their close proximity. A cell may have a point force attached to it via one or more of its nodes, and a cell may be subjected to one or more force fields such as gravity. A cell that is not fixed may move. A cell may comprise a set of nodes, some of which may be shared by neighboring cells. These nodes may have masses and velocities that vary from node to node, and whose values may vary over time. This allows a cell to move in a non-uniform manner, as its nodes may move independently. A cell may destroy itself based upon a set of built in rules and obtained measurements. For example, a cell may determine that it is experiencing too little or too much strain. It may also measure a property of itself with respect to the environment, such as the distance of the cell's center to a point representing a keep-out region. If the distance is less than a specified threshold, then the cell may destroy itself. When a cell detects that no other cells are using one of its corner node, it destroys the corner node when it destroys itself.

The representation of cells described above is one of many possible representations. The system may support substitution of different physical models for cells. Alternate approaches may include modeling cell masses at their centers, rather than at the corners of cells. Also, the cell material may be rigid or deformable, rather than elastic with damping. The system may also model the attachment of cells to one another by using small attachment springs, or constraint models that allow for detachment, or tearing, once a certain force threshold is attained. The cell may also support internal growth, whereby the cell's springs may be increased in stiffness over time or with age in order to allow the cell to resist deformation. The number of springs and arrangement of springs may also be altered to simulate increased or decreased flexibility. This may include removing one or more of the crisscrossing internal springs and dampers. A cell may also increase the resting length of one or more of its springs in order to skew the orientation of opposing boundaries. A cell may use this technique to orient itself with respect to a signal source such as the direction of light or another cell that is emitting a signal.

A cell and its neighbors may be logically organized in a grid formation called a cell fabric. A cell fabric may be 2D or 3D. Each cell belonging to a cell fabric may have an identifier (ID) comprising an x, y, and z index portion that corresponds to the cell's location in the fabric grid.

FIG. 3A illustrates a set of cells 310 positioned relative to a cell fabric 305. In this example, cells form a planar rectangular grid. FIG. 3B illustrates a set of cells 320 aligned with a rectangular cell fabric, and also displays corner nodes and both internal and boundary springs of cells. Referring to FIG. 3A, the cell fabric 305 may impose an ordered structure upon a population of cells. The cells associated with a cell fabric need not be physically connected, but they are logically related. Cell nodes in the fabric are logically ordered into an x-y-z grid. A node may occupy any physical position in space, but each node may have an ID that identifies it relative to the other nodes using x-y-z notation. When the system creates a new node relative to existing nodes, the new node may receive an ID that logically places it relative to the IDs of the neighboring nodes. For example, if a new node were to be created to the right (positive x direction) of an existing node, the new node might get an ID comprised of an x, y, and z portion, whereby the x portion is 1 greater than the x portion of its immediate neighbor to the left in the x direction. The x, y, and z portions of a node's ID are referred to as the location of a node in cell fabric space. This location is fixed over time, whereas the physical position of a node may change as it moves around in space. One purpose of a cell fabric is to provide an un-deformed representation of cells in space, invariant over time. The logical organization of cells in a fabric does not change, even though cells may physically move relative to one another due to forces such as gravity. Cell fabrics may be square grids, hexagonal, triangular, or may follow any grid pattern represented by the node locations in space on regular polyhedrons, such as the dodecahedron. Cell fabrics may also follow irregular patterns such as a Penrose tiling formation.

A cell fabric may provide an underlying structure that organizes a growing and shrinking cell population. A cell fabric may prevent pleats, which are regions where sequences of cells reverse direction in space. A cell fabric may also facilitate filling of gaps in a cell population because the system may easily determine if a cell has any immediate neighbors simply by comparing the x, y, z indices of its nodes to those of neighboring cell nodes, rather than comparing the positions of the nodes in space. For example, suppose a fabric were to form a gap of several cells wide, and then the system started creating new cells to fill the gap. The fabric structure would make it easy for the system to determine if new cells were ready to fuse with cells on the other side of the gap. This is because the fabric supports a finite number of cells within a region such as the gap, rather than an ambiguous number, in the case where cells can overlap. The cell fabric may act as an abstract scaffolding in the sense that it can be deformed, but it won't allow an irregular pattern (i.e. non-rectangular in this case) of cells to form.

As cells are spawned into a cell fabric, they may be constrained to attach to their immediate neighbors, and fill up the structure, eliminating gaps. In such a fabric, there is a known number of “slots” available between any two cells in a certain direction. Another type of cell fabric may form a rectangular grid wrapped onto a cylinder. In other embodiments, cell fabrics may form geodesic domes, and may exhibit hexagonal or other patterns.

For 3D volume-filling structures, a cell fabric may be volumetric and have 3 dimensions. In one embodiment, a cell fabric may support sets of interconnected cubes or space filling tetrahedrons. In another embodiment, cells may be allowed to connect to form non-uniform grids with branching cell fabrics.

When the system spawns a new cell in the x, or y direction along a cell fabric, it may check to see if the new cell should be fused to any pre-existing cells. Fusing may be accomplished by having two cells share some of the same nodes. For example, if a new cell were going to use new nodes, such as 35-112-0 and 35-113-0 (x, y, z index notation), and these nodes were already being used by another cell, then the new cell could be instantiated to share the nodes—thus fusing it to the neighboring cell. If no pre-existing cell were using these nodes, then the system could create new nodes and assign them to the new cell. This way, the system may automatically stitch up gaps by creating new cells and attaching them to neighboring cells by way of using the common nodes. One can see that the cell fabric makes it easy for the system to determine if a new cell has potential neighbors based on the fabric positions of the cell nodes.

When the system removes a cell, it may check to see if there are neighboring cells using the cell's nodes. If not, then the system may destroy the cell's nodes when destroying the cell. A cell fabric may maintain a map of nodes, keyed by their x, y, and z indices. A map of nodes allows the system to quickly determine if a node is occupying an indexed location within the fabric, regardless as to the node's location in space.

By comparing the IDs of two cells in a cell fabric, the system may determine the number of cell “slots” that separate the cells in one or more dimensions. In a 2-dimensional rectangular fabric, slots are analogous to rows and columns. The integer offsets among the x, y, and z portions of cell IDs provides a quick way for the system to determine the number of slots separating cells, without having to resort to comparing the physical locations of cells in space.

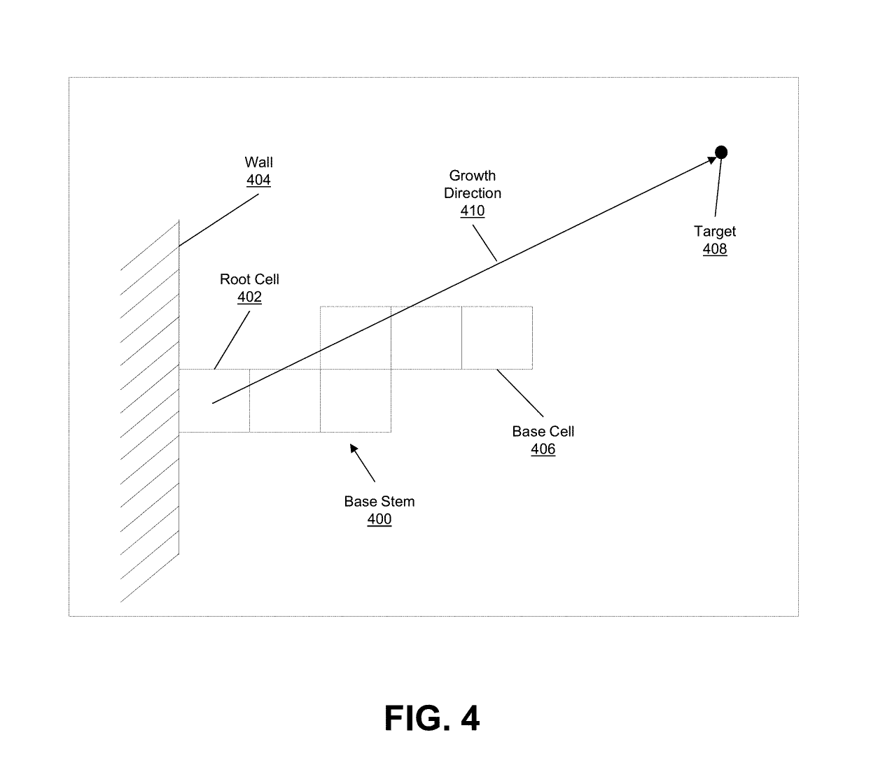

FIG. 4 illustrates a lateral 2D view of a base stem 400 growing from a wall 404 towards a target location 408. An example system may maintain one or more base cells (e.g., base cell 406). Base cells are specially designated cells where pre-programmed cell creation occurs in a specified direction. This cell creation is referred to as base growth.

When a base cell creates a new cell, it may transfer the designation of “base cell” from itself to the new cell. In this way, a base cell may continuously remain at the tip of a growing stem. The system may designate an original base cell in a stem 400 as the root cell 502. This root cell 402 may be attached to a wall 404 or other fixed structure or surface. The system may attach the root cell 402 by setting the positions of two or more of its nodes to be fixed over time. The system may also keep track of the current base cell 406, located at the tip of the base stem 400. In addition, the system may associate a target location 408 with the base stem, and use this target location to derive a growth direction 410 for the base cell in the stem. The system may use a collection of multiple growing base stems to form initial structures in a cell population. In the same manner that a spider may spin a single thread to span a gap, and then build a web off this of thread, a base cell may form a stem resembling a thread. Once threads have formed, they may grow towards common target locations (e.g., target location 408) where they may eventually fuse.

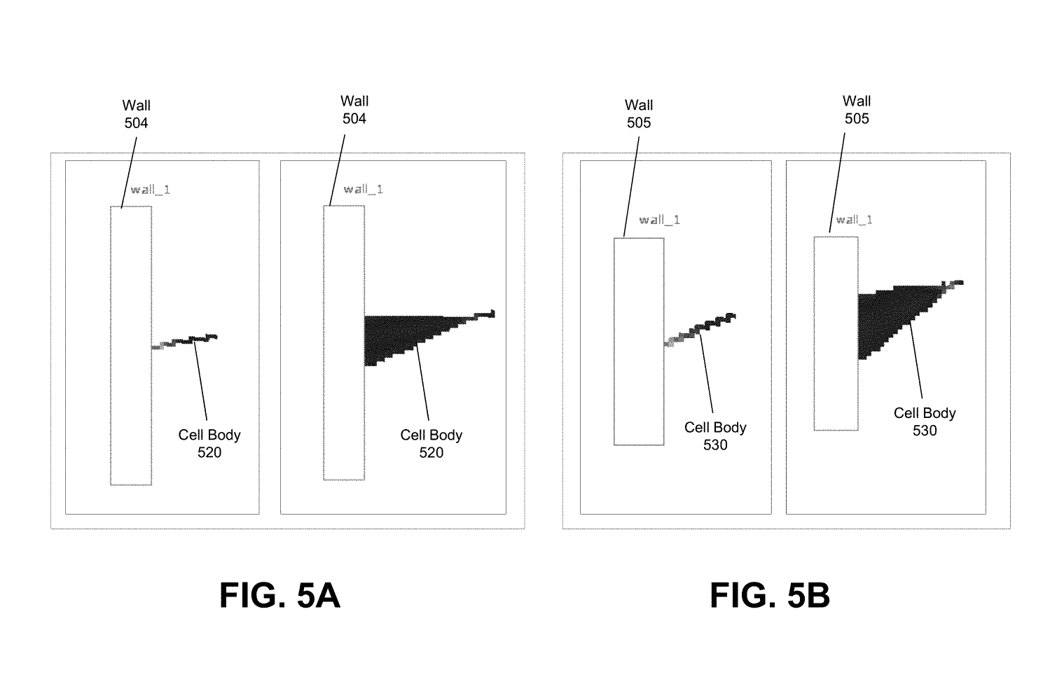

FIGS. 5A-B illustrate lateral 2D views of cell bodies 520, 530 growing from a respective wall 504, 505 in further examples. Here, as in FIG. 4, base stems are grown from an initial seed base cell attached to a wall. In the first case, the direction of growth was designated to be a vector pointing upwards, whereas in the second case, the vector points downwards. The direction of growth may be fixed, but it may also change over time in cases where a base cell stem is tracking towards a moving target such as the base cell at the tip of another base stem.

The first frame of each of FIGS. 5A-B shows that cells towards the base of the stem begin to experience higher strain due to bending, as the stem grows outwards from the wall. Base stems may grow outwards from a base cell, but they may also grow fatter as a means of resisting bending and collapse. A process, whereby cells may spawn neighbors along their uninhabited boundaries as a way of strengthening these boundaries and resisting stretching or compressing, is described in further detail below. FIGS. 5A-B also illustrate how cells near the root of a base stem have spawned new cells in order to reduce the level of bending in the stem, due to gravity pulling downwards on all of the cells.

In plants, base cells are analogous to meristems. Meristems are regions where cells subdivide, usually in a direction towards a stronger chemical presence, known as a morphogen. In organisms, for example, specific stem cells may send out chemicals that diffuse from opposing ends of a nascent structure in order to form a strong concentration along a line. Other cells may sense a close proximity to such a chemical line and migrate towards the line, or produce new cells of their own through subdivision.

Referring again to FIG. 4, a base cell 406 may store a fixed vector as the growth direction 410 to create a new base cell. Because the normal vectors of the base cell's boundaries may not align precisely with this direction, the base cell 406 may compare its boundary normal vectors with this fixed direction and choose a boundary normal vector that results in a new cell that best fits the fixed direction. One base cell may create a neighbor in the upwards direction, while its successor may create one in the horizontal direction. Over time, the collection of new base cells may form a line that matches the specified direction 410. FIG. 4 thus illustrates the step nature of a base stem where cells are created sometimes upwards and sometimes horizontally to closely track the growth direction. In another embodiment, a base stem may follow a step wise trajectory in 3 directions.

Because many cells in a cell population may be free to move about in space over time, their physical positions (which may change) may not coincide with their cell fabric positions (which are fixed to specific indices in the cell fabric coordinate space). As a result, the system must decide if it is going to use cell fabric positions or physical positions to determine the best direction for growing new base cells. For example, a base stem might extend horizontally in the positive x direction in cell fabric space. This means that each subsequent cell in the stem has nodes with increasing x ID indices, and unchanging y ID indices. But because the stem is free to flex and bend under the influence of forces such as gravity, the physical positions of the nodes in the same stem might sag out of perfect horizontal alignment. In other words, the physical x and y positions of the nodes might change non-uniformly further out on the stem, even though the y ID indices remain unchanged.

In one embodiment, when determining the new direction for base cell growth, the system may use cell fabric positions, rather than physical locations of nodes. This means that the system may use the non-deformed representation of cell positions to determine the best direction for cell growth. The advantage to this is that over time, a structure may bend back and forth. If growth directions were based on local deformations, then the overall growth direction might over compensate for a temporarily large deformation. For example, if a base stem were sagging, it might grow many base cells in the upward direction in order to maintain tracking to its target direction. However, if later in time, the structure had returned to a non-deformed state, then the base stem would appear to have overshot growth too much in the vertical direction. Using non-deformed positions of cells may cause the growth of a base stem to have less erratic behavior.

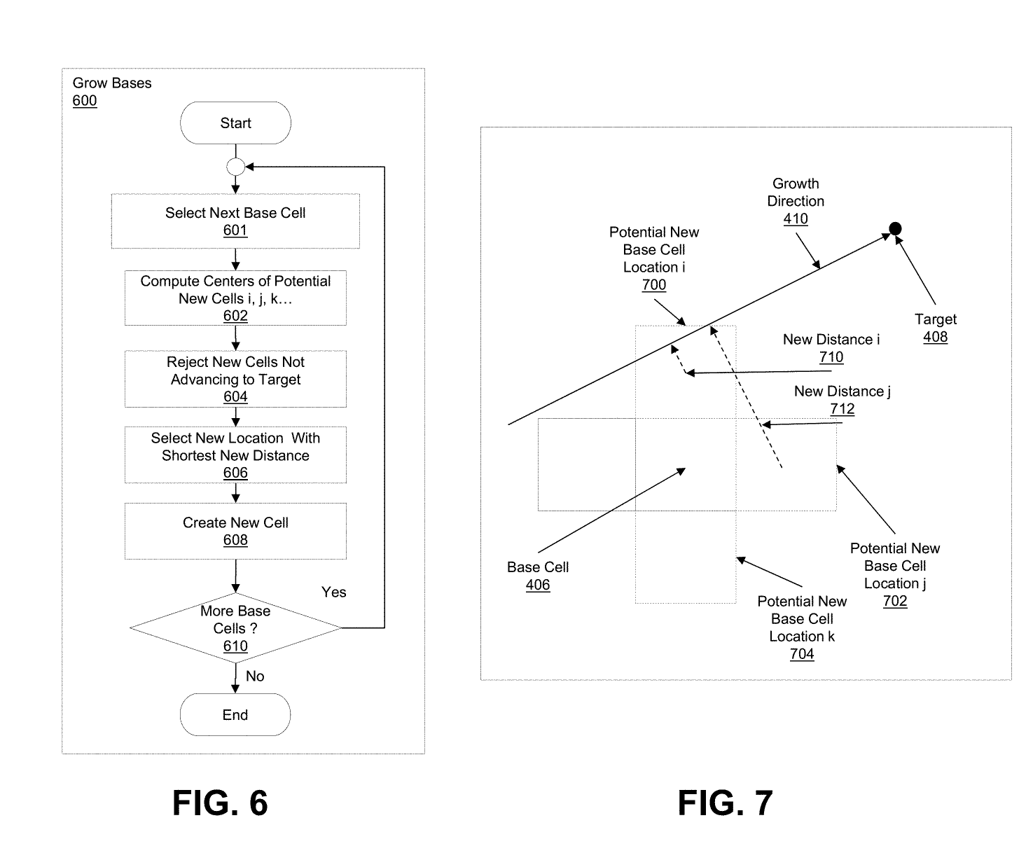

FIG. 6 is a flow diagram illustrating an example process 600 for growing bases from existing base cells, which may correspond to operation 222 of FIG. 2B. FIG. 7 shows a portion of FIG. 4, with attention to the components involved, for a specific base cell 406, in determining the best direction to create a new base cell, to best fit the growth direction 410 and track towards the target 408.

Referring to FIGS. 6 and 7, the system may determine to create a new base cell relative to the existing base cell 406. In the example shown, there are three potential new locations for the system to create a new base cell. These locations correspond to the three empty boundaries of the current base cell 406. The three potential new base cell locations may be referred to as locations i, j, and k, 700, 702, and 704. In order to compute these locations, the system may first select a next existing base cell (601), and compute the center in cell fabric coordinates of this base cell using its corner node locations measured in cell fabric space. Because a cell may not move relative to its cell fabric position over time, the system may calculate this location once and store it for repeated use. This location is unlike the physical center location, which may move over time as the cell moves in space due to bending of the cell structure. Next, the system may compute the centers of the potential new base cell locations (602) by adding each of the cell's boundary normal vectors multiplied by the cell's side length, to the cell's center location.

Given the potential new base cell locations, the system may proceed to reject one or more of the potential new base cell locations (604) because they may not indicate growth towards the target 408. A potential new cell k, 704, clearly shows growth away from the target location 408. Next, the system selects a new location with the shortest new distance (606), in order to select one of the remaining potential new base cell locations, 702 or 704, indicating the shortest distance to the growth direction. In the present example, new distance i 710 is shorter than new distance j 712. Thus, the system may create a new base cell to coincide with potential new base cell location i (700).

During creation of the new base cell (608), the system may determine whether the new base cell should be attached to any neighboring cells. The system may accomplish this by looking for existing neighboring nodes in the cell fabric before creating any new nodes for the new base cell. If such nodes exist, the system may attach the new base cell to existing cells using these common shared nodes. The act of stitching a base cell to other cells (including other base cells) may cause this and other base cells to have no empty boundaries, which would prevent such a base cell from growing a new base cell in the future.

Once the system has processed a base cell in this manner, it may determine if there are additional base cells to process (not including new base cells just created during operation 608). If there are additional base cells, the system may proceed to operation 601; otherwise it may terminate. The system may support multiple base cells, with each base cell causing growth in a different direction. One or more base cells may be attached to a wall.

Each cell may compute a collection of strain or strain chemical measurements that determine the amount of distress that the cell is experiencing. The internal strain may be computed as a measure of the percentage of stretch relative to the resting length of the 2 internal diagonal springs. When cells become sheared or twisted, the internal springs stretch and compress—usually one stretches and the other compresses. The system may measure the absolute value of each percentage of stretch, and add these values together. The absolute value means that stretching and compression both add to form a non-canceling composite value for strain. This measure may be referred to as i_strain.

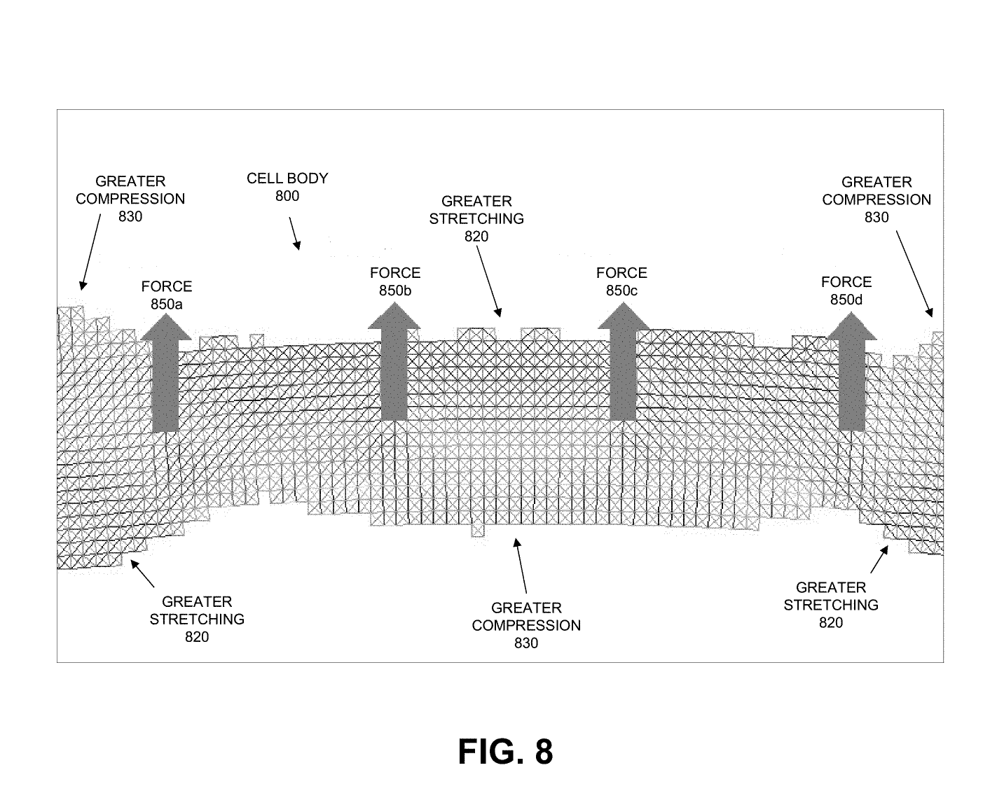

FIG. 8 is a lateral 2D view of a population of cells (a cell body) 800 displayed with only their boundary and internal springs. The cells experience varying levels of strain, where some portions experience varying degrees of stretching 820, while other portions experience varying levels of compression 830. The upward forces 850a-d applied to certain cells in the population are causing the upper cells to experience horizontal tension, while the lower cells are experiencing horizontal compression. Some cells do not experience a high level of strain along their boundaries, but do experience high levels of strain on their internal springs due to diagonal forces. The system may also determine that a cell warrants spawning of a neighboring cell if its overall strain exceeds that of a specified threshold.

Each cell of the population 800 may also measure its cumulative boundary strain as the sum of the strains of each outer spring. The measure of boundary strain is referred to as “b_strain.” In example embodiments, b_strain may take into consideration the 4 boundary springs on each cell. Each cell may also measure a weighted composite of both the internal and boundary strains. The internal strain may be given double the weight of the boundary strain, as there are only 2 internal springs, versus 4 boundary springs. Furthermore, the internal strain may be given twice the weight of the boundary strain, as it has been found that internal shear is more critical to the distress of a cell than simple compression or stretching. Shear, or twisting, may indicate a non-uniform deformation within the cell population. This often corresponds to instability, versus uniform compression or stretching, which often corresponds to a loaded, but stable population. In one embodiment, the measurement of overall strain may be represented by the formula strain=(i_strain+2*b_strain)/3.0.

In addition to computing the current strain for each cell, the system may compute an average strain that's a rolling average of several strains updated periodically at staggered times in the past. In one embodiment, a set of strains measured with different frequencies in the past may be updated when the cell's age values are multiples of 1, 7, 11, 14, 18, and 20 time cycles. This means, for example, that a strain called strain6 may be updated each time the cell's age is a multiple of 20; strain5 may be updated when the cell's age is a multiple of 18, and so forth. A time-based average of strain may be computed as the average of strains: strain6, strain5, strain4, and so forth.

One purpose of averaging the strain over time is to mitigate any negative effects from rapid changes in time-localized strains. When multiple cells are added or removed in a single cycle, new energy in the form of initial stretching may be added to the system in the form of a spike. This new energy may cause the strain of the whole system to fluctuate emphatically over subsequent cycles, and take on the form of strain waves that move through the cell population. A strain wave may be visible when a cell experiences high strain at cycle N, but passes this strain to a neighboring cell at cycle N+1. This may happen when a cell spawns a neighbor cell on a heavily compressed or stretched boundary. The new cell may experience an instantaneous increase in potential energy that's caused by the difference in the un-stretched resting length and the current length of the boundary at the moment the new cell is attached to the neighbor. During subsequent cycles, the new cell may snap back into non-deformed shape, and pass this deformation on to its neighbors in a wave-like fashion.

Use of the averaging of strain may create a better-behaving model. Otherwise, cells might be removed or added prematurely in areas where a local strain might temporarily exceed or fall below a certain threshold, but average out to a normal value over time. Averaging the strain causes the system to add and remove cells only where there is a lasting reason for growth or atrophy of the cell structure.

When a cell senses an undue amount of strain on one of its boundaries, the system may cause it to spawn a new cell on that boundary in an effort to improve its own health. A new boundary cell will help counteract the compression or stretching that the cell is experiencing, because the new cell will provide an additional boundary spring spanning the two boundary nodes of the original cell, and this will provide double the counteractive force to alleviate the strain.

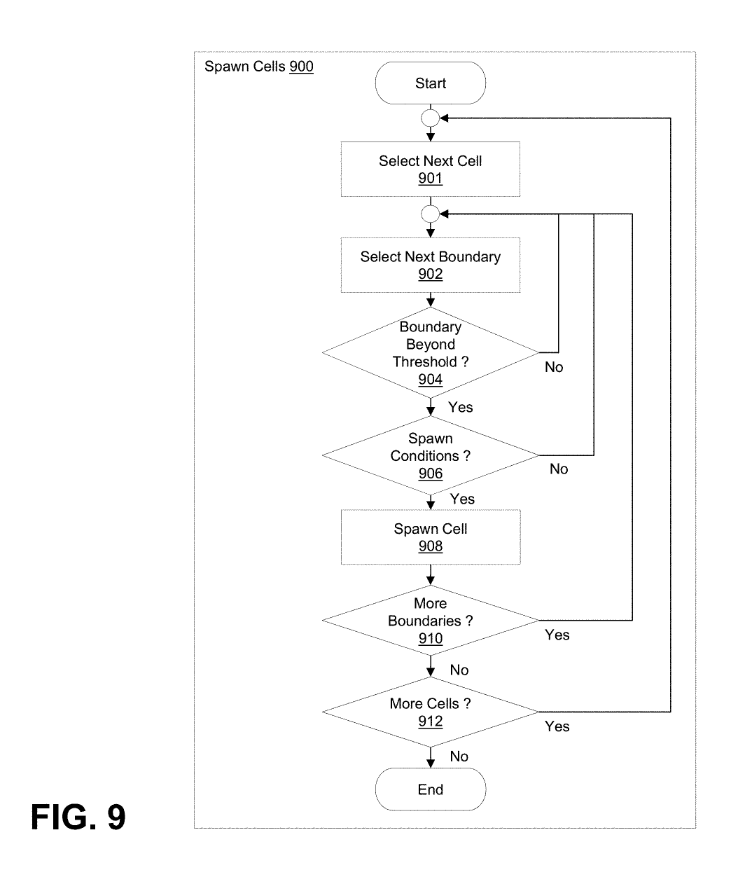

FIG. 9 is a flow diagram illustrating a process 900 of spawning cells, which may correspond to operation 224 in FIG. 2B. The process 900 may begin by first selecting a next cell to process from the set of all cells in a cell structure (901). For the selected next cell, the system may iterate around its boundaries by first selecting a next boundary to process (902). Cell spawning may take place in one of the directions orthogonal to a cell's boundaries. For 2D rectangular cell fabrics that span the x, y index space, this corresponds to spawning in the positive and negative x and y directions in the grid—or 4 directions corresponding to the four boundaries of the square cells.

With respect to the selected boundary (902), the system may evaluate the condition of the spring and damper corresponding to that boundary. A cell may use a number of techniques for determining if a boundary exceeds the threshold (904) for spawning a new cell. One technique may involve measuring the strain of the boundary spring and checking if it exceeds a specified threshold such as 1%. A cell may alternatively measure and utilize the stress experienced by the boundary spring. A cell may also take into consideration the overall measure of strain on the cell as a composite of all of the individual spring strains, as an overriding factor, if a boundary spring is not exceeding a threshold, but the overall cell is in distress. There may be times when a boundary spring is not very deformed, but the cell may be horribly twisted. In these cases, the threshold for spawning a new cell along the boundary may not be met, but due to the overall distress of the cell, the system may decide to spawn a new cell anyway.

If the system determines that the boundary conditions for spawning a new cell are met, it may proceed to determine if overall cell-level spawning conditions have been met (906). This may involve checking if the cell is fixed, or occupying a keep-out region, or if the cell is too young. Furthermore, the system may ensure that the cell boundary has no pre-existing neighbor.

The system may prevent a cell from spawning a new cell until it has reached an age of at least 20 cycles, where 20 may be a variable value. This requirement helps to prevent overly aggressive growth. A newly spawned cell may experience its own high level of strain early in its life, due to the fact that it will have been created along a boundary that's already stretched or compressed beyond the spawning threshold. If a new cell is not given time to exert its own restoring force to its neighboring cells, it may show an immediate strain that will cause it to spawn new children prematurely. This can lead to runaway growth of the cell population. By giving a cell some number of cycles to exert a restoring force, a new cell may partially snap back to its resting shape, and not trigger immature spawning of new cells.

If the conditions for spawning a new cell are met (906), the system may proceed to spawn a new cell (908). Part of the process of creating a new cell may involve attaching it to walls if any of its new nodes penetrate walls. One means of attaching a node to a fixed wall involves fixing it in space. In another embodiment, the system may add a constraint between the node and the wall such that the node may move with respect to the wall. Additionally, the system may stitch the new cell to neighbors, as defined by their proximity in the cell fabric.

The operation of spawning a new cell (906) may also comprise invoking the physics engine to advance the physical simulation some number of cycles in order to allow the newly spawned cell to dissipate some of its initial potential energy, caused by the initial spring lengths of the new cell not coinciding with the new cell's spring resting lengths. If the system were to spawn too many cells without advancing the physics engine between each new cell, then the system may build up too much potential energy concentrated in the new cells. Advancing the physics engine gives the system a chance to dissipate a new cell's potential energy into some of its neighbors before the system spawns cells off of the neighboring cells.

After having processed a boundary, the system may determine if there are more boundaries to process (910). After all boundaries have been processed, the system may determine if there are more cells to process (912). Once all cells have been processed, the system may terminate.

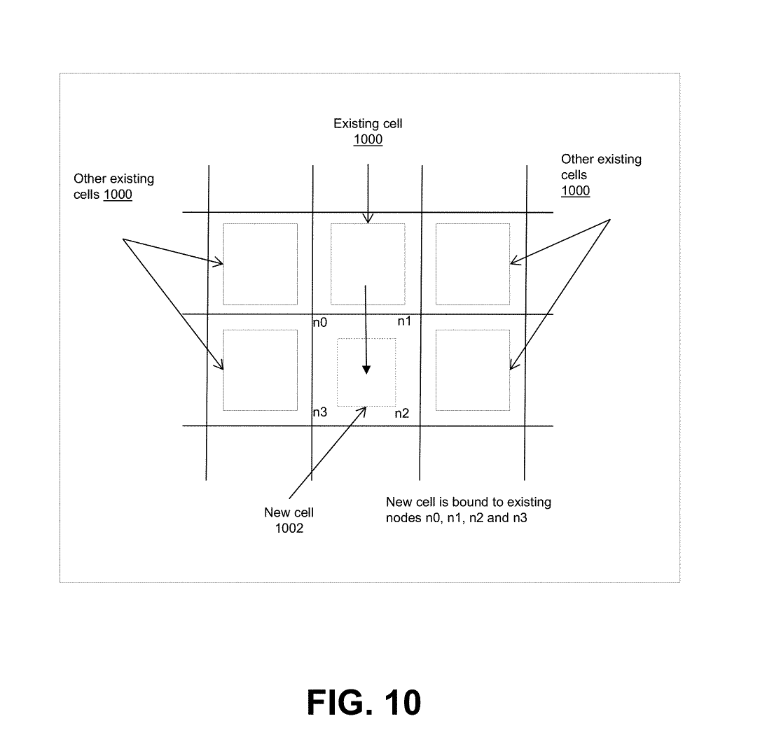

FIG. 10 illustrates one of a number of existing cells 1000 in the process of spawning a new cell 1002 along one of its boundaries, defined by nodes n0 and n1. When the system determines that a cell should have a new cell spawned along one of its boundaries, there are several steps the system may take in order to ensure that the new cell is properly stitched to any already existing neighboring cells. The system may first determine that the new cell, if created, would occupy new nodes n2 and n3, as shown in the figure. The system may determine the cell fabric locations of these nodes, without actually creating the nodes and storing them in the cell fabric. The system may query the cell fabric to see if nodes n2 and n3 already exist, and if they do, then proceed to look up the cells that share the boundaries spanning nodes n1 and n2, the boundary spanning nodes n2 and n3, and the boundary spanning nodes n3 and n0. For rectangular cells, there may be up to 3 existing neighboring cells in addition to the original spawning cell that the new cell must be stitched to. Stitching may involve first creating the new cell such that it shares any existing nodes n0-n3, and second, marking the existing cells and the new cell as neighbors.

In one embodiment, the system may store a map in each cell containing nodes as keys and neighboring cells as values. Such a map may enable a cell to quickly determine if a neighboring cell exists along any boundary corresponding to node ni, where the assumption is that a neighboring cell will span nodes ni and nj, moving in a clockwise direction when looking towards the face of the cell.

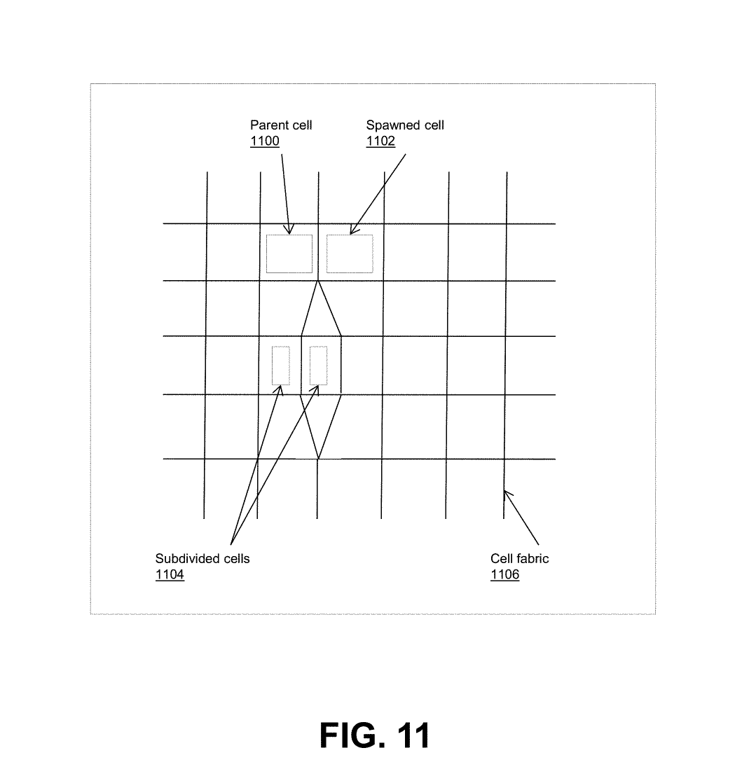

FIG. 11 illustrates a cell division. In addition to supporting the spawning of new cells, a cell may also be capable of dividing into two cells. This may only occur if the cell fabric is flexible enough to allow insertion of cell slots. For example, if a cell divides along its vertical axis, the underlying cell fabric needs to support the addition of a new slot next to the existing slot. FIG. 11 illustrates the difference between a parent cell 1100 that spawns a new neighbor 1102 into an empty neighboring slot versus a cell that splits into two adjacent cells 1804. In the latter case, the fabric 1106 must be split as well, in order to accommodate the additional slot. Splitting a fabric requires that the fabric support a flexible indexing mechanism where indices may be inserted into the fabric.

As cells spawn neighboring cells in a certain direction, and thus grow into a stem, the cells at the end of the stem may sag as the structure bends under the force of gravity. This causes the fabric space to warp. This is because cells at the end of the stem may not lie in the same physical line as those in the base of the stem, even though all cells in the stem may lie in the same logical row of the cell fabric. The advantage of a cell fabric is that the system may quickly determine if cells should be joined due to their proximity of being direct neighbors in the cell fabric, even though they may have moved around arbitrarily in space due to bending of the cell structure. Without an underlying cell fabric, it would be harder for the system to determine when to fuse cells together as neighbors, and still maintain a regular grid of organized cells. For example, cells may have moved sufficiently close together in space due to bending of the structure, for the system to decide to fuse the cells. At the same time, such cells may not occupy the same row or column of the cell fabric. If fusing were done based on physical cell proximity rather than location within the fabric, then the integrity of the rectangular fabric structure could be violated if cells were fused from different rows or columns of the cell fabric.

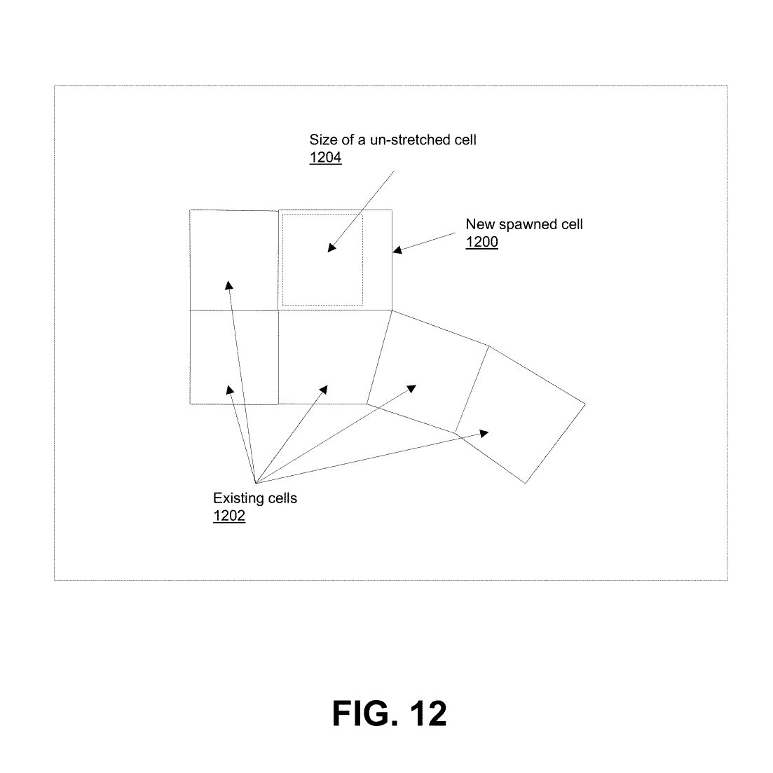

FIG. 12 illustrates cells undergoing a strengthening operation. When a new cell is spawned, it boundaries may be given the resting lengths of its already stretched neighbors' boundaries, or it may be given a uniform default resting length. The latter will often cause a newly spawned cell to have an instantaneous initial amount of stretch or compression potential energy relative to its neighbors, whereas the former case will result in new cells that have no initial stored potential energy. FIG. 12 illustrates the difference between the deformed state of a newly spawned cell 1200 relative to other existing cells 1202, versus an un-stretched cell 1204.

For cases where the system may create newly spawned cells whose spring resting lengths match those of the existing stretched neighboring springs, the system may employ a process to gradually, over-time, restore the resting lengths of these cell springs to some default values. Alternatively, the system may initially alter the spring constant, thus making a spring initially more flexible, and then over time, modify this constant in order to make the spring stiffer.

The system may impose a correlation between a cell's spring strengths (i.e. its spring constants) and the masses of the nodes of the cell, in order to account for the extra “cost” associated with carrying heavier duty springs. When a cell increases the strength of its springs, it may also increase the masses of its nodes proportionately, because in a physical world an added level of strength naturally comes with a bulkier material. Alternatively, the system may modify the material of the cell, substituting, for example, a material such as wood with that of steel. In this case the mass of a cell may be not be directly related to its strength. The system may use cell strengthening as opposed to cell spawning as a means of preventing a cell structure from bending excessively.

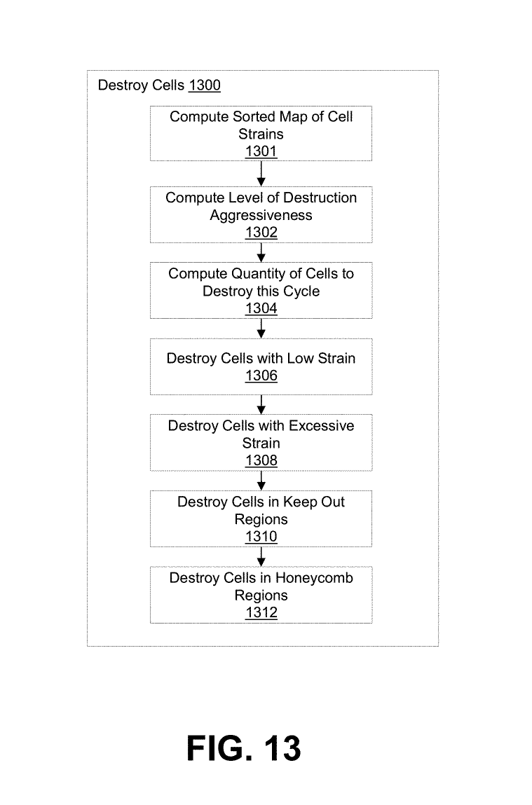

FIG. 13 illustrates a process 1300 of selectively destroying cells, which may correspond to operation 226 in FIG. 2B. In example embodiments, a system may exhibit several types of more or less aggressive cell destruction behavior, depending upon the current time. It has been found that early on in the growth process, cell destruction naturally inhibits the formation of basic cellular connecting structures among walls and forces. It's important to hold aggressive cell destruction process at bay until some threshold indicating adolescent maturity has been met. In one embodiment, this value may be a fixed amount of time having passed, or in another embodiment, it may be an average age of cells in the population.

Once cell destruction has begun, there may be varying degrees of aggressiveness in the allowed amount of “bite” that the cell destruction process may have in pruning the cell population in each cycle. Initially, it has been found that an aggressive pruning allows the structure to wretch violently and fight back in order to prevent over excessive destruction of cells. Rather than just let the cell destruction process begin by nibbling away at a small percentage of least strained cells in each cycle, better results may be obtained if a violent and aggressive cell destruction process is met by an aggressive cell spawning process that “fights back.” The rapid and simultaneous creation and destruction of cells during the adolescent stages of cell growth causes strains in the system to “flow” rapidly as if analogous to a liquid sloshing around in a partially empty container. The result is a more robust cell population, better geared towards supporting the loads imposed on the system. By way of comparison, a bucket holding a sloshing liquid must be stronger than a bucket holding the same liquid, but calm.

After the aggressive cell destruction stage has tested and shaped the structure, the system may enter into a more relaxed mode of “nibbling away” cells that have least strain. During the settling stage of cell destruction, the dynamic waves of strain that were kicked up during aggressive cell destruction are allowed to settle down. The cell population is allowed to dampen out some of the energy introduced during rapid addition and removal of cells. It is during this phase when the structure begins to trim itself down into “fighting form.” Fighting form means that the structure is efficient, not retaining cells that are not supporting much load bearing.

Finally, the system may enter a “cleanup” or “scavenger” phase of cell destruction, whereby only a small percentage of cells is culled in each cycle. During this phase, the structure has reached equilibrium, and the structure is neatened. For example, areas where “honeycomb” gaps exist are hollowed out so that the structure takes on a cleaner form.

Referring to FIG. 13, the process of destroying cells 1300 may include: computing the sorted map of cell strains (1301), computing the level of destruction aggressiveness (1302), computing the quantity of cells to destroy this cycle (1304), destroying cells with low strain (1306), destroying cells with excessive strain (1308), destroying cells in keep-out regions (1310), and destroying cells in honeycomb regions (1312).

The operation of computing the sorted map of cell strains (1301) may involve first updating the cell strains for each cell at the current time, followed by creating a sorted array of strains, with each strain referencing its corresponding cell. The strains may be sorted from most strained to least strained. A number of different measurements for cell strain may used. Alternatively, cells may compute stress rather than strain.

Computing the level of destruction aggressiveness (1302) may include determining the percentage of cells that may be destroyed in a single cycle. If the time is prior to an aggressive cell destruction threshold, this value may be 0. During aggressive cell destruction, this value may be a maximum of 0.5% of the total cell population. During slow cell destruction this value may be a fixed number of cells—such as a maximum of 3 per cycle. During passive cell destruction, this value may be a maximum of 1 cell per cycle.

Computing the quantity of cells to destroy this cycle (1304) may comprise using the measure of cell destruction aggressiveness obtained in operation 1302 and the total number of cells, to determine a maximum number of cells to destroy.

Destroying cells with low strain (1306) may comprise selecting a subset of cells from the sorted map obtained in operation 1301. In one embodiment, if the maximum quantity of cells to destroy is N, the system may select the N least strained cells from the map, and beginning with the least strained member of this set, destroy the cell if its value of strain is greater than a threshold. In one embodiment, this threshold may be 0.01. Moving from least the strained to the most strained cell in this set, the system may evaluate one-by-one if a cell should be destroyed.

Destroying cells with excessive strain (1308) may include selecting a subset of cells from the sorted map obtained in step 50, whereby the strain must exceed a specified threshold. In one embodiment this strain threshold may be 11%, or 0.11, and all cells whose strain exceeds this threshold may be destroyed. This operation can provide a means of slicing out “out of control” cells whose high strain may cause a cascade of uncontrolled growth. This process is geared towards removing dangerous cells early so that they can be replaced later when the system may have settled down. It has been found that removing such a highly deformed cell early is not detrimental to the system because such cells are usually unable to return to a less deformed shape without slamming the system with violent strain waves.

Destroying cells in keep-out regions (1310) may include evaluating each keep-out region with respect to each cell to determine if the keep-out region applies to the cell. A number of different test formulas may be employed by keep-out regions in general to indicate if a cell lies within a region. In one embodiment, a keep-out region may comprise a location in space, along with a shape function such as a circle or rectangle. A cell may fall within a region if its current location falls within the shape. In another embodiment, a keep-out region may have a location specified with respect to a cell fabric (i.e., have an x, y, z index in the fabric). In such a case, a cell's location in the fabric may be used to determine if the cell should be removed.

Operation 1310 may also select cells as candidates for destruction in keep-out regions by first sorting the cells by their age. In one embodiment, cells may be added to an array as they are created. If the system traverses this array from start to end, it may naturally select the oldest cells as candidates before selecting younger cells. In another embodiment, the system may select cells as candidates for destruction using a random selector. It has been found that the approach of selecting oldest cells first as candidates for keep-out region destruction provides good results because older cells are typically located near the core of growth structures. In the same way that a structure grows from the inside towards the outside, cell destruction in keep-out regions may take place from the inside towards the outside as well.

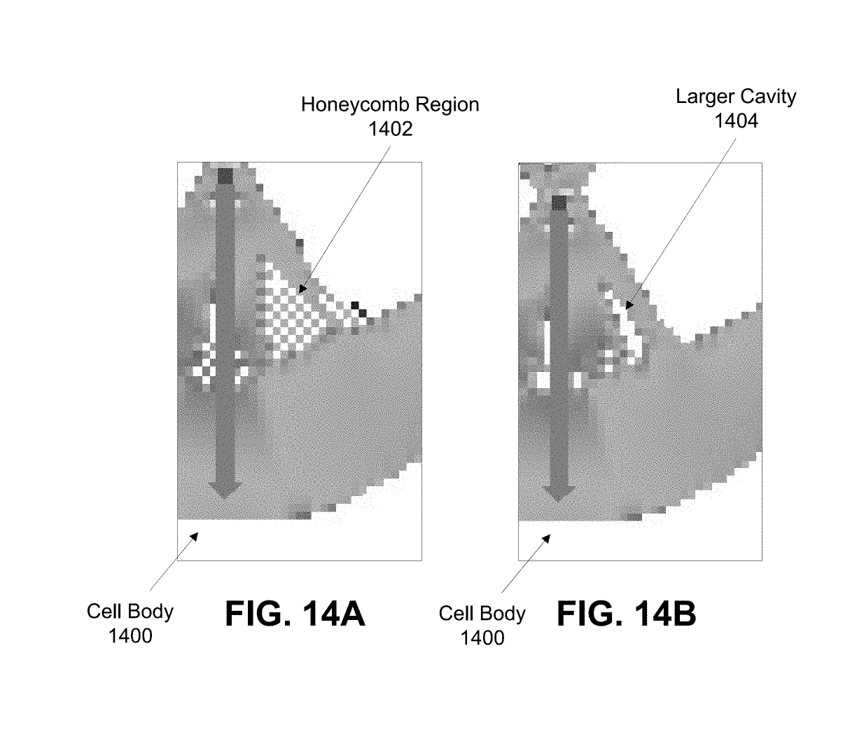

FIG. 14A illustrates a cell body 1400 having a honeycomb region 1402 comprising several small cavities between cells. Referring to FIG. 13, destroying cells in honeycomb regions (1312) may include selecting cells as candidates if it is determined that they have no neighbors. A cell may have no neighbors, and yet, still be attached at its corners, forming a sort of honeycomb or checkerboard-like structure. Destroying cells in honeycomb regions (1312) may be triggered during the “cleanup” or “scavenger” stage of cell destruction whereby it may be desirable to clean up a cell structure so that it becomes more suited to manufacture. A structure that is potted with small holes is generally harder to manufacture than a contiguous structure. This leads to the removal of cells attached to neighbors only at corners, and not along edges. As the cells are removed, the neighboring cells take up the increased loads and may spawn cells—resulting in larger holes. FIG. 14B illustrates the same region after operation 1312 has caused the cleanup of the honeycomb region, leaving a larger cavity 1404.

When a cell spawns a new cell, the new cell may become attached to another cell or a structure such as a wall. This is called “fusing.” Once a cell has fused, it may not be capable of spawning its own cells along the fused boundary, because several of the cell's boundaries may already be occupied by neighbors or constraints such as a wall.

Cell fusing may involve attaching one or more of a cell's nodes to the nodes of another cell via constraints, or it may involve sharing nodes between cells. In the second case, the system may look for nodes in the cell fabric, already used by other cells, before necessarily creating new nodes for the to-be-created cell. If the system finds nodes already used by the neighboring cells, it may use these nodes as end points for the springs in the new cell. In order to facilitate the lookup of nodes in the cell fabric, the system may maintain a hash map for getting a node based on an x, y, and z key value in the cell fabric.

When two base cells have spawned long shoots, there may be significant bending that causes the cells at the ends to have moved significantly far from their unbent positions. In this case, the fusing process may create a new cell whose nodes on the first boundary are far from the nodes on the second boundary, sometimes at a distance of several times the size of an unbent cell. The system may decide not to create a fusing cell that bridges the gap in this instance if the resulting cell will infuse too much stretched spring energy into the system. Instead, the system may apply a temporary restoring force between the base cells at the ends of each shoot to help restore the positions of the shoot ends to their unbent positions. After several cycles, when the cells have into closer alignment, the system may create the fusing cell. When base cells fuse, they may generate an event that allows the system to trigger other actions in the main loop. For example, the system may apply a point load to a cell when a set of base cells has fused.

Cells may be attached to fixed structures such as walls via cell adhesions. In one embodiment, the system may apply a cell adhesion to a fixed structure by setting the positions of some of a cell's nodes to “fixed” in the physics engine. For moving structures, the system may set the velocities of a cell's affected nodes, to correspond with the velocity of the adhered-to object. Cells may be attached to other cells via cell adhesions. One type of cell adhesion involves two cells sharing one or more boundary nodes. When cells pull apart against a common boundary node, the system may prevent tearing, or it may allow the cells to split apart by creating a new node, and reattaching springs from one cell to the new node. If cells are organized according into a cell fabric, the system may enable cell tearing by simply allowing a cell in a chain to be destroyed. This effectively allows the cells on each side of the chain to move independently.

The system may apply point loads to the nodes of cells. These point loads may be varied in magnitude and direction over time. A collection of point loads may be applied to a collection of nodes to simulate a boundary force on a cell structure. The system may also support the definition of repulsive or attractive forces at specified locations. These forces may affect nodes by applying forces to them that are proportional to the distance of each node to the source, and directed from the node towards or away from the source location.

The system may also support signal sources. A signal source may comprise a location in space, a concentration function, a direction function, and a signal signature. A concentration function may accept a set of input values, and provide a concentration for the signal. In one example a concentration function may accept the location of a node in space, and return a value proportional to the inverse of square of the distance between the node and the signal location. In the same example, the direction function may return a normalized vector from the signal location to the node location, and the signal signature may be “A.”

Several signal sources may be combined to define gradient fields in space. For example, two signal sources from the previous example might both emit signatures of “A.” If a cell were to measure the signals from sources emitting signal “A,” it would find a maximum combined concentration along the line joining the two sources. The system may use multiple signal sources of the same signature to define complex shaped areas.

In nature, certain types of cells are capable of responding to multiple signal sources. The chemicals emitted by these sources are referred to as morphogens. In animals, a period of early embryo formation takes place where cells detach and migrate towards high concentrations of multiple morphogen signals. In vertebrates, cells at opposite ends of the organism emit signals that define a line along that becomes the neural crest, or backbone. Cells migrate towards this line, and then form nerve cells that end up becoming the spinal cord and backbone.

Keep-out regions may be areas within the environment where cells are not allowed to spawn new cells, or adhere to structures. A keep-out region may be activated at time=0, but it is more typically activated after a cell population has had a chance to develop its initial structure. In this way, keep-out regions may be used to remove cells after-the-fact, as well as prevent cells from being created within their boundaries.

The system may allow for the definition of multiple keep-out regions. A keep-out region may be specified as a 2D or 3D shape such as a circle of box, at a specified location. The system may provide a means of indicating the time at which a keep-out region should be activated, such that cells may be allowed to grow and exist within the region prior to this time, and then be destroyed after this time. A keep-out region may also have a deactivation time which causes the system to reverse the behavior and allow cells to exist within the region.

When the system evaluates cells to determine if they lie within one or more keep-out regions, cells may be selected in the order of their age, from oldest first to youngest last. When oldest cells are selected first as candidates, the destruction commences from the center of grown structure, and gradually works its way towards the outside. This pattern is consistent with the growth pattern that created the structure, whereby cells grew along a central axis or curve, and then out towards the perimeter of the cell population. This pattern may resemble a policy whereby the first cells generated are first candidates for termination.

When cells are chosen for destruction based upon their age, the system may have a natural tendency to destroy older cells first, rather than younger cells. Older cells tend to exist in locations where they are no longer as important to the system as younger cells, because the conditions in which older cells were created may have changed significantly.

Fill-in regions (also referred to as attractor regions), like keep-out regions, may be areas in the environment where the system requires cells to spawn child cells. A fill-in region may force a cell structure to fill an area with a specified shape such as a circle or square. Fill-in regions may be used to ensure that a structure fills out some easily manufacture able shape. For example, the region around the end of a supporting bracket may need to adhere to a simple circular shape in order to be easily cut out by a machine controlled punch. The placement and activation of a fill-in region may be specified by a growth instruction. The inputs to the instruction may comprise a location of a cell or node, a shape specification, such as a square or circle, and one or more configuration parameters to determine the size of the shape.

When a fill-in region is active, the system may look for cells located within the region, and force the spawning of child cells from these cells, even if strain or other thresholds for spawning have not been met. The system may limit the number of new cells that are spawned within a fill-in region in a given cycle so as to ensure that growth is not too rapid. Rapid growth may cause a spike in the amount of new potential energy entering the system, due to a large number of new cells whose initial spring lengths may not be the same as their natural resting lengths.

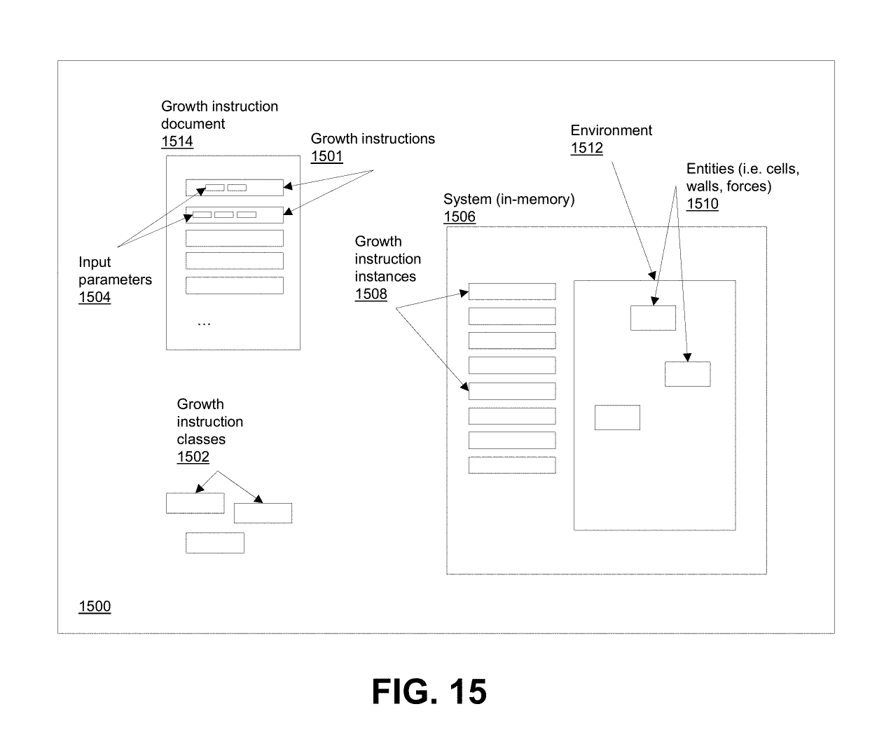

FIG. 15 is a block diagram representing a data structure 1500 that may be implemented in example embodiments. An example system may provide a means of eliminating the need to hard-code logic into a main loop (e.g., loop 200 in FIG. 2A) for adding and removing growth elements to and from the environment. Instead, the system may provide a means of reading in a set of externally supplied inputs comprising a growth recipe. This growth recipe may be referred to as a set of growth instructions 1501. Each growth instruction 1501 may comprise the name of a growth instruction class 1502 and a set of input parameters 1504 to be used as inputs. A growth instruction class 1502 refers to a software implementation of the logic encompassed by the growth instruction. When the system 1506 creates an in-memory instance of a growth instruction class 1502, this may be referred to as a growth instruction instance 1508. The system may feed the input parameters 1504 into a growth instruction instance 1508.

Growth instruction instances 1508 may create, modify, and delete entities 1510 in the environment 1512, such as cells, in addition to modifying the state of the environment in which the cells reside. A growth instruction instance 1508 may also be used to cause an abrupt change to the environment, such as removing an entity such as a support structure, or it may be used to subtly change the state of the environment, such as gradually increasing the magnitude of a force. The collection of growth instructions representing the growth recipe described above may be stored in a structure known as a growth instruction document 1514.

When the system reads a set of growth instructions 1501 from a document, it may look for the growth instruction class 1502 identified by each growth instruction and instantiate a growth instruction instance 1508 that provides an in memory representation for the growth instruction. The system may, furthermore, pass the input parameters 1504 from each growth instruction into the corresponding growth instruction instance's constructor method.

The system may instantiate a number of growth instruction instances, and then incorporate these instances into the execution a main loop (e.g., operation 212 in main loop 200 of FIG. 2A). While executing the main loop, the system may increment time, call for an update of entities in the environment, and then evaluate each growth instruction instance to see if any conditions for triggering execution have been met. If conditions for execution are met, the system may call an execute method on the growth instruction instance. In cases where an input parameter is the ID of an entity in the environment, the system may look up the in-memory representation of that entity and pass it to the growth instruction instance.

An example growth instruction 1501 may be represented as XML, or JSON data. Such a growth instruction 1501 may have an ID, which may be a number assigned by the system. The ID may uniquely identify the growth instruction from others within a growth instruction document 1514. The instruction 1501 may also comprise a type identifier, (e.g., “add force”) that is used to identify a growth instruction class 1502. The instruction 1501 can also include a condition that the system may use to determine when to execute the instruction. For example, a condition may take on the form of a Java or C++ Boolean expression. An example condition may cause the system to retrieve a base cell matching a given ID, and test the cell to see if it has reached its target. Accordingly, the system may return a Boolean value indicating if the base cell has reached its specified target location through repeated base growth. If the cell has reached its target, then the instruction may cause the system to check whether the number of cycles (i.e. time) has exceeded a given count. If so, then the system executes the instruction, which creates a new point force in the environment.

The instructions 1501 may comprise a set of inputs. In the example described above, a first input may provide the ID of a node in the environment to which the point force will be attached. Second and third inputs may specify the magnitude and direction of the force, with an assumption of units being Newton and unit vector.

Based upon conditions, growth instruction instances may be triggered to execute at multiple and different times. For example, one growth instruction instance may place a wall in the environment at time=0. Another growth instruction instance may add a force to a cell node when two base stems have fused together. Another growth instruction instance may place a keep-out region after a certain amount of time has passed. A set of growth instructions defines the recipe for a particular growth process.

One type of growth instruction may be a force whose components of magnitude and direction (i.e. a vector) may be defined as expressions that take frame time and position into consideration. For example, the direction of a force may be defined to have a component in the Y direction that is 1000.0*sin(0.1*t), where t is the frame time. Furthermore, this growth instruction may define a surface such that any cell touching the surface will feel the force if it is “pushing” against the surface, based upon an evaluation of the expression at each cell's location and current frame time. In this example, when the force direction is evaluated at different times, the force direction will oscillate from having elements of positive to negative Y direction. If the force surface were a cylinder with a horizontal axis, this may cause the set of cells feeling the force to vary from a collection touching the bottom of the cylinder surface to the top of the cylinder surface. As such, a growth instruction may have expressions that must be evaluated at each time frame in order to update the region of impact.

A user may create a growth instruction document that defines a growth process, and supply this composition as an input to the system prior to execution. At any point in the editing of growth instructions, the user may test the growth process by re-ingesting the growth instructions into the system, and triggering the propagation of time to see the effects of the growth instructions as they execute and operate on the environment, as well as see the effects of processes that operate within the environment (such as cell spawning). The user may stop the time propagation, edit the growth instructions, and repeat the growth simulation. Users may also extend the system by defining their own growth instruction classes. The system may supply a core set of growth instruction classes that place cells, define structures such as walls, define forces, and keep-out regions. For example, a user might create a new growth instruction class that removes a clump of cells in a circular shape, at a specified location. Once a growth instruction class has been implemented and stored in a location accessible to the system, the user may create a growth instruction document containing calls to the new growth instruction class.

As described above, the inputs parameters for growth instructions may include references to entities in the environment. This may include the IDs of entities. For example, the growth instruction described previously might accept the ID of a cell as a location to remove a clump of cells. The system may assign IDs to entities in the environment that are derived from the IDs of the growth instruction instances that create the entities respectively. If a growth instruction creates multiple entities, then these entities may each be given an ID comprised of the growth instruction's ID plus a serial number that increments each time the growth instruction instance creates a new entity.

It may be beneficial for the entities in an environment to incorporate the IDs of the growth instruction instances that created them in cases where the system may rebuild the contents of the environment. For example, the first time the system executes a set of growth instructions, a user may stop the process and edit one of the instructions to include a reference to an entity in the environment. The growth instruction referencing this entity may obtain the in-memory representation of the entity with that id, and use it how it wants. However, the next time the system executes the same set of growth instructions, the entities may have different ids. If the IDs are different, the growth instruction in question may get a different entity than it did in a first round, and this may cause the growth instruction to fail. One way to address this issue is to have a growth instruction that creates an entity assign an ID to the new entity that reflects both the ID of the growth instruction, and a serial number corresponding to the count of entities created by that instruction. With this approach, the system may re-execute a set of growth instructions, and the entity IDs passed as inputs may likely correspond to the same entities as in previous executions. This method of assigning IDs to environment entities that are derived from the creator's IDs may be referred to as ID invariance. Users may also define their own libraries of entities that reside in the environment, by implementing classes that extend the existing entities, such as cells.

The system may also provide a component library with an API that allows users to build programs that execute their own growth scripts. The system may produce a graphical 3D representation of the model, including a view of the growth instructions, and the environment containing the grown structures and supporting artifacts.

In addition to storing the growth instructions defining a particular growth process in a document, the system may store the contents of the environment in their final state in a document as well, possibly the same document. The combined document comprising the persisted form of growth instructions along with the environment contents produced by the growth process may be referred to as a model. This model may also comprise the value of the time variable indicating the amount of time that executed during the growth process.

The system may open a model and read the growth instructions to produce an in-memory representation of growth instruction instances. In addition, the system may read the persisted environment, and recreate the in-memory representation of the environment as it was at the end of the growth process. A user of the system may be able to immediately view the contents of the environment without having to re-execute the growth process from scratch. The system may also provide a user interface for creating new models and editing them. Editing tasks may comprise adding new growth instructions to the model, configuring their inputs, and defining the order of instructions. Each growth instruction may comprise a set of conditions used to determine when to start execution of the growth instruction instance. In addition to providing an editing interface for growth instructions, the system may provide commands for setting starting the execution of the growth process at a certain time, stopping the growth process after some amount of time has passed, and reversing the direction of time increments.

The editing interface for specifying input values to growth instructions may include a selection mechanism whereby a user may select an entity and the system will determine the entity ID and set it as the input value to a growth instruction. The user interface may need to ensure that no entity be selectable as an input to a growth instruction unless the entity in question has been created by a growth instruction occurring prior to the growth instruction being edited. During the initial creation of a set of growth instructions, this is not an issue, because any entity that's selectable as an input to a new instruction must have been created by a previous instruction. However, in the case where the system allows a user to roll back the environment to an earlier time and edit the inputs to an instruction mid-sequence, it's important that the system prevent the user from selecting an entity existing after this mid-sequence instruction. If this policy is not enforced by the system, then there will be problems when the growth sequence is executed from scratch on an empty environment because an instruction will be invoked with a reference to an entity that has not been created yet.

The user of the system may have direct control over the advancing of time, as represented by the time variable. In one embodiment, the system may automatically advance time sequentially, after the user has issued a start command. The user may also issue a stop command to halt the incrementing of time. The user may also issue a command to change the direction of the time increments from advancing to decreasing. Through these and other commands, the user may control the forward and reverse progression of time, similar to the way a user might interact with the controls of a video player.

When the system modifies the value of the time variable, the cells in the environment may be triggered to execute processes that may affect the state of the cell itself, as well as any other aspect of the environment. In one embodiment, a cell may keep track of its age by recording each advance of time, and when reaching a certain age, may destroy itself if it deems that it is experiencing too much strain, as measured by analyzing its internal state. In another embodiment, a cell may analyze its boundary strains upon the advance of each time increment, and at some point spawn a new cell adjacent to one of its boundaries in order to help relieve some of the strain.

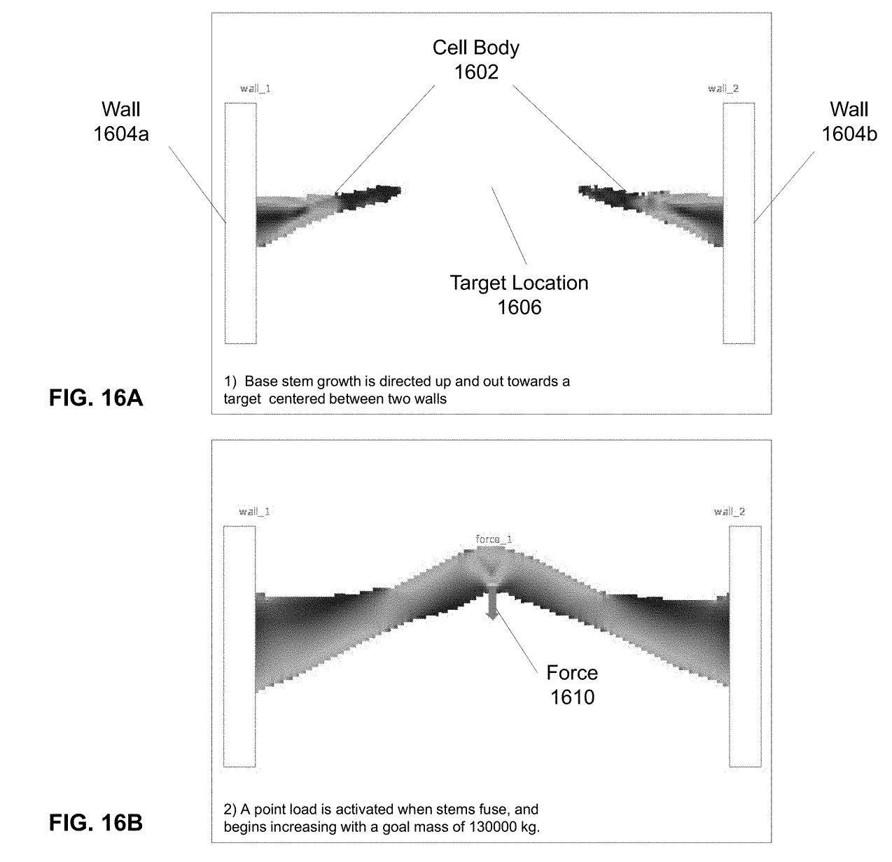

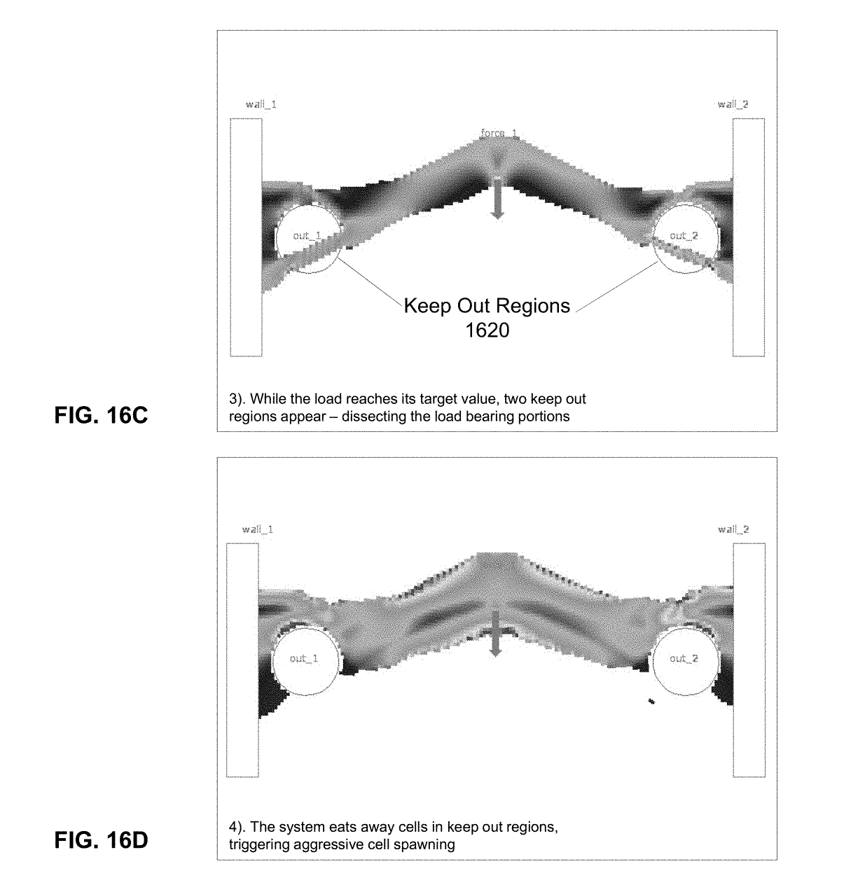

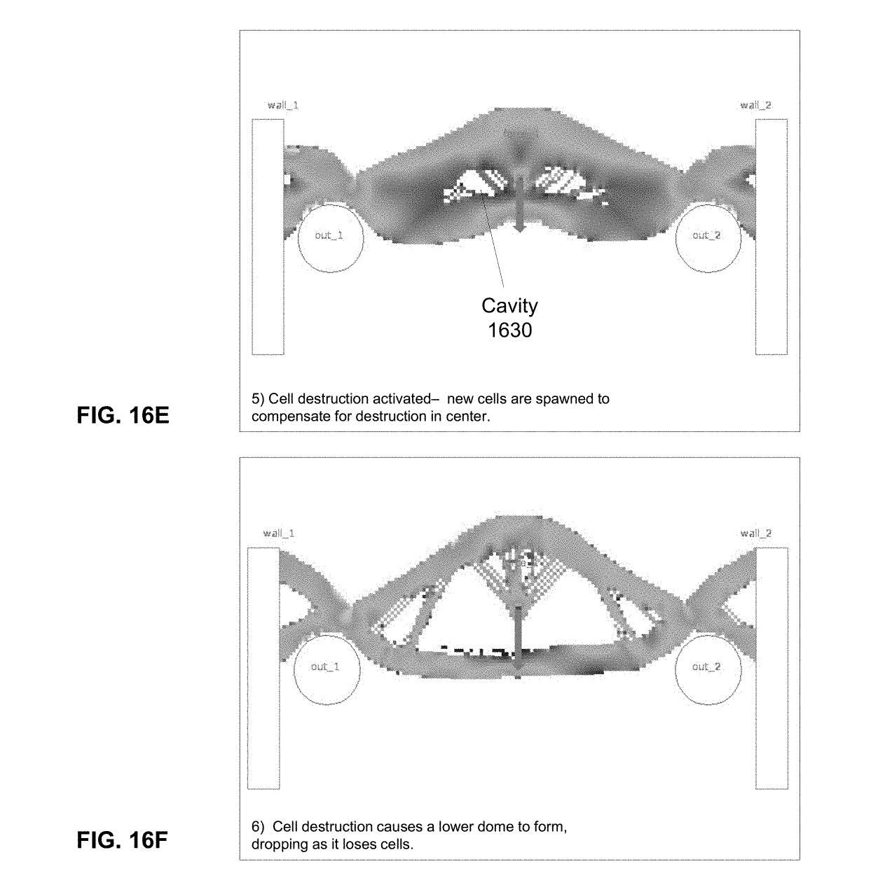

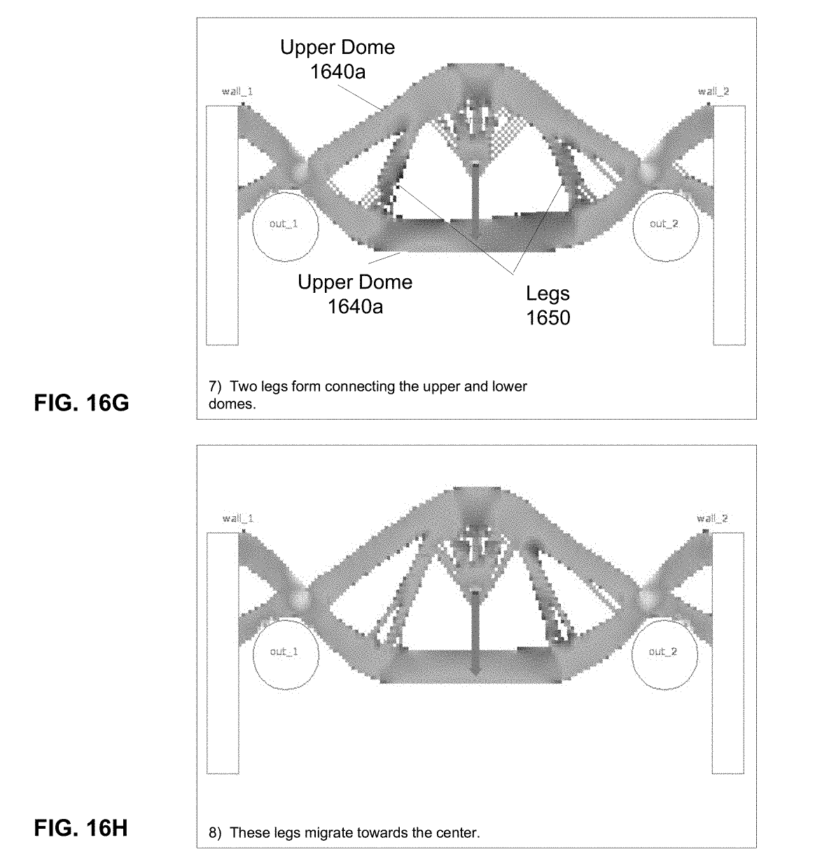

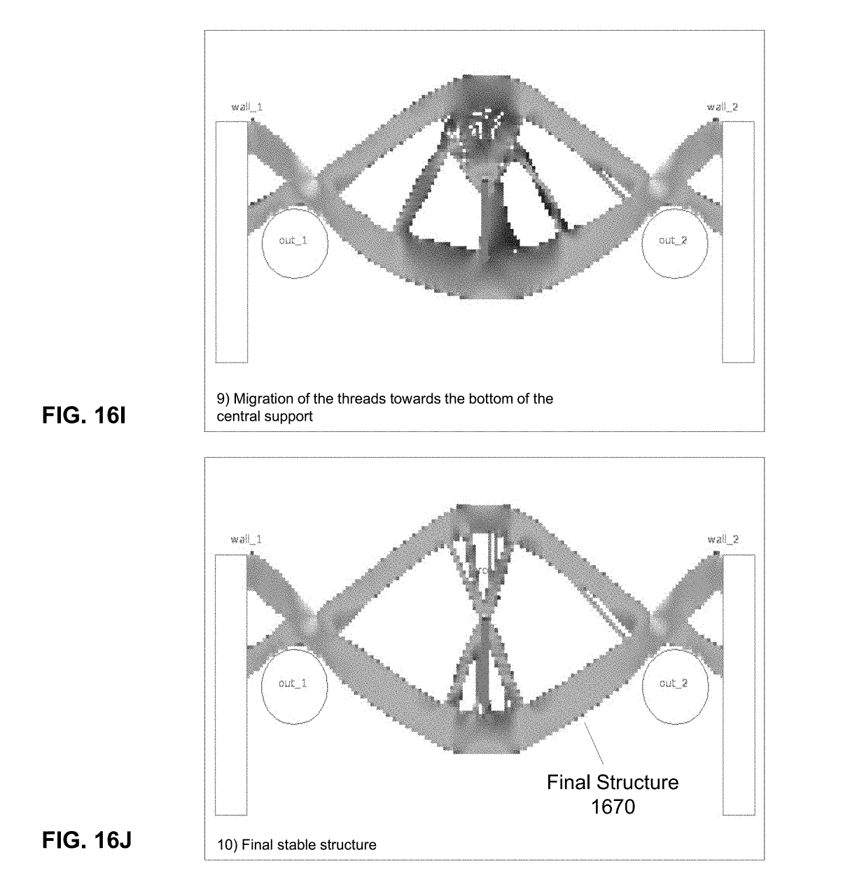

FIG. 16A-J illustrate a sequence of growth and modification of a cell body in an example embodiment. The sequence may be exhibited by a system implementing some or all of the processes and features described above. In FIG. 16A, a cell body 1602 begins as two separate cell populations, each attached to a respective wall 1604a-b, and programmed to grow toward a central target location 1606 between the walls 1604a-b. A process such as the growth process 600 (FIG. 6) described above may direct such growth. In FIG. 16B, the cell body 1602 fuses together at the target, and a force 1610 is applied to the cell body 1602 at the target location. In FIG. 16C, two keep-out regions 1620 are introduced, which prohibit occupation by the cell body 1602. In response, as shown in FIG. 16D, a cell destruction process (e.g., process 1300 of FIG. 13) destroys cells to clear the keep-out regions 1620. Simultaneously, a cell spawn process (e.g., process 900 of FIG. 9) causes additional cells to be spawned to withstand the force 1610.

As shown in FIG. 16E, the cell destruction process also causes some cells at the center of the cell body 1602 to be destroyed as a result of experiencing insufficient strain, opening a cavity 1630 within the cell body 1602. Continued cell spawning and destruction, in reaction to one another and to the force 1610, cause the cavity to expand as shown in FIG. 16F. This expansion continues through FIGS. 16G-I. In FIG. 16G, an upper dome 1640a and a lower dome 1640b begin to form, and the domes 1640a-b are joined by legs 1650. In FIG. 16H, the legs 1650 begin to migrate towards the center of the cell body 1602. The legs 1650 continue to migrate and form new threads as shown in FIG. 16I, as the response to the force 1610 causes the cell spawning and destruction to shift structural support towards the central target location 1606, thereby supporting the force 1610 with greater efficiency. At FIG. 16J, the cell body 1602 forms a stable, final structure 1670 that meets the imposed constraints (e.g., the target location 1606, adherence to the walls 1604a-b, the force 1610, the keep-out regions, 1620) without requiring further modification. The structure 1670 can be further processed (e.g., surface smoothing), and the geometry of the structure 1670 can be exported for use in an assembly in a CAD tool, or may be used to define the geometry of an object to be fabricated (e.g., via a 3D printer).

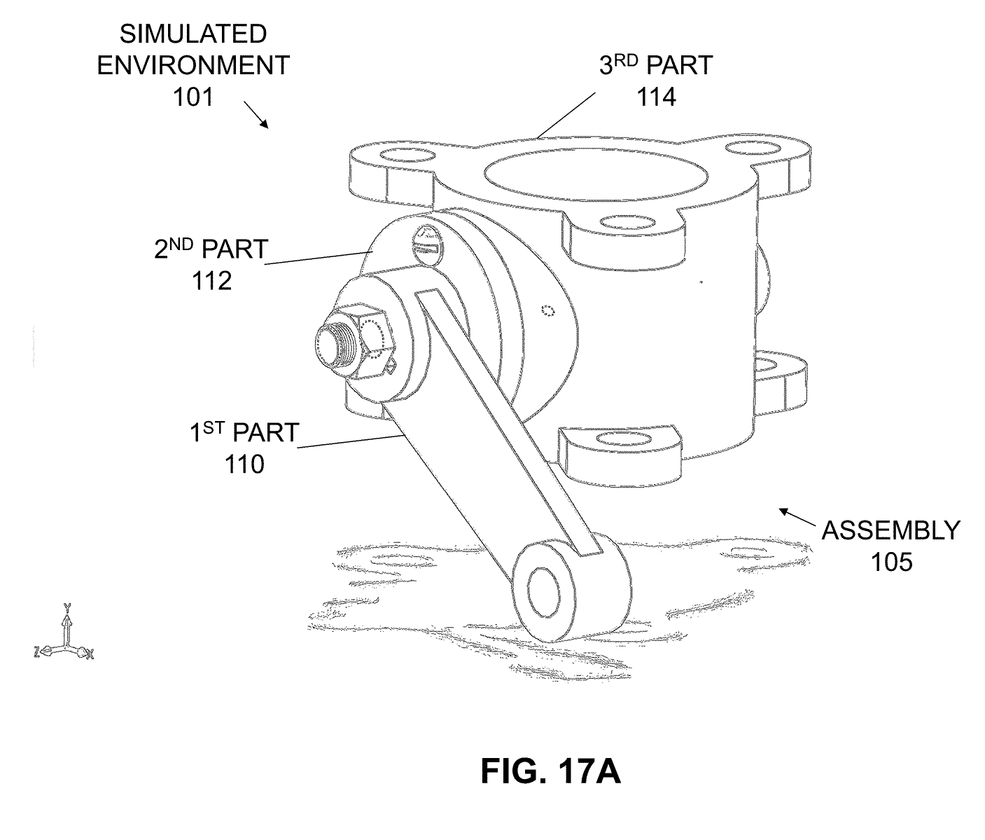

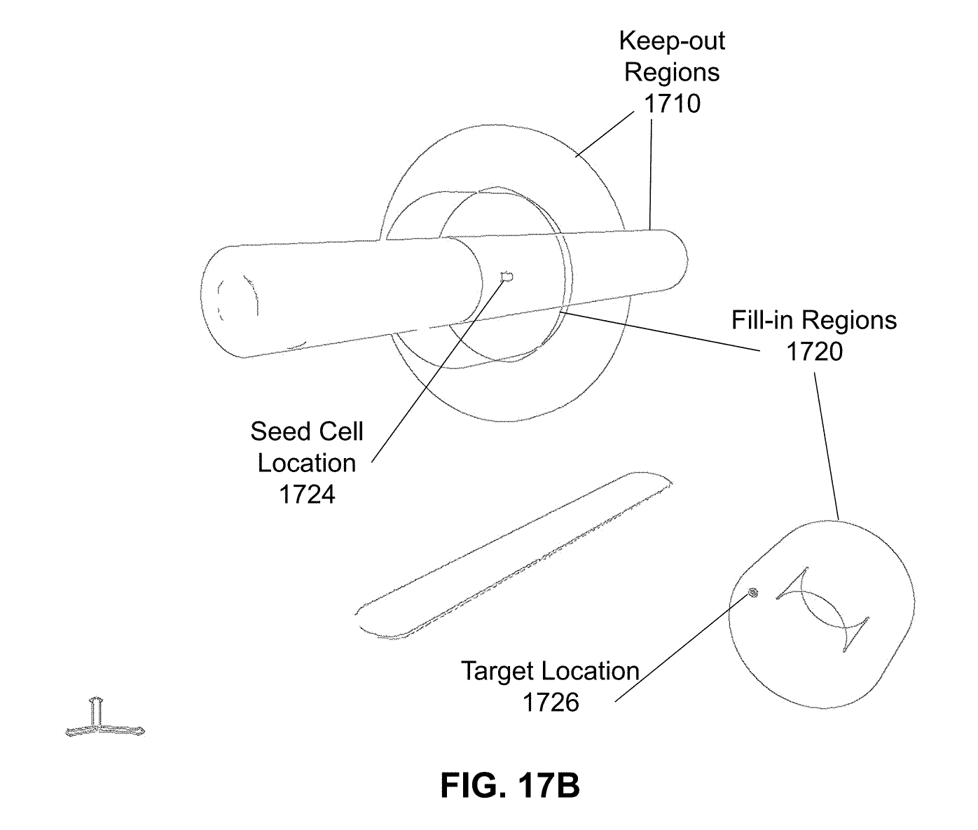

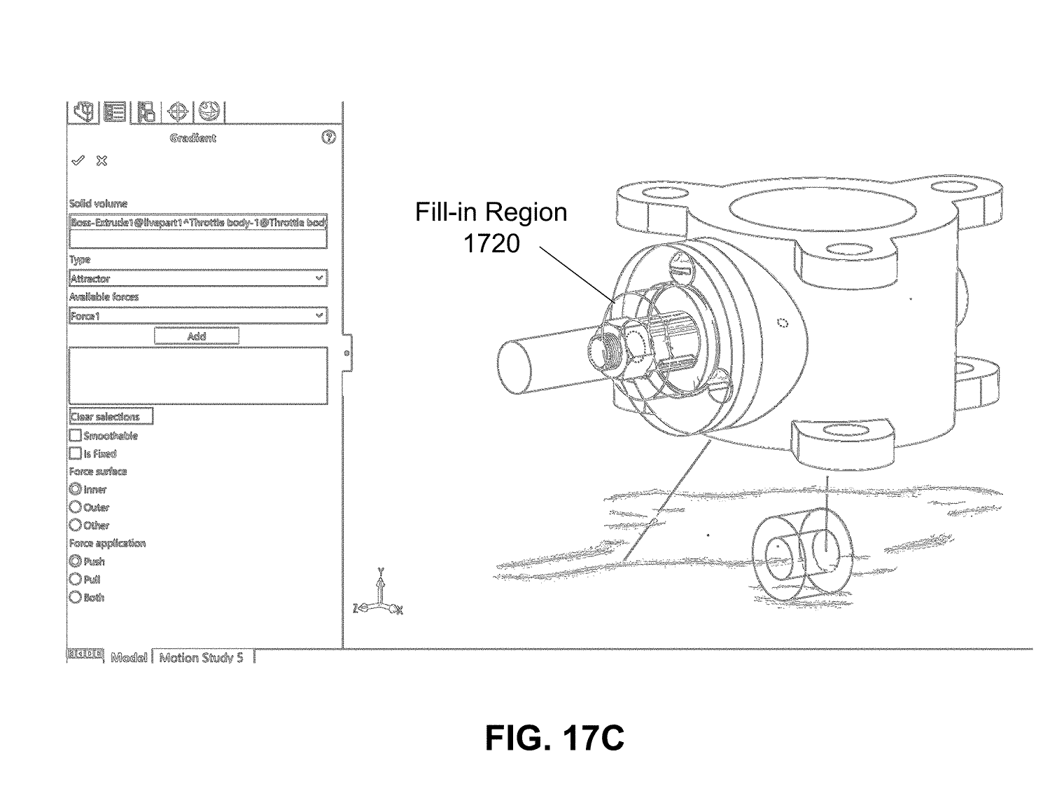

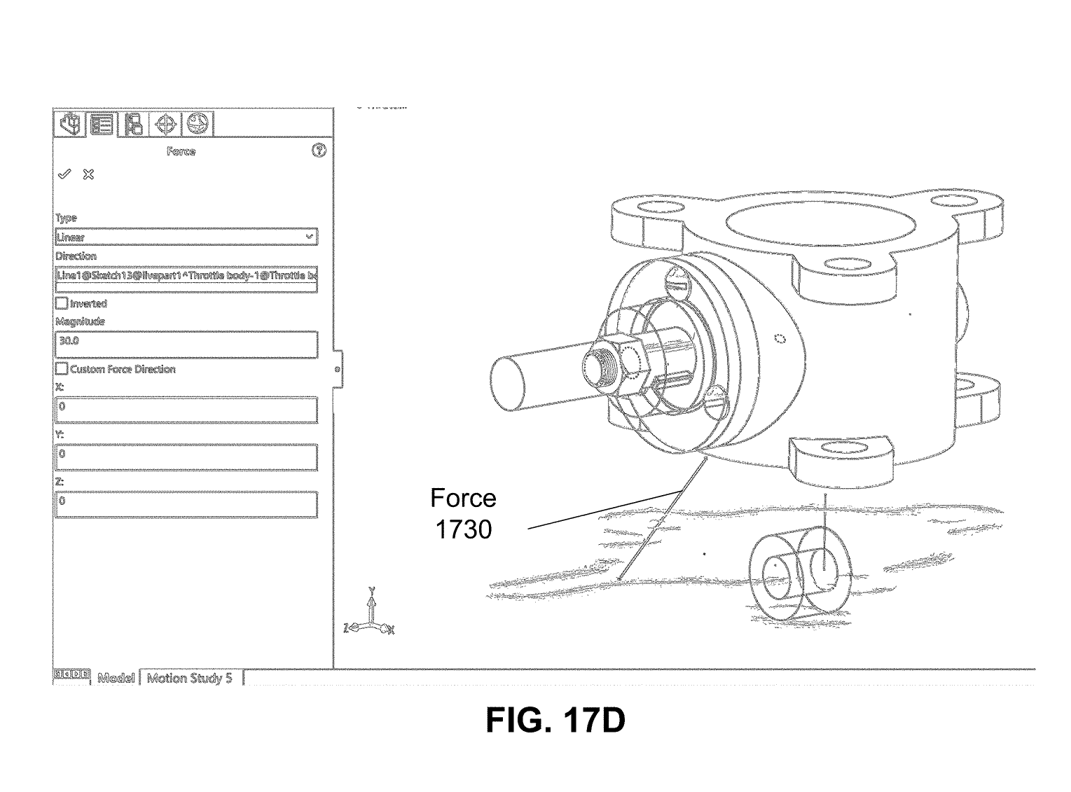

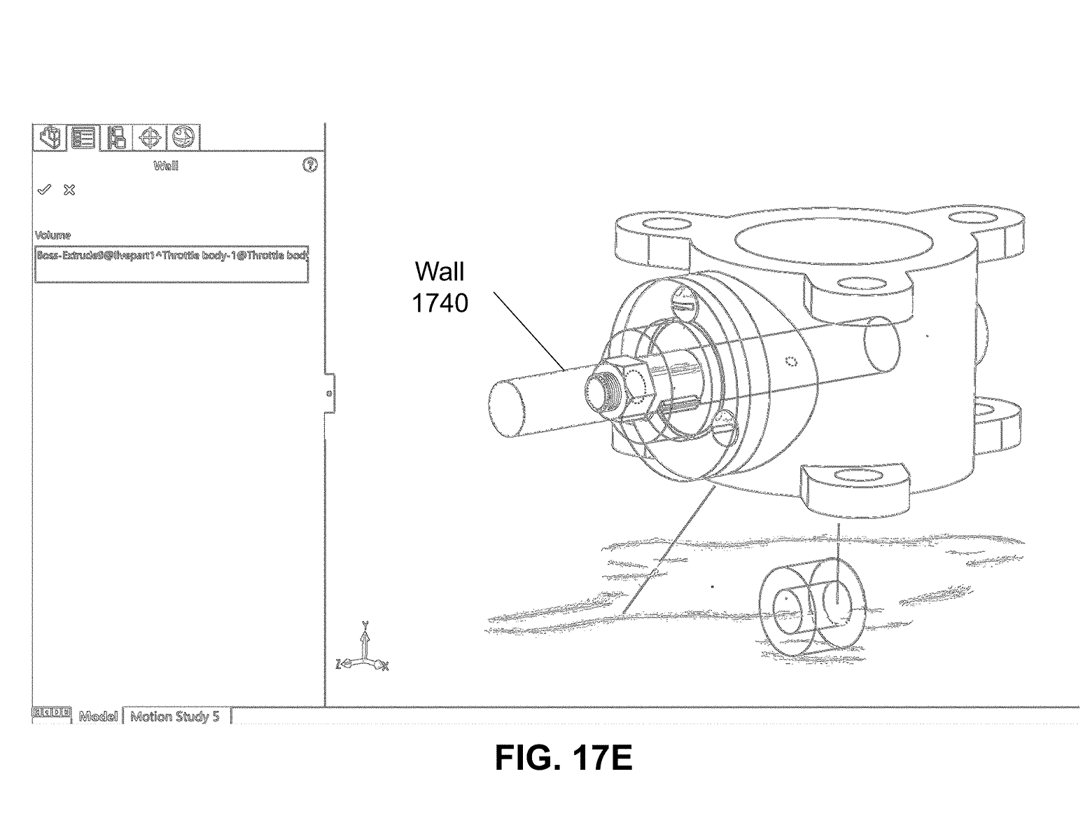

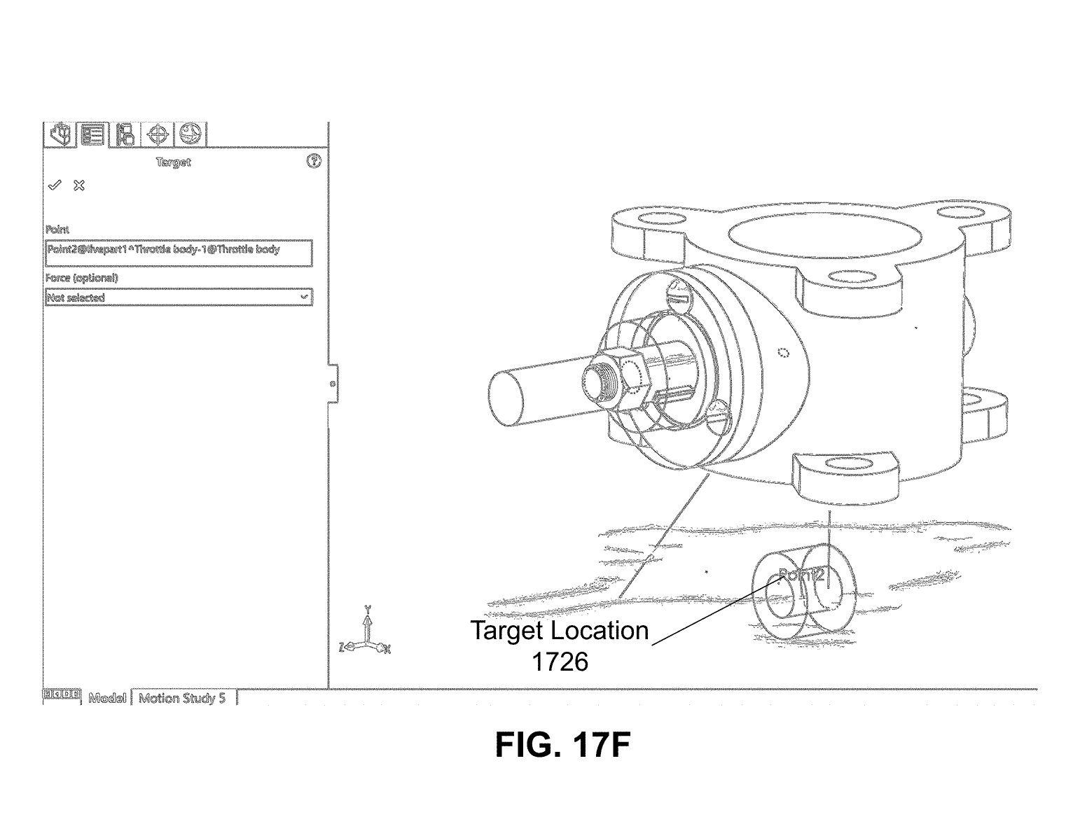

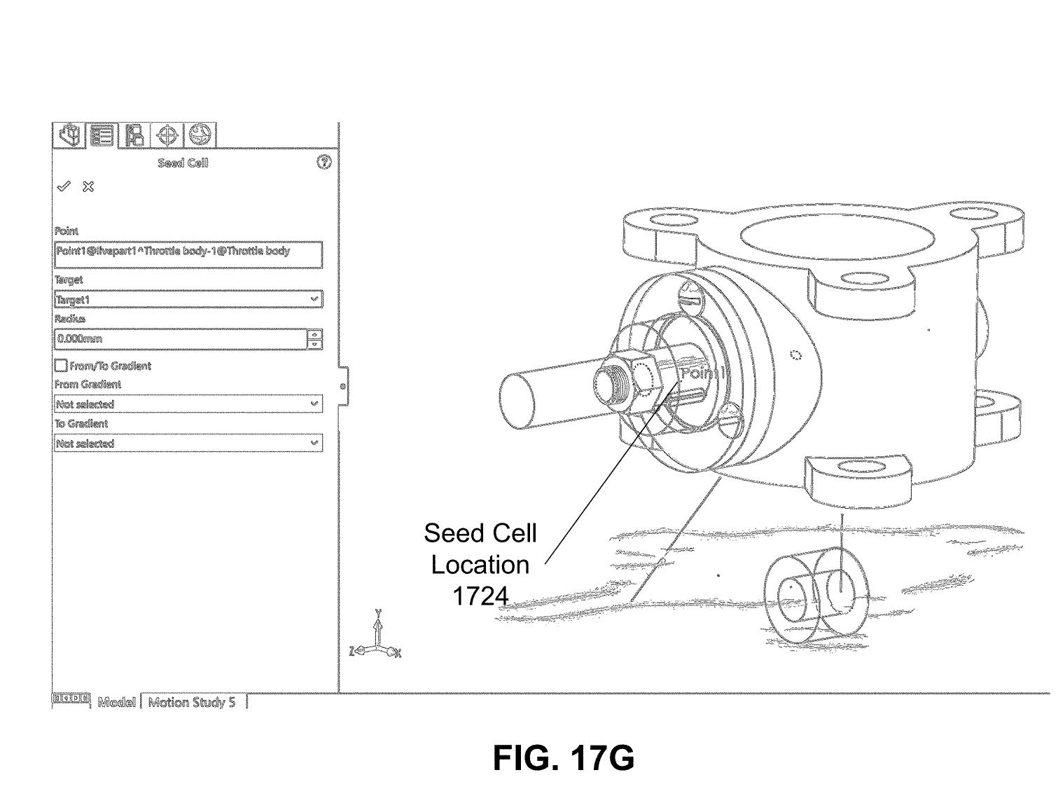

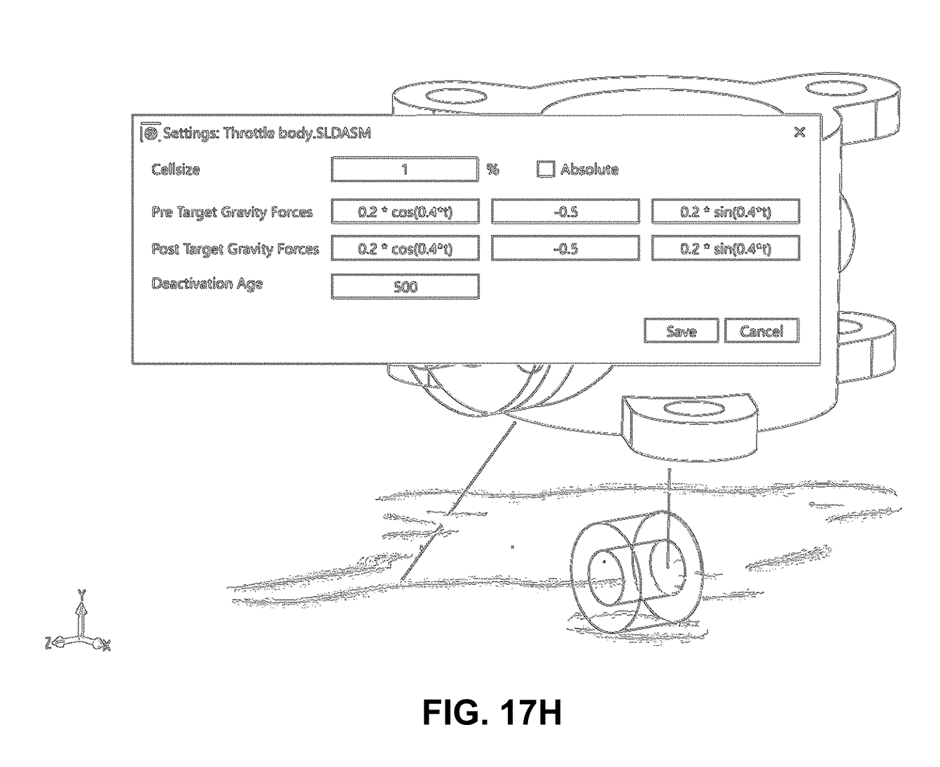

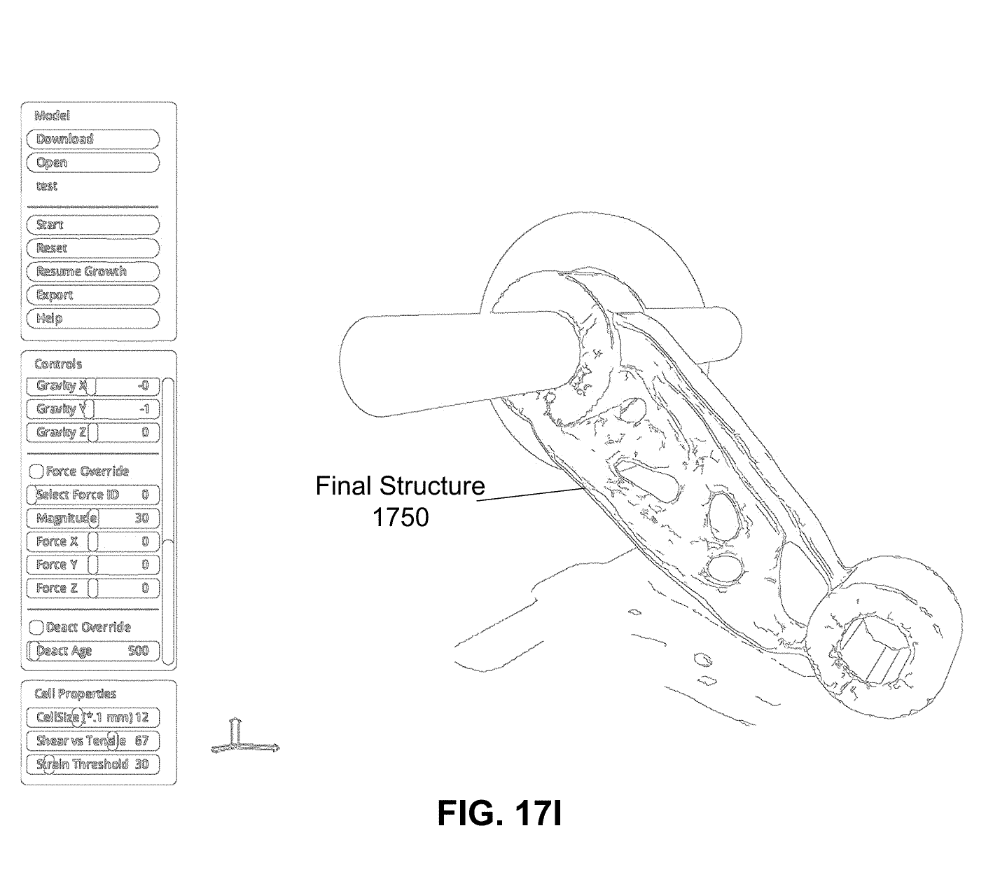

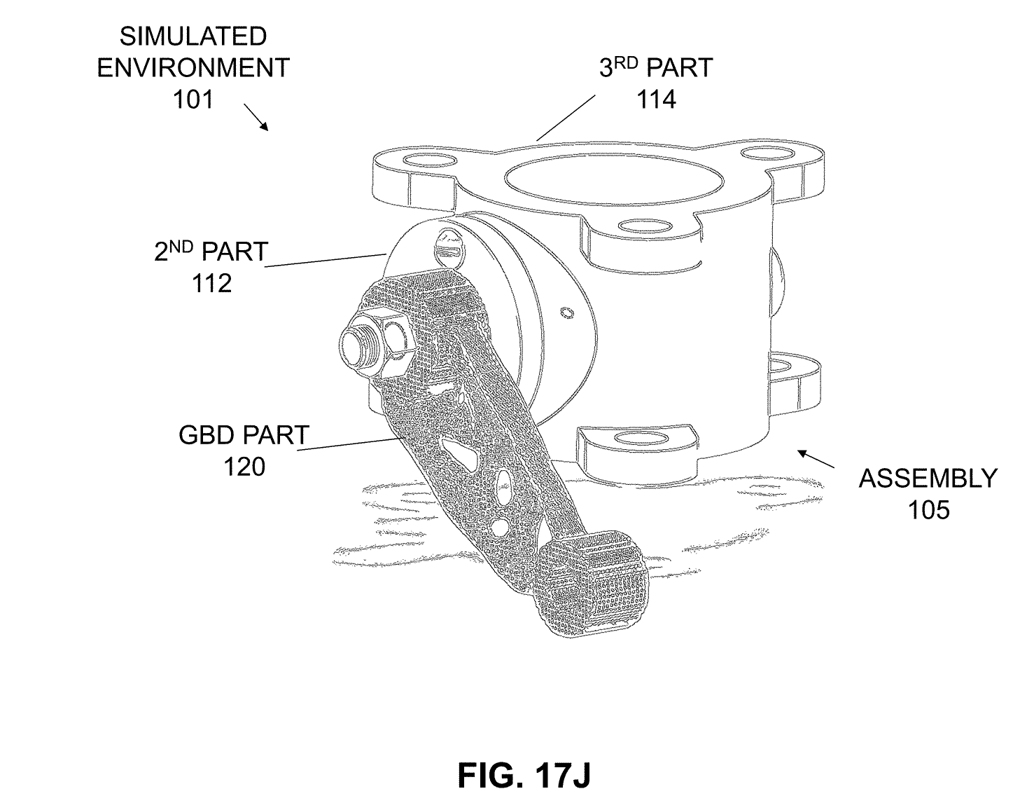

FIGS. 17A-J illustrates a sequence of operations to form an object in an example embodiment. Each of the FIGS. 17A-J shows a portion of a CAD tool user interface during a respective state of a design process. FIG. 17A corresponds to FIG. 1A, illustrating the model assembly 105 within a simulated environment 101 rendered by the CAD tool. In this example, the first part 110 is to be replaced with a newly-designed part defined by a GBD process.

FIG. 17B illustrates an initial environment in which the cell body is to be grown. Here, a number of constraints are established to guide the growth and represent the remainder of the assembly. In particular, fill-in regions 1720 may be imposed to ensure the cell body occupies those regions, and keep-out regions 1710 may be imposed to prevent the cell body from occupying those regions (e.g., regions occupied by other components of the assembly 105). The seed cell location 1724 define locations for one or more seed cells of the cell body, while the target location 1726 defines one or more locations to which the cell body must grow.

FIGS. 17C-H illustrate a number of dialog boxes within a user interface enabling the user to define constraints and other parameters within the environment to affect the cell body. FIG. 17C shows a gradient dialog box for defining the geometry of the fill-in regions 1720. A comparable dialog box may be provide to define the geometry of the keep-out regions 1710. FIG. 17D shows a force dialog box enabling a user to define a force 1730 to be imposed on the cell body. As shown in FIG. 17E, a wall dialog box enables a user to define a wall 1740 to which the cell body will adhere. In this example, the wall 1740 is an outer surface of a keep-out region 1710. FIG. 17F shows a target dialog box for defining the target location 1726, while FIG. 17G shows a seed cell dialog box for defining the seed cell location 1724. Lastly, FIG. 17H shows a dialog box enabling the user to define other parameters and constraints, such as background gravity waves as functions of time and position. Additionally, the user may define cell properties such as cell size and minimum age before a cell is eligible for termination.

FIG. 17I illustrates a final, stable structure 1750 resulting from the cell body undergoing the cell growth, cell spawning and cell destruction processes under the imposed constraints and parameters described above. The structure 1750 may be further processed, such as by smoothing the outer surfaces of the structure. Alternatively, a user may continue to modify the structure by modifying the aforementioned constraints, or by imposing other parameters or forces as presented in the dialog box at left.

FIG. 17J corresponds to FIG. 1B, illustrating a model of the resulting GBD part 120 based on the final structure 1750 in the context of the assembly 105. The model GBD part 120 may be further analyzed within a CAD tool, or may be used to fabricate a corresponding real-world object. For example, a 3D printing system may process the model GBD part 120 to define the geometry of a corresponding printed object, as well as corresponding instructions (e.g., a toolpath) enabling the 3D printing system to print the object.

Dynamic Transitional Forces

Finite element analysis (FEA) simulation tools enable the user define multiple load cases. One may determine that a bracket should be subjected to an upwards force, and in another case, a downward force. Without multiple load cases, if a user added these forces together, the net effect would be zero. Many generative design tools use FEA simulation of a mesh to determine which mesh elements may be deleted.

However, multiple load cases does not address the real world behavior of parts. Parts have to transition from one load case to another over time. They don't just live in a vacuum of isolated load cases. Instead, mechanical parts live in a constantly changing world. Living organisms operate in the same way. But what is unique to living organisms is that they are able react to time varying states. Whether it's high frequency vibrations or low frequency oscillations, cells react to forces by building up and emitting chemicals, over time, called morphogens—and these cause the organism to change behavior by growing stronger or atrophying—regardless as to the time scales of these transitions.

Example embodiments can operate to simulate nature's dynamic transitional forces by combining a multi-physics engine with cellular growth and chemical morphogenesis. A part is an organism living in a continuously changing world. This means that if a design calls for an upward and downward force, one can model that scenario as not just two isolated load cases, but the following: a) an impulse that changes from up to down abruptly, b) a low frequency oscillation, c) A vibration that might generate fatigue, and d) a randomized collection of changes.

In the real world, forces are like waves in the ocean, and every now and then they build up to create a “perfect storm,” causing unexpected outcomes. Example embodiments enable parts to be being grown to handle these perfect storm cases because parts are able to become stronger over time as they experience these dynamic transitional forces.

Example embodiments provide an environment where a 3D cell population spawns new cells and destroys existing cells in a real-time simulation. At each iteration of the simulation, strain is calculated for each cell, and the system may use the strain values to determine if a cell is over-strained or under strained. Cells that are over-strained may benefit from the spawning of neighboring cells to provide more structural integrity, while cells that are under-strained may be destroyed without harming the structure. In order to calculate the strain on cells, the system associates a cell with a collection of springs and masses where the springs may counteract tensile strain (compression and tension) as well as shear and torsion. The masses may also experience forces exerted at locations where the cell makes contact with external surfaces, as well as gravitational forces, magnetic induced forces, or forces caused by interaction with gases and fluids or other elements.

Because the cell population reacts to changes at each iteration step (whereby a step represents one “tick” forward in time), it can be important that the forces be updated for each particle mass associated with the cells at each iteration. This gives the system real time behavior whereby cells constantly adapt to changing forces in the environment. For example, when a collection of growing cells forms a stem, the weight of the cells causes the stem to bend, thus causing strain to build up and cells to spawn in order to grow stronger and resist the bending. At each time step, forces on particles are updated as a result of solving for the positions, velocities and accelerations in a multi-physics engine. Springs provide restoring forces between particles, and also provide damping in order to remove energy from the system over time. External forces are also updated on particles with each iteration. External forces applied to particles may be defined by users as expressions that are a function of time, position, and neighboring cell state. Thus, a force need not have a fixed direction and magnitude over time and position during the simulation. The ability for forces to change continuously is called “dynamic transitional forces.”

One example of dynamic transitional forces are gravity forces. Users may define gravity waves to be expressions that incorporate time and position as in the following:

Gravity force: “gravity”: [“0.4*cos(0.4*t)”, “(t<1000)?−5.0: −0.5”, “−0.4*sin(0.4*t)”]

Here, the magnitude of the gravity in each of 3 directions is defined as a function of time. The gravity in Y is a step function that bumps down after a certain amount of time has passed. Gravity in the X and Z directions is a periodic oscillating function of time. These gravity forces serve to subject cells to constant undulating forces that combine with other user defined forces. It is possible that the additive effects of forces on a particle may combine in important ways, similar to the way waves may add up to create a “perfect storm” effect where a rogue wave forms due to unexpected combinations of forces.

The following are examples of dynamic transitional forces applied to cells by external objects.

Periodic Impulse Force: “magnitude: “(floor(t/15) % 2==0)? 80: −80”

Here, the force is defined to abruptly change in magnitude from +80 to −80 every 15 time steps. It may be defined to apply in a “pushing” or “pulling” manner to a surface such as the inner surface of a bearing:

Oscillating Force: “magnitude”: “120.0”, “direction”: [“0.0”, “−1.0*cos(0.4*t)”, “1.0*sin(0.4*t)”]

Here, the magnitude is fixed, but the direction of the force changes as a function of time. This force may also be applied to a surface as in the previous example.

Static Position Varying Force: “magnitude”: “(abs(x)+abs(z))*10.0”

Here, the force is a function of the position of a cell and its particles in space. If this force is applied to a table top surface centered at the origin (X=0) (Y=0) then the force will grow stronger at the edges of the table.

Generally, software programs 510 comprise logic and data embodied in, or readable from, a device, media, carrier, or signal, e.g., one or more fixed and/or removable data storage devices 504 connected to computer 500, or one or more remote devices accessed via a network connection 508. The logic is generally written in a programming language, and contains calls to an operating system on the computer 500 that interfaces with, and controls, components connected to the computer 500.

Force expressions may be as complex as desired, and may be defined for both magnitude and direction at the same time. A cell may also experience multiple forces at the same time. At each time step, when a cell is deemed to be subjected to forces, the system may determine the magnitude and direction of each force given the time and the position of the cell. The system may apply the unique values of force and magnitude to each of the cell's particles. These forces may also be calculated at different levels of granularity where the position of each particle is taken into consideration, rather than just the position of the cell. Forces may also be defined as expressions that take other state variables into consideration. For example, an expression may define the force as a function of a cell or particle's velocity, which is a vector, similar to a particle's or cell's position. This gives the force a damping behavior on a cell's motion.

In further embodiments, cells may be configured to be able to accumulate knowledge of the events (i.e. state changes) that impact them over time. They use this accumulated knowledge to make decisions such as when to spawn neighboring cells or when to terminate. No other system such as topology optimization enables elements to acquire knowledge derived from events over time and use this information to affect behavior.

In cells, events that cells are able to sense, such as changes in pressure, velocity, and acceleration, cause cells to produce chemicals, and these chemicals accumulate within the cell over time as well as diffuse into the environment around them over time. This is how a cell builds up a representation of knowledge of what has happened to it over time. It is also how a cell communicates what is happening to it with its neighboring and distant cells—by the diffusion of chemicals into the cell fabric (e.g. collagen).

Example embodiments consistent with principles described herein may use this same approach to allow a cell to build up knowledge of the kind of activity it is experiencing. So, for example, an infrequent surge in strain that moves through the organism might register a spike in the cell here and there, and cause it to bump up the value of an internal state variable X. However, because this increase is infrequent, the diffusion or gradual reduction in the value of X will keep it below the threshold that would trigger the cell to spawn a neighbor, or decide alternatively that it is too spent or fatigued and thus die.

On the other hand, a high frequency vibration could stimulate the cell with frequently occurring strain distortions, and this would cause the value of the variable X to increase faster than the diffusion rate correspondingly reduces it. As a result, the cell might signal spawning of a neighbor to help relieve the strain, or alternatively, realize that it is too fatigued to stand up to the high frequency vibration.

In the latter case, the cell's higher concentration of variable X would cause the diffusion rate to be larger. A higher diffusion rate causes the propagation of the chemical X into its surrounding environment to be further reaching, and for the concentrations of Xin the cell fabric to be higher. In example embodiments, neighboring cells may sense the concentration of a variable such as X, and this may cause the cell to change the value of its own X or another variable Y.

In nature, there is a famous example of cellular chemical interaction called Reaction Diffusion Equations. Alan Turing used this example to explain how Zebras get their stripes. Cells emit two different chemicals that affect color pigmentation, and the rate of production of each chemical is a function of the concentration of the other. As the cells produce chemicals and diffuse them into the environment, a complex interplay of chemical concentrations evolves, causing complex patterns to emerge.

Example embodiments may use a similar kind of cell-to-cell communication and accumulation of state over time to enable cells to act autonomously. For example, cells may maintain a collection of state variables X, Y, Z. The variables maintained by cell 1 may be different from the variables in cell 2.

Cells may reside in a cell fabric, which is a deformable 3D grid that positions the cells relative to each other. Cells do not necessarily need to occupy slots in the fabric, but each slot may be able to maintain a concentration of chemicals represented by variables similar to those in the cells. At each time step, cells sense the concentration of variables in their cell fabric slots, and they sense events such as changes in force, position, velocity, that apply to their physical embodiments, such as masses and springs. At each time step, the cells may update the state of their own variables based on the latest events. The cells then apply functions to further diffuse or increase these values. At each time step, the cells then transmit the new state of certain variables to the cell fabric. Once in the fabric, these values may propagate to neighboring fabric slots where other Cells may sense the variable state changes. At any time, the cells may react to the state of their variables. They can decide to spawn neighboring cells, die off, or change properties such as their own stiffness or damping characteristics.

The cells may also use the concentration of chemical values in the cell fabric to make “group” decisions such as whether a feature is too small. In this case a feature may represent the cross-sectional area of a collection of connected cells. No individual cell can know the shape of the higher-level organism, but the concentration of chemicals in the cell fabric can give it clues about how to behave and this may cause the organism to thicken areas that are too thin.

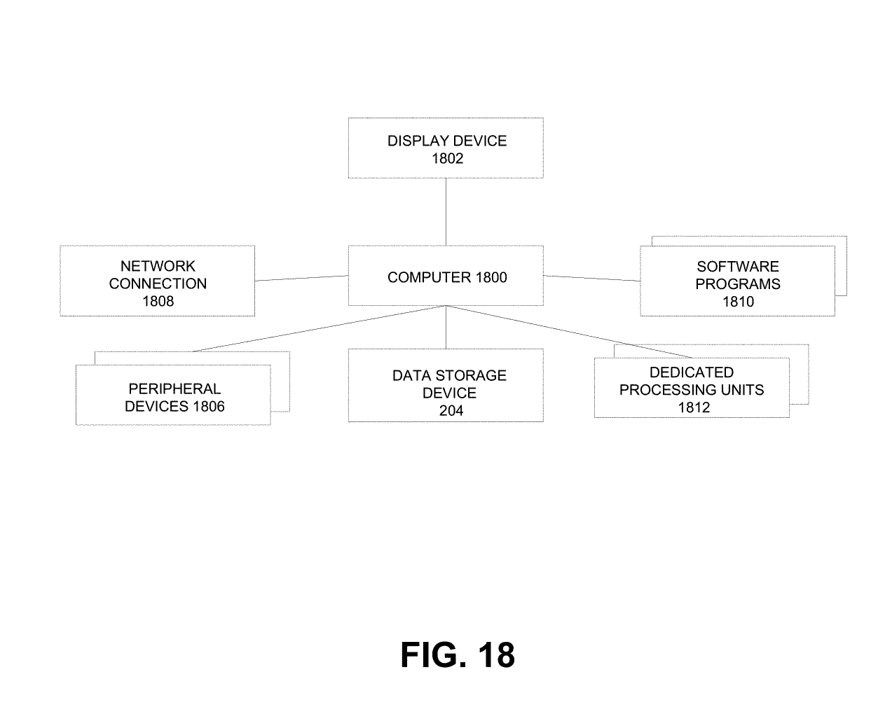

FIG. 18 is a block diagram of a hardware and software environment in which example embodiments may be implemented. Embodiments may be implemented using a computer 1800, which generally comprises a display device 1802, a data storage device 1804, one or more peripheral devices 1806 (such as pen/tablet, mouse, and keyboard), a network connection 1808, one or more software programs 1810, and one or more optional dedicated processing units 1812, such as a hardware implemented physics processing engine. The computer 1800 may additionally be a mobile device such as a smart phone, tablet, or embedded device on a machine. Those skilled in the art will recognize that any combination of the above components may be used with the computer 500.

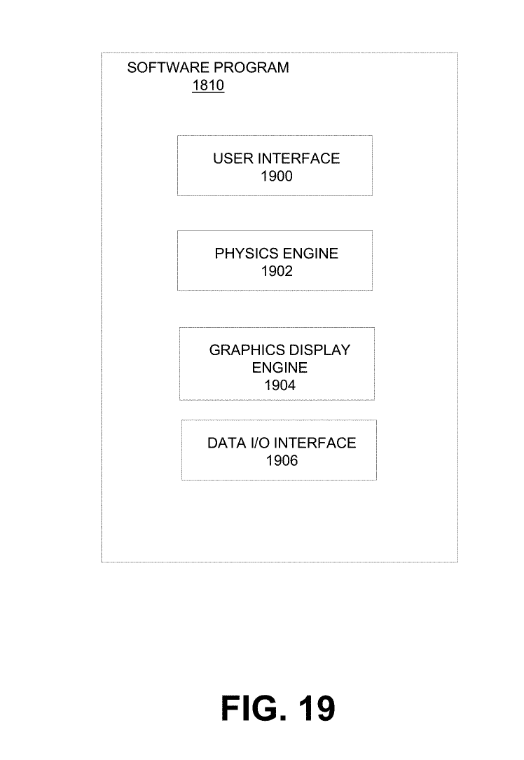

FIG. 19 is a structural block diagram illustrating components of the software program 1810 according to an example embodiment. With reference also to FIG. 18, the software program 1910 may comprise a user interface 1900 supporting input commands supplied by a user via peripheral devices 1806 (e.g. keyboard, mouse, or touch screen). Software program 1810 may also comprise a physics engine 1902, optionally utilizing a dedicated processing unit 1812, should one exist. Program 1810 may also comprise a graphics processing engine 1904 for optionally rendering 2D and 3D graphical displays to the display device 1802, and a data input/output interface 1906 for reading and writing data to and from the data storage device 1804. Example embodiments may also comprise a standalone software implementation (a computer program product). Those skilled in the art may appreciate that the example embodiments may be implemented as a “plug-in” extension to a CAD tool such as Pro/ENGINEER from Parametric Technology Corp., 3ds Max from Autodesk Corp., or Sketchup from Google Corp.

Voxel Fairing

Further embodiments may implement a software algorithm referred to as Voxel Fairing. Voxel fairing is an approach to applying a pseudo-smoothing algorithm to a model comprised of voxels that serves as a step in between the raw voxel format of the model and a fully smoothed form of the model. The raw voxel format of the model is represented by a 3-dimensional set of points that represent the vertices of each voxel. The algorithm analyzes each point and its neighboring points to create a geometric mesh of triangles around the outside of the voxels with “fabric-oriented,” “slant,” “corner,” and “inverse corner” triangles filling in areas of the raw voxel model to provide a smoother model that retains the features of the original model.

It is advantageous to bring the generated parts from their initial voxel-based format into a smoother format for production and use by the end user, and the desired method of smoothing would not be able to smooth the original raw-voxel model to the desired level while still retaining its features. When the desired smoothing method was applied to the raw-voxel model, the result either still had an undesired roughness or had features of the original model that were worn thin by the algorithm over too many iterations.

Example embodiments may satisfy this need by applying a rough stage of pseudo-smoothing to the original raw voxel model while preserving features desired in the end model. When the desired smoothing method is applied to this “faired” model, the result is a cleaner model that retains feature size better than applying the smoothing method to the raw voxel model.

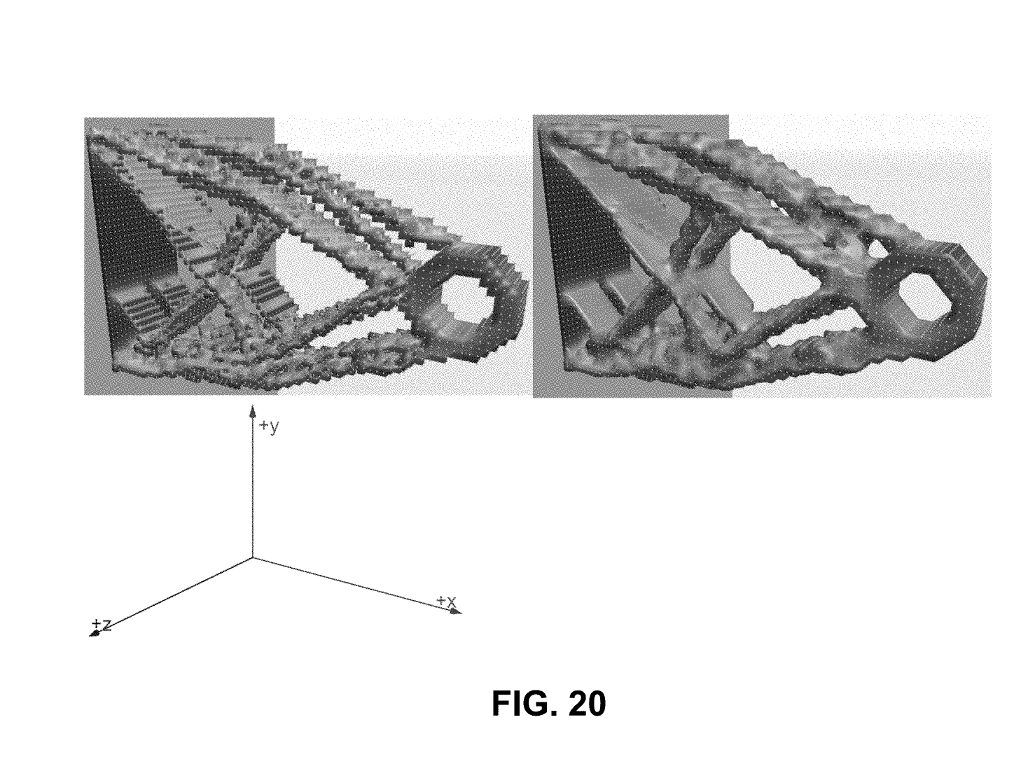

FIG. 20 shows an example of a model that underwent the process of voxel fairing. The model on the left is the model before fairing occurred and the model on the right is the model after fairing. The algorithm begins by stripping all geometric triangles from the model so that it can generate its own triangles for the faired mesh. It then loops through each vertex of the voxels of the model and analyzes whether vertices exist in each cardinal direction from the current vertex, so it may decide whether to insert each of the 4 types of geometric triangles: Fabric-Oriented, Corner, Inverse Corner, and Slant.

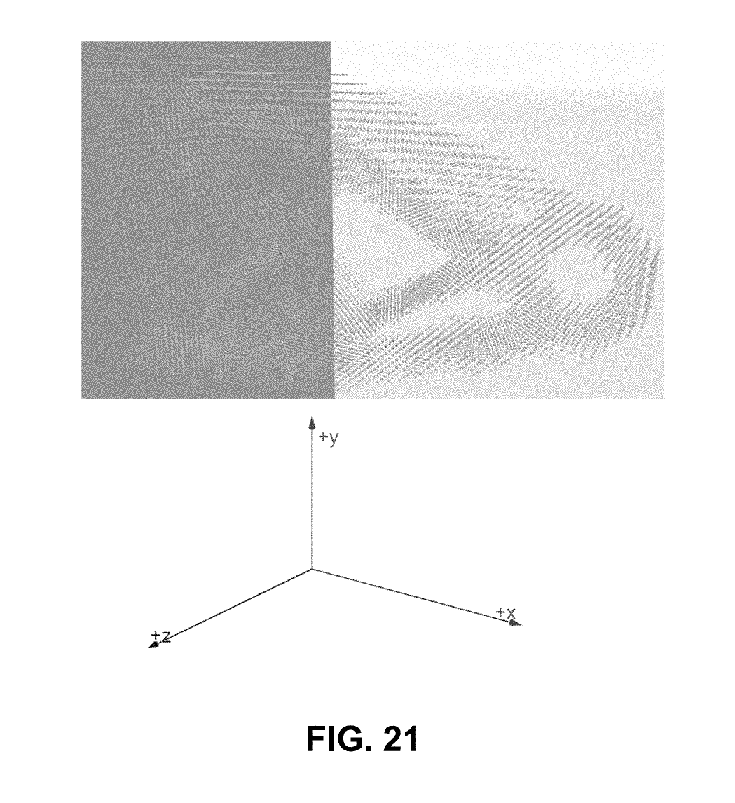

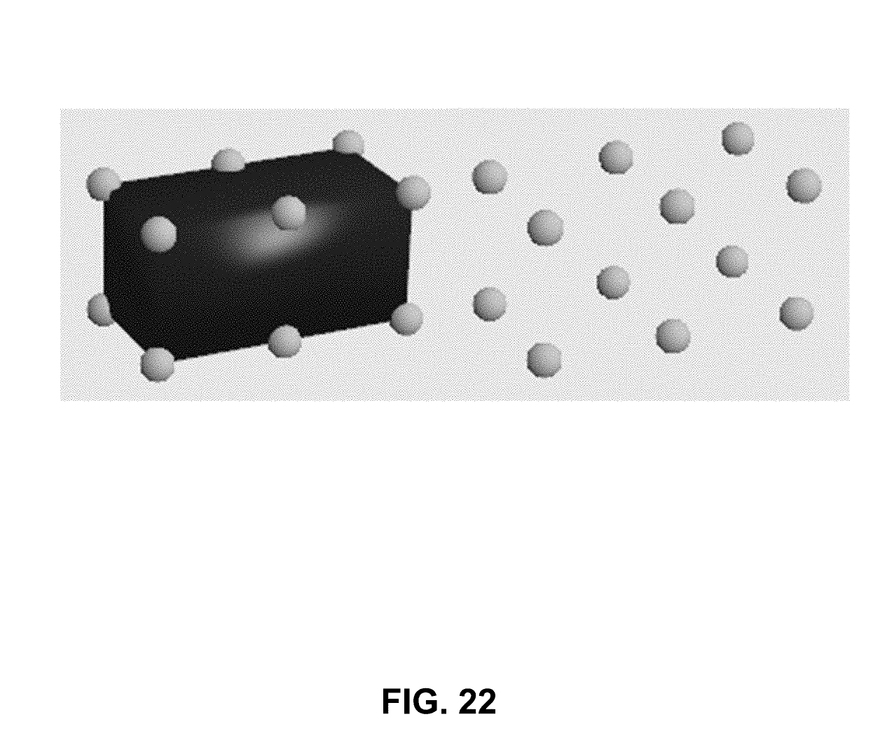

The model is represented by a grid of points, which is shown by FIG. 21. Where two or more voxels meet (on faces, edges, or corners), the shared vertices are represented by a single point. For example, if there were two voxels side by side, connected by a face, four of the points would be shared, resulting in a representation of 12 points in total (illustrated by FIG. 22).

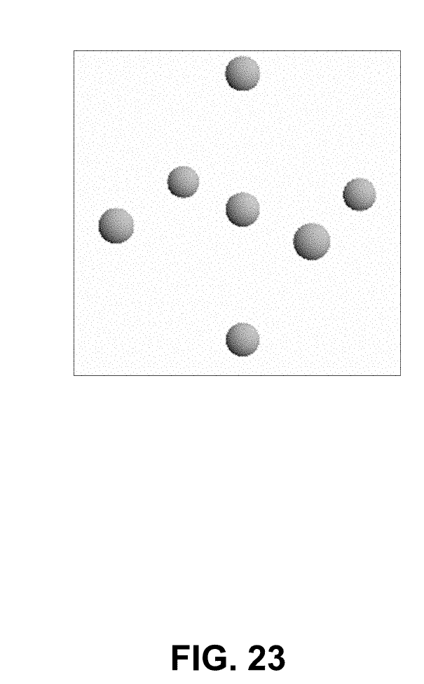

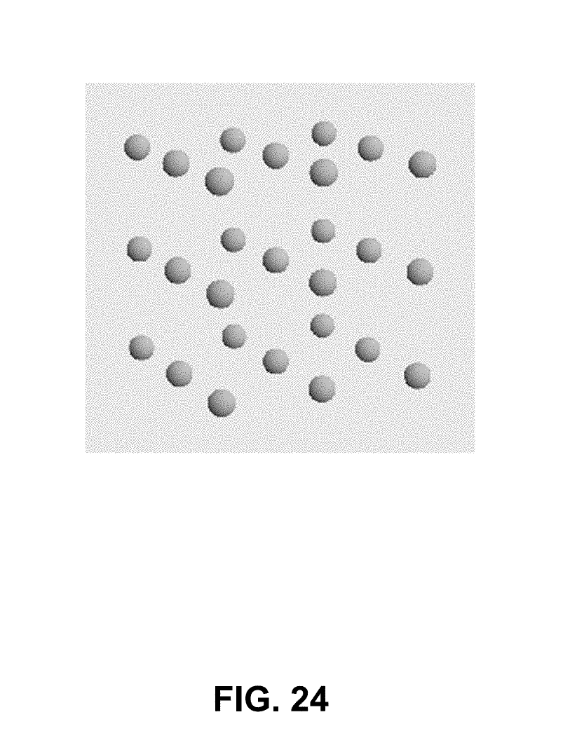

When the algorithm is looping through every point in the model to decide where to place the geometric triangles, it analyzes positions neighboring the main point. This is shown in FIG. 23, which illustrates the point being analyzed and the 6 neighboring points. After it chooses a neighbor to analyze, it continues by analyzing all the points in the immediate area surrounding the base point, which is shown in FIG. 24. Some of these reference positions may or may not be active points in the grid. The algorithm uses the information of what points neighbor the point being analyzed to decide what triangles to place (if any) that connect to the main point being analyzed.

As the algorithm cycles through all points in the model, it analyzes the current point (Base Point) and all surrounding points to decide where to place triangles. Those points that are in the ±x, ±y, or ±z directions from the base point and are 1 unit away from the base point are defined as the “neighbors” of the base point. Points in a combination of the ±x and ±y, ±y and ±z, or ±x and ±z directions from the base point are known as “diagonals” of the base point. These points are at a distance of √2 units from the base point. Points in a direction comprised of all 3 axes are “opposite points” to the base point and are at a distance of √3 from the base point. The algorithm uses these sets of points to determine where to generate triangles. There are four types of geometric triangles the algorithm generates as it loops through the points: Fabric-Oriented, Corner, Inverse Corner, and Slant. The Fabric-Oriented Triangles are comprised of two types: Normal and Abnormal.

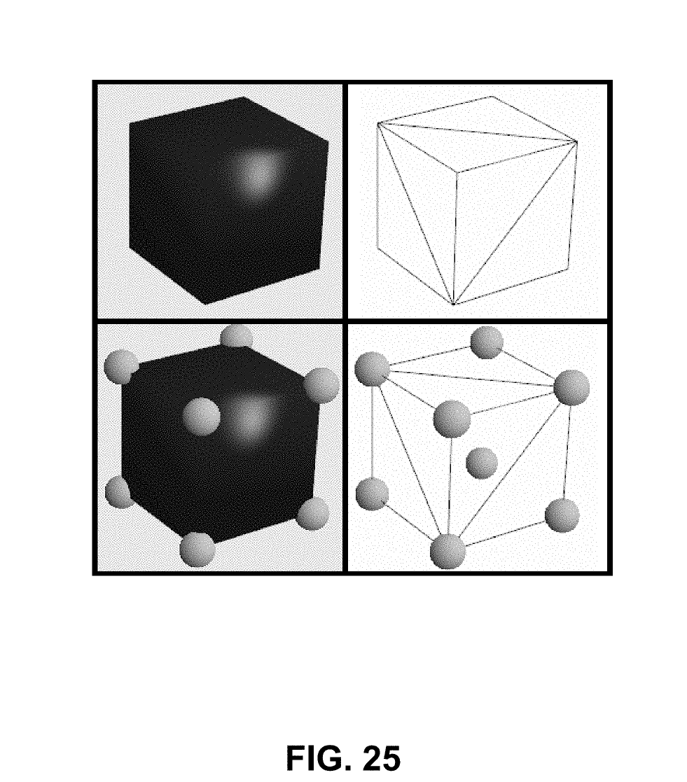

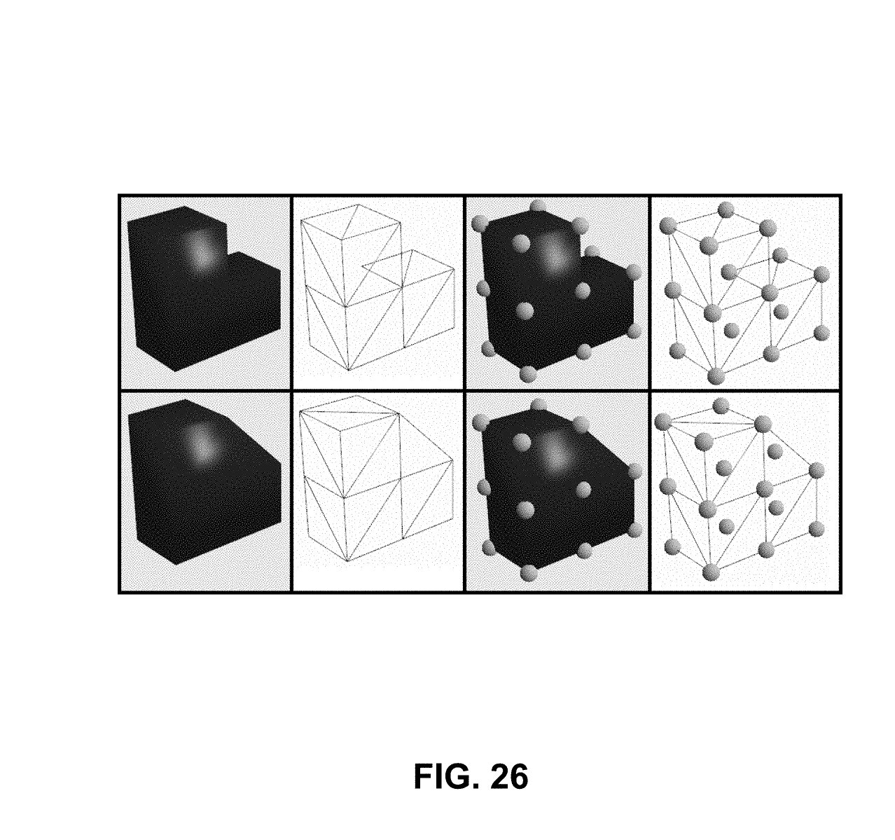

All Fabric-Oriented Triangles (FOTs) are placed between 3 points that all lie on the same plane (x-y plane, y-z plane or x-z plane) during the fairing process. This means that the normals of all FOTs are in the cardinal directions from the base point. Typically, FOTs are generated on faces of voxels in pairs, but there are instances where FOTs must either spawn in between voxels (as in FIG. 26) or leave one of the two triangles that would normally spawn out due to other types of triangles spawning. In these cases, there is a potential to spawn Abnormal FOTs, which have their normals swapped from Normal FOTs. FIG. 25 is an example of a set of Normal FOTs, while FIG. 26 has a single Abnormal FOT in it on the side of a Slant.

When the algorithm generates a FOT, it analyzes each neighbor point, and based on the cardinal direction, also analyzes another neighbor point, specified as a leg. If the neighbor lies on the x axis (either positive or negative) in relation to the base point, the leg is chosen to lie on the z axis (also either positive or negative) in relation to the base point. If the neighbor lies on the y axis, the leg is chosen to lie on the x axis. If the neighbor lies on the z axis, the leg is chosen to lie on the y axis. With each attempt, the algorithm will attempt to spawn 4 triangles: 2 with the legs going in opposite directions (i.e. + and −z direction if the neighbor lies on the x axis from the base point) with the triangle normal being the cross product of the neighbor and the leg (Normal FOT) and 2 with the same leg directions, but with the normal reversed (Abnormal FOT).

For Normal FOTs, the triangle will only generate if the points in the normal direction of the base, neighbor, and leg points are all nonexistent, meaning the face is open, or if the point in the normal direction of the base is open and the point in the diagonal direction of the neighbor and leg combined from the base point is open, meaning there is a slant, corner, or inverse corner that needs its sides filled in that location. For Abnormal FOTs, it is more restrictive, as they only generate in non-standard cases (Sides of slants or Inverse Corners, Corners and Slants cutting through faces). In these cases, the point in the normal direction from the base point must be clear. Then there is a choice: Either the point in the diagonal direction lying on the face of the potential FOT is clear or the points in the normal direction of the leg, neighbor, and the diagonal that does exist are clear.

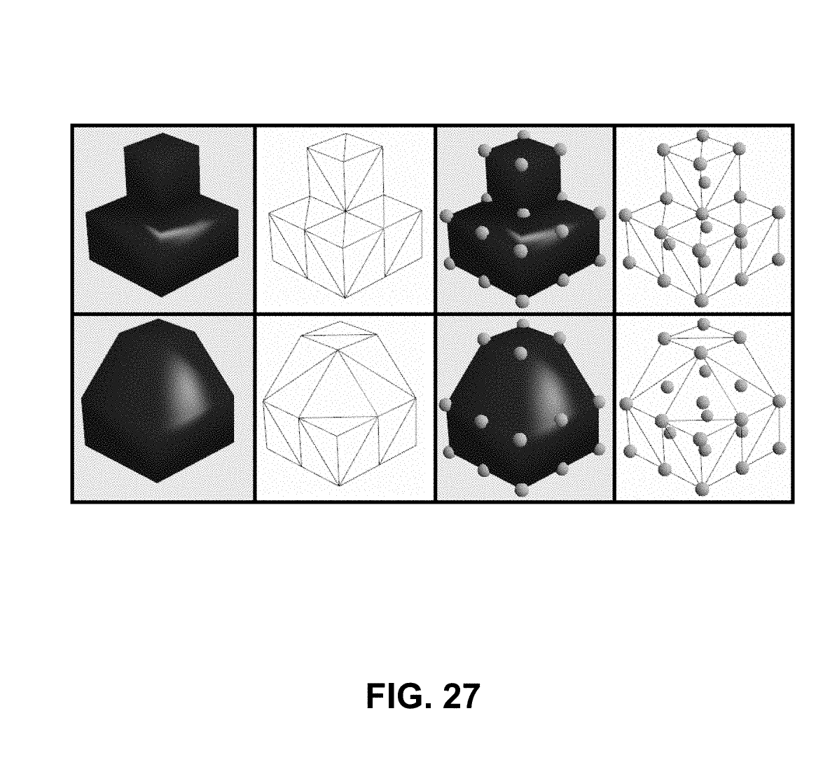

Corner Triangles are generated in between 3 points that branch off in the 3 cardinal directions from a base point. The x/y, y/z, and x/z directions of the neighbors are each added together to get the 3 diagonals from the base point. The opposite point being analyzed in this case lies in the direction of all 3 neighbor directions added. If there are points in each of the 3 cardinal directions from the base, no more than 1 diagonal point, and no opposite point, the Corner Triangle can spawn. The normal of this triangle points away from the base point. This is shown in FIG. 27, where the base point is the point that all 5 voxels share. The 3 points that are being used to generate the Corner Triangle in this example are in the −x, +y, and +z directions from the base point. There is 1 point in a diagonal direction from the base point, and it lies at the −x, +z position. The −x, +y and +y, +z diagonals remain without points. Additionally, there is no point opposite the base point. These conditions allow a Corner Triangle to spawn.

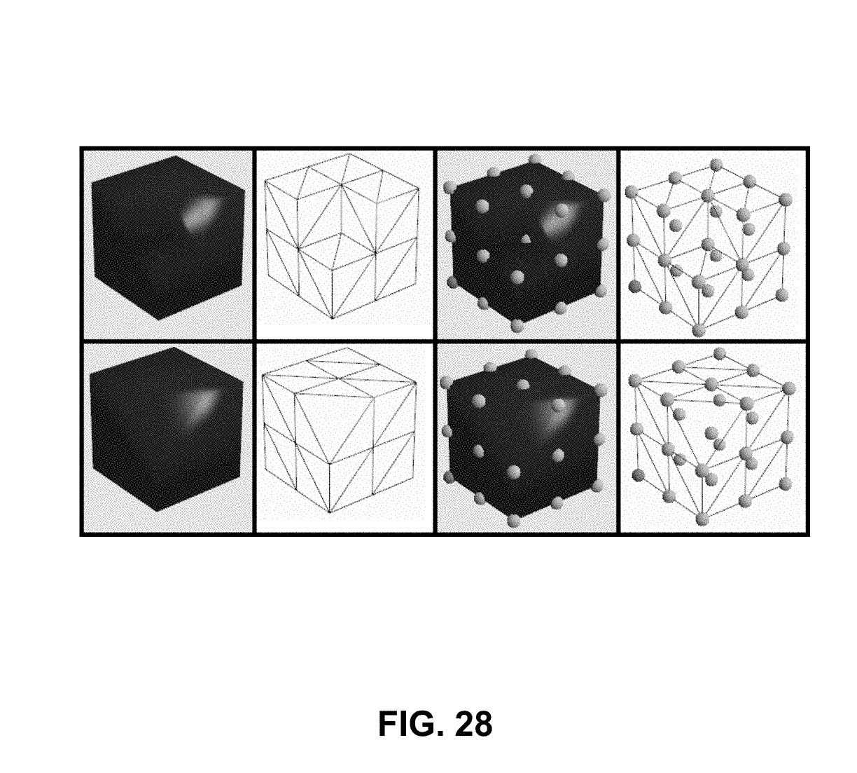

Inverse Corner Triangles are generated when a base point has 3 neighbors —1 of each axis—like with the Corners, but also has all 3 diagonals corresponding with these neighbors, but no point opposite the base. This is demonstrated in FIG. 28. The base point is the point that is shared by all 7 voxels in this figure. It has points in the −x, +y, and +z directions as well as in the directions of all 3 diagonals. Because the 8th voxel is missing, there is no point opposite the base point. These conditions allow an inverse triangle to spawn where the voxel is missing.

Slant Triangles are the most complicated to spawn. Each slant is comprised of 2 triangles, each with distinct base points. In these cases, the base points are a part of the triangles being generated, like the FOTs. Depending on the direction of the neighbor being analyzed from the base point, it chooses a “slant direction,” which is any of the 4 cardinal directions perpendicular to the line created between the base point and the neighbor. The 2 remaining directions that are perpendicular to the base/neighbor lines and the base/slant lines are the “cross directions.” For a single slant triangle to spawn, the points in one of the slant directions above the base point and the neighbor must be clear. Additionally, the points in the cross direction from the base point and the neighbor point must be filled, as well as the points in the slant direction from those positions (otherwise referred to as the “slant/cross directions” from the base and neighbor). If these conditions are met, a triangle is generated between the base point, the neighbor, and the point in the cross direction plus the slant direction from the base point. Using this logic, as more base points are analyzed, inevitably, the other half of the slant will be filled in.

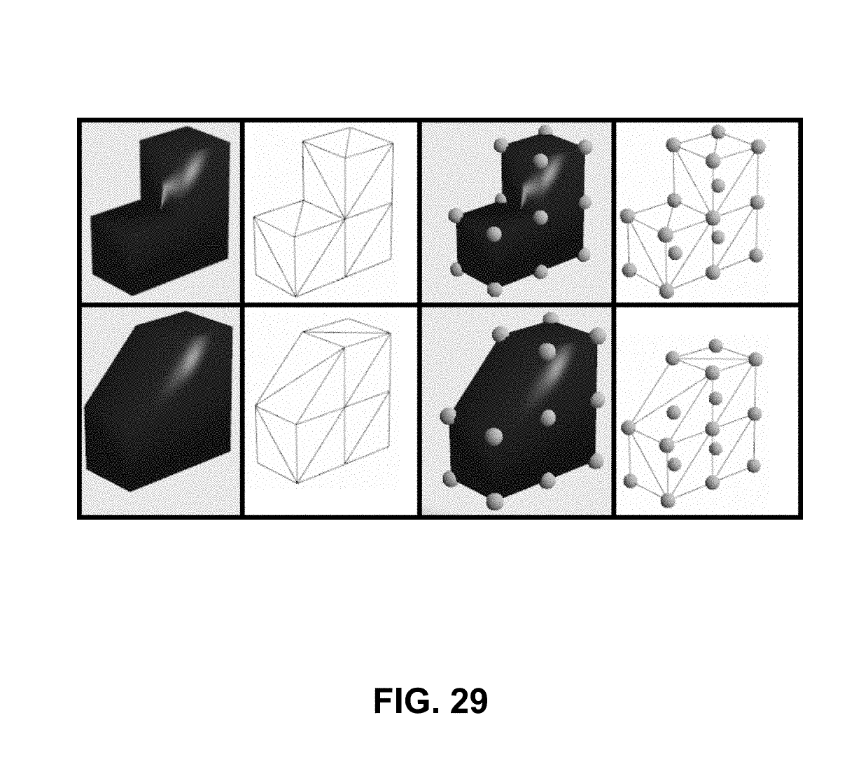

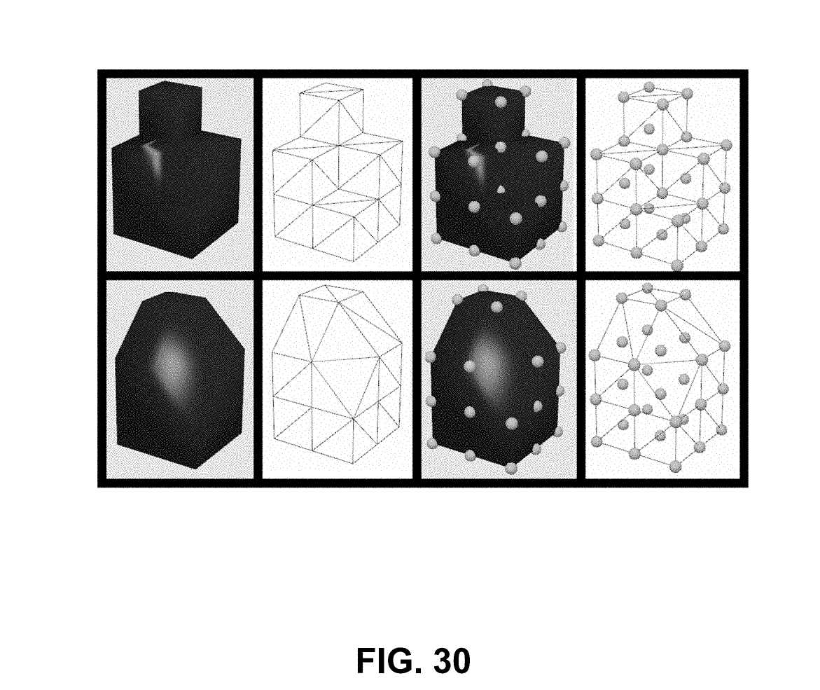

The behavior used to generate slants is best shown in FIG. 29. There are two slant triangles in this figure, the back top left one and the front bottom right one as viewed. For reference, the point lying at (0, 0, 0) has the lowest x, y, and z values on the figure, which would be the bottom left back point. Starting with the back top left slant triangle, the base point is at (1, 2, 0) from the origin and the neighbor being analyzed is the +z neighbor (at (1, 2, 1)). The “slant direction” in this case is the vector <−1, 0, 0>, and the “cross direction” is the vector <0, −1, 0>. In this example, the points in the slant direction from the base and the neighbor are clear, while the points in the cross direction and slant/cross direction from the base and neighbor are filled. This allows a triangle to spawn between the base, neighbor, and the point in the slant/cross direction from the base. For the other triangle, the base point is at (0, 1, 1), its neighbor direction is in the −z direction, so the neighbor is at (0, 1, 0). The slant direction is <0, 1, 0> and the cross direction is <1, 0, 0>. The points in the slant direction from the base and neighbor are empty while those in the cross direction and the slant/cross direction from the base and neighbor are filled. This also allows a triangle to spawn between the base, neighbor, and the point in the slant/cross direction from the base. This shows that to generate a full slant, the algorithm analyzes 2 different bases. FIG. 30 depicts a simple scenario where each type of geometric triangle is used in standard rendering and wireframe, with and without points visualized. The top is the raw voxel format, the bottom is faired.

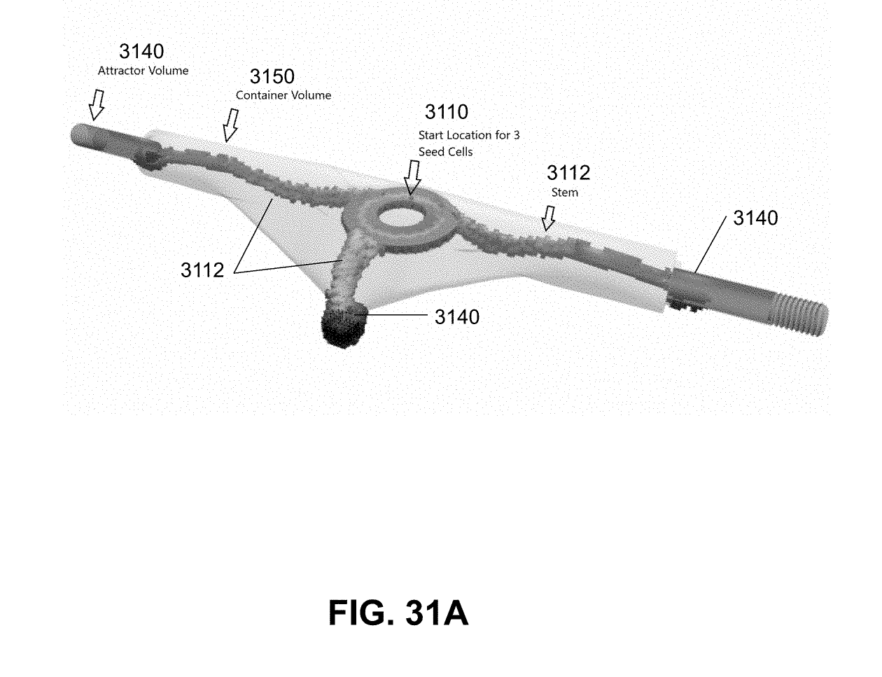

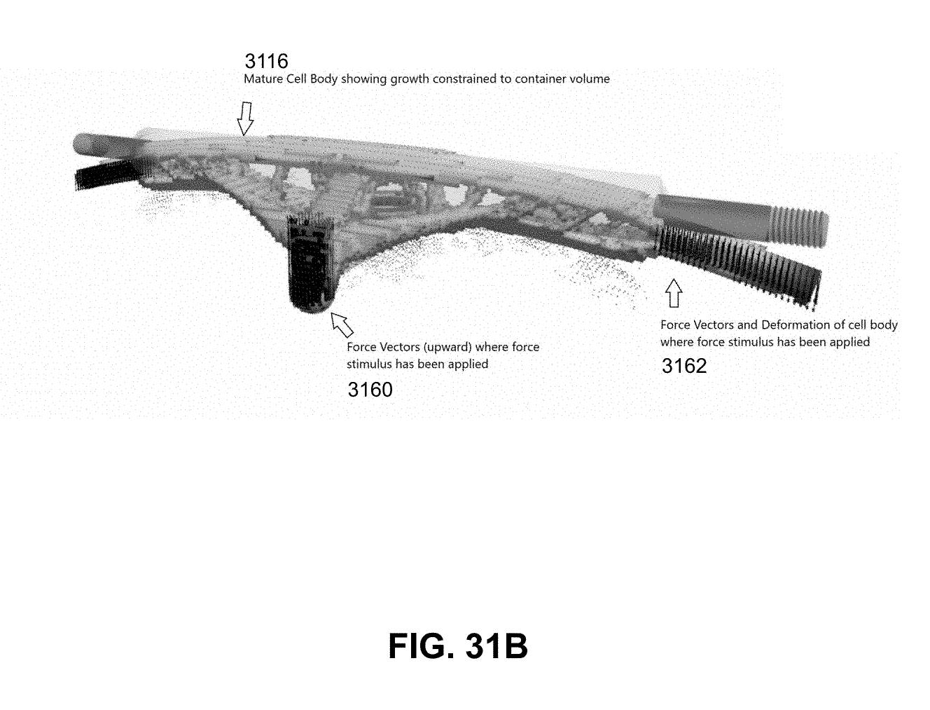

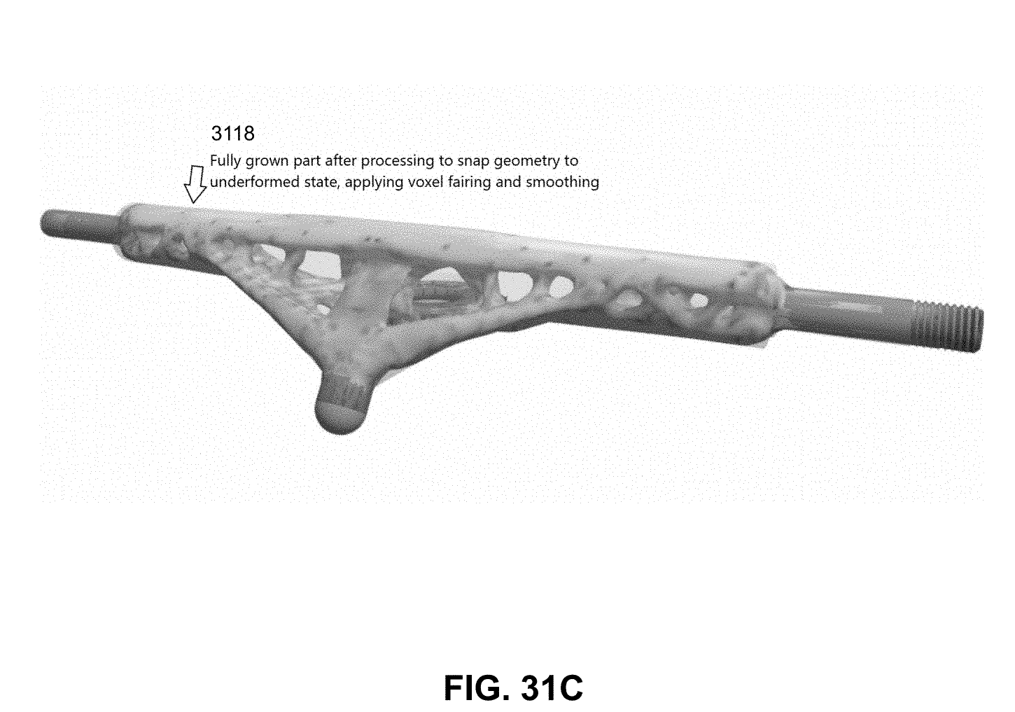

FIGS. 31A-C illustrate a controlled growth of a cell body and formation of a model part in a further embodiment. FIG. 31A illustrates early growth of a cell body, including three stems 3112 growing from start locations 3110 coincident at the rear center of a disk region towards end locations located on three attractor volumes 3140. The growth is constrained to lie within a container volume 3150, which defines a volume within which the cell body may grow, and may prevent occurrence of the cell body outside of the container volume 3150.

FIG. 31B illustrates a mature grown part 3116. Forces 3160, 3162 are applied during the growth of the part 3116, influencing the growth by causing the cell body to generate and/or remove cells to counteract the forces 3160, 3162. An upward force 3160 is applied at a central attractor volume, and a downward force 3162 is applied at ends of the part on surfaces touching attractor volumes. The cell body 3116 is deformed due to the force stimuli, but is being constrained to grow only within the container volume 3150. FIG. 3C shows a mature part 3118 after snapping to an undeformed state, with application of voxel fairing and smoothing. Here, it can be seen that the part 3118 continues to lie within the container volume 3150 of FIG. 3A.

While example embodiments have been particularly shown and described, it will be understood by those skilled in the art that various changes in form and details may be made therein without departing from the scope of the embodiments encompassed by the appended claims.

What is claimed is:

1. A method of defining geometry of an object, comprising:
generating a simulated environment including at least one initial cell, the simulated environment being defined by environment parameters;
generating successive cells to form a cell body including the at least one initial cell, the generation being a function of the environment parameters and cell parameters of cells of the cell body;
determining updated cell parameters in response to a simulated stimulus applied to the cell body, the stimulus including at least one of a force, a radiation source, and a chemical reaction;
modifying the cell parameters of the successive cells based on a value corresponding to the cell parameters of neighboring cells;
generating new cells adjacent to the successive cells as a function of the cell parameters of the successive cells following the modification; and
defining a geometry for an object based on a geometry of the cell body.

2. The method of claim 1, wherein a successive cell is adjacent to the face of an existing cell.

3. The method of claim 1, wherein the environment parameters define a start location and an end location, the cell body extending between the start location and the end location.

4. The method of claim 3, wherein the generation of successive cells progresses from the start location to locations that form a shortest route from the cells in the cell body to the end location.

5. The method of claim 1, wherein the environment parameters include at least one of a growth rate, a gravity force, and a force applied to a surface adjacent to the cell body.

6. The method of claim 1, wherein the cell parameters include at least one of a value corresponding to strain exhibited by a cell, a temperature of the cell, or an age of the cell.

7. The method of claim 1, wherein the stimulus includes at least one of a gravity force, a friction force, a tension force, a rotational force, a linear force, a pressure force, a constraint of degrees of freedom, and a contact force applied by an assembly within the simulated environment.

8. The method of claim 1, wherein the chemical reaction includes an electrolytic action.

9. The method of claim 1, wherein the environment parameters define a surface of an assembly within the simulated environment, the surface applying the simulated stimulus to cells adjacent to the surface.

10. The method of claim 1, wherein the environment parameters define a volume requiring occupation by the cell body.

11. The method of claim 1, wherein the environment parameters define a volume prohibiting occupation by the cell body.

12. The method of claim 1, wherein the environment parameters 1) define a volume, 2) enable growth of the cell body within the volume, and 3) prohibit growth of the cell body outside of the volume following occupation of the cell body within the volume.

13. The method of claim 1, wherein the environment parameters include at least one of a maximum thickness of the cell body, a minimum thickness of the cell body, and a growth direction.

14. The method of claim 1, further comprising detecting a violation of the environment parameters, the violation including at least one of 1) a failure of the cell body to occupy a required volume, 2) an occupation of a prohibited volume, and 3) failure to connect a start location and an end location via the cell body.

15. The method of claim 14, wherein modifying the cell body includes modifying the cell body to correct the violation.

16. The method of claim 1, wherein modifying the cell body includes adding further successive cells to the cell body, the location of the further successive cells being determined based on the environment parameters and the at least one force.

17. The method of claim 1, wherein modifying the cell body includes removing a subset of the successive cells from the cell body, the subset being determined based on the environment parameters and the at least one force.

18. The method of claim 1, further comprising calculating locations for the successive cells, comprising:
selecting an existing cell of the cell body;
defining a growth direction from the existing cell to an end location;
determining a set of locations for potential new cells adjacent to the existing cell; and
selecting one of the set of locations based on at least one of: 1) a relative deviation from the growth direction, and 2) strain exhibited by a face of the existing cell.

19. The method of claim 1, wherein each of the successive cells and the at least one initial cell defines a respective volume within the simulated environment.

20. The method of claim 19, wherein the geometry for the object corresponds to the respective volume of each of the successive cells and the at least one initial cell.

21. The method of claim 1, wherein defining the geometry for the object includes generating a modified geometry of the cell body, the modified geometry having a plurality of additional slant faces at the surface of the modified geometry.

22. The method of claim 1, further comprising determining completion of the cell body based on 1) an indication that at least one expression involving the environment parameters evaluate to true, and 2) an indication that the modification of the cell body has decreased below a threshold.

23. The method of claim 22, wherein defining the geometry for the object is in response to the determined completion.

24. The method of claim 1, further comprising:
determining an immediate strain parameter and a strain concentration parameter for each cell of the cell body, the immediate strain parameter indicating a degree of simulated strain at the cell; and
modifying the strain concentration parameter for each cell based on the corresponding immediate strain parameter and strain concentration parameters of neighboring cells.

25. The method of claim 24, further comprising determining the degree of simulated strain at the cell based on an effect on the cell, the effect being related to the simulated stimulus.

26. The method of claim 1, further comprising simulating at least one of a strain, a stress, and a displacement in reaction to the simulated stimulus.

27. The method of claim 1, further comprising selectively spawning new cells adjacent to the successive cells as a function of the cell parameters of the successive cells following the modification.

28. The method of claim 1, further comprising selectively terminating cells based on a measure of at least one simulated chemical at cells of the cell body.

29. The method of claim 1, further comprising terminating cells adjacent to the successive cells as a function of the cell parameters of the successive cells following the modification.

30. A method of defining geometry of an object, comprising:
generating a simulated environment including an assembly;
defining a start location and an end location within the simulated environment;
generating at least one initial cell at the start location;
calculating locations for successive cells, the locations being 1) adjacent to at least one of another successive cell and the at least one initial cell, and 2) a function of environment parameters;
generating the successive cells to form a cell body including the at least one initial cell, the cell body extending from the start location to the end location and including a portion adjacent to the assembly;
modifying the cell body in response to at least one simulated force applied to the cell body; and
defining a geometry for an object based on a geometry of the cell body.
